(19) United States
(12) Patent Application Publication
(10) Pub. No.: US 2006/0129482 A1
(43) Pub. Date: Jun. 15, 2006

(54) Methods and systems for managing real estate property

(75) Inventor: Richard G. Etzkorn, Kirkwood, MO (US)

Correspondence Address: PATRICK W. RASCHE;ARMSTRONG TEASDALE LLP, ONE METROPOLITAN SQUARE, SUITE 2600, ST. LOUIS, MO, 63102-2740, US

(73) Assignee: Turley Martin Tucker Company

(21) Appl. No.: 11/292,443

(22) Filed: Dec. 1, 2005

Related U.S. Application Data
(60) Provisional application No. 60/634,735, filed on Dec. 9, 2004.

(51) Int. Cl. G06Q 40/00

(52) U.S. Cl. 705/39

(57) ABSTRACT

A method for controlling workflow relating to an acquisition or leasing of a facility is provided. The method utilizes a real estate management system that includes a computer coupled to a database. The method includes selecting a location for a potential facility being considered for a transaction including at least one of an acquisition transaction and a leasing transaction, prompting a user to enter information relating to the selected location and storing it in the database, and automatically displaying on the computer a workflow summary relating to the selected location of the potential facility. The method further includes prompting the user to enter information relating to each action displayed and performed to complete the transaction, generating documents to complete the transaction based on the information stored in the database for the selected location, prompting the user to enter information relating to infrastructure updates for the facility, and managing the infrastructure updates for maintaining the facility.

### CROSS REFERENCE TO RELATED APPLICATIONS

This application claims priority to and the benefit of the filing date of U.S. Provisional Application No. 60/634,735, filed on Dec. 9, 2004 and which is hereby incorporated by reference in its entirety.

### BACKGROUND OF THE INVENTION

This invention relates generally to managing real estate property and, more particularly, to network-based methods and systems for managing real estate property.

Businesses engaging in a variety of business activities may have facilities located in more than one place within the United States. In fact, at least some known businesses have numerous facilities located throughout the United States and/or worldwide. Such facilities are located on real property that may be either owned or leased by the businesses.

In order to manage such facilities, businesses must also manage information associated with the leasing or ownership of each of these facilities. For example, a business engaged in providing accounting and tax preparation services may have numerous facilities located throughout the United States. Each of these facilities must satisfy certain requirements (i.e., size, location, available technology) designated by the business. These facilities typically include a building located on a piece of real property, and may be either owned or leased by the business. In addition, the business may also be interested in locating and opening new facilities.

When a business is interested in locating and leasing a new facility, the business must first locate a facility that satisfies the building requirements of the business. Once such a facility is located, the business must then negotiate a lease agreement with the landlord of the property. The process of locating a facility and negotiating a lease agreement for such a facility may involve a great deal of documentation and time. The lease agreement will provide the terms and conditions of the lease including, but not limited to, rent for the facility, a period for paying the rent (i.e., monthly, quarterly, or yearly), a term of the lease, options, and will identify which portions of the property that each party (i.e., landlord or tenant) is responsible for. The business must then monitor and manage the property in light of the terms and conditions of the lease agreement. For example, the business must ensure that the rent is timely paid, the correct amount is paid, the lease is timely renewed or cancelled, and that the proper party is paying the proper expenses associated with the facility. Similarly, when the business is already leasing a facility, the business must monitor and manage the property in light of the terms and conditions of the existing lease agreement to ensure compliance with the lease agreement.

Moreover, when the business desires to purchase a facility that includes real property, the business must first locate the facility that satisfies the building requirements of the business. Once a facility is located, the business must then negotiate the purchase of the property. The business then monitors and manages the property including, for example, securing financing, timely payment of real estate taxes, and processing expenses associated with the facility.

The process of managing such facilities may be extremely time consuming and may require a significant amount of information management. This information is often complex and relates to various aspects of a piece of real estate and/or the transaction associated with the real estate. In at least some known processes, the information is gathered from a variety of sources and is managed by a number of systems, which may require the same information being entered multiple times on multiple systems. Individual collection of such information by various persons increases the risk of overlapping data collection and decreases time efficiency. Further, individual reporting by one person associated with the business to other persons associated with the business increases the risk of providing inconsistent or incomplete data during the documentation process, which may result in increased cycle time and costs.

Because of the time and expense associated with managing the information associated with the leasing and/or ownership of such facilities, at least some known companies outsource these responsibilities to an outside entity that manages this information and the duties associated therewith.

### BRIEF DESCRIPTION OF THE INVENTION

In one aspect of the present invention, a method for controlling workflow relating to an acquisition or leasing of a facility is provided. The method utilizes a real estate management system. The real estate management system includes a computer coupled to a database. The method includes selecting a location for a potential facility being considered for a transaction including at least one of an acquisition transaction and a leasing transaction, prompting a user to enter into the computer information relating to the selected location and storing the information in the database, and automatically displaying on the computer a workflow summary that includes an active stages section, a future stages section, and a past stages section relating to the selected location of the potential facility, wherein the active stages section includes tasks to be performed within a predetermined period of time and in a recommended sequence to progress the transaction toward completion, the future stages section includes tasks that will likely need to be performed in the future in a recommended sequence to complete the transaction, and the past stages section includes tasks that have already been performed to progress the transaction toward completion. The method further includes prompting the user to enter into the computer information relating to each action displayed and performed to complete the transaction, generating documents to complete the transaction based on the information stored in the database for the selected location, prompting the user to enter into the computer information relating to infrastructure updates for the facility, and managing the infrastructure updates for maintaining the facility.

In another aspect, a network-based system for controlling workflow relating to an acquisition transaction or a leasing transaction of a facility for a business entity and for managing the facility for the business entity after the transaction has been completed is provided. The system includes a client system comprising a browser, a database for storing information, and a server system configured to be coupled to the client system and the database. The server is further configured to prompt a user to select a location of a potential facility being considered for a transaction including at least one of an acquisition transaction and a leasing transaction, prompt the user to input into the client system information relating to the selected location and storing the information in the database, calculate a score for the potential facility based on a determination of whether the potential facility satisfies certain building requirements for the business entity, and automatically display on the client system a workflow summary including an active stages section, a future stages section, and a past stages section relating to the selected location of the potential facility, wherein the active stages section includes tasks to be performed within a predetermined period of time and in a recommended sequence to progress the transaction toward completion, the future stages section includes tasks that will likely need to be performed in the future in a recommended sequence to complete the transaction, and the past stages section includes tasks that have already been performed to progress the transaction toward completion. The server is further configured to prompt the user to input into the client system information relating to each action displayed and performed to complete the transaction wherein the inputted information is stored in the database, generate documents to complete the transaction based on the information stored in the database for the selected location, prompt the user to input into the client system information relating to infrastructure updates for the facility, and process the infrastructure updates for maintaining the facility.

In another aspect, a computer program embodied on a computer readable medium for controlling workflow relating to an acquisition or leasing of a facility by a business entity is provided. The program includes at least one code segment that prompts a user to select a location for a potential facility being considered for a transaction including at least one of an acquisition transaction and a leasing transaction and then prompts a user to input information relating to the selected location for storing in a database. The at least one code segment also calculates a score for the potential facility using an algorithm for determining whether the potential facility satisfies certain building requirements for the business entity, and automatically generates a workflow summary including an active stages section, a future stages section, and a past stages section relating to the selected location of the potential facility, wherein the active stages section includes tasks to be performed within a predetermined period of time and in a recommended sequence to progress the transaction toward completion, the future stages section includes tasks that will likely need to be performed in the future in a recommended sequence to complete the transaction, and the past stages section includes tasks that have already been performed to progress the transaction toward completion. The at least one code segment further prompts the user to input information relating to each action displayed and performed to complete the transaction for storing in the database, prompts the user to submit an approval request for approval of the transaction involving the selected location by at least one predetermined approver wherein the approver provides the user with an approval or a rejection indicating whether management of the business entity approves or rejects the transaction, generates documents to complete the transaction based on the information stored in the database for the selected location including at least one of a lease agreement, a lease renewal agreement, and a purchase agreement relating to the facility, records and tracks any options relating to the facility, prompts the user to input information relating to infrastructure updates for the facility including scheduling and monitoring construction or repair costs for the facility, arranging for signage for the facility, and arranging for installing certain technology systems within the facility, and manages the infrastructure updates for maintaining the facility including processing at least one of work orders, purchase orders, vouchers, invoices, and payments to vendors for work performed at the facility.

### BRIEF DESCRIPTION OF THE DRAWINGS

FIG. 1 is a simplified block diagram of a Real Estate Workflow Management System (REWMS) in accordance with one embodiment of the present invention.

FIG. 2 is an expanded version block diagram of an example embodiment of a server architecture of a REWMS.

FIGS. 3A and 3B show a flowchart illustrating example processes utilized by a REWMS as described herein.

FIGS. 4A and 4B show a flowchart illustrating in more detailed example processes utilized by a REWMS as described herein.

FIG. 5 is an example embodiment of a user interface displaying a worklist page included within a REWMS.

FIG. 6 is an example embodiment of a user interface displaying a transaction initiation page included within a REWMS.

FIG. 7 is an example embodiment of a user interface displaying a workflow summary page included within a REWMS.

FIG. 8 is an example embodiment of a user interface displaying a workflow summary page included within a REWMS.

FIG. 9 is an example embodiment of a user interface displaying a workflow summary page included within a REWMS.

FIG. 10 is an example embodiment of a user interface displaying a workflow summary page included within a REWMS.

FIG. 11 is an example embodiment of a user interface displaying a workflow summary page included within a REWMS.

FIG. 12 is an example embodiment of a user interface displaying a workflow summary page included within a REWMS.

FIG. 13 is an example embodiment of a user interface displaying a workflow summary page included within a REWMS.

FIG. 14 is an example embodiment of a user interface displaying a workflow summary page included within a REWMS.

FIG. 15 is an example embodiment of a user interface displaying a workflow summary page included within a REWMS.

FIG. 16 is an example embodiment of a user interface displaying an offer to lease document generator page included within a WREWMS.

FIG. 17 is an example embodiment of a user interface displaying a workflow summary page included within a REWMS.

FIG. 18 is an example embodiment of a user interface displaying a workflow summary page included within a REWMS.

FIG. 19 is an example embodiment of a user interface displaying a workflow summary page included within a REWMS.

FIG. 20 is an example embodiment of a user interface displaying a workflow summary page included within a REWMS.

FIG. 21 is an example embodiment of a user interface displaying a workflow summary page included within a REWMS.

FIG. 22 is an example embodiment of a user interface displaying a workflow summary page included within a REWMS.

FIG. 23 is an example embodiment of a user interface displaying a transactions summary page included within a REWMS.

FIG. 24 is an example embodiment of a user interface displaying a transactions key dates page included within a REWMS.

FIG. 25 is an example embodiment of a user interface displaying a transactions contacts page included within a REWMS.

FIG. 26 is an example embodiment of a user interface displaying a transactions notes page included within a REWMS.

FIG. 27 is an example embodiment of a user interface displaying a transactions photographs page included within a REWMS.

FIG. 28 is an example embodiment of a user interface displaying a transactions images page included within a REWMS.

FIG. 29 is an example embodiment of a user interface displaying a transactions vouchers page included within a REWMS.

FIG. 30 is an example embodiment of a user interface displaying a transactions purchase orders page included within a REWMS.

FIG. 31 is an example embodiment of a user interface displaying a transactions signage information page included within a REWMS.

FIG. 32 is an example embodiment of a user interface displaying a transactions design information page included within a REWMS.

FIG. 33 is an example embodiment of a user interface displaying a transactions move information page included within a REWMS.

FIG. 34 is an example embodiment of a user interface displaying a transactions conference room tracking page included within a REWMS.

FIG. 35 is an example embodiment of a user interface displaying a transactions follow-up log page included within a REWMS.

FIGS. 36A and 36B are an example embodiment of a user interface displaying a transactions clearance and negotiation page included within a REWMS.

FIG. 37 is an example embodiment of a user interface displaying a transactions collection list page included within a REWMS.

FIG. 38 is an example embodiment of a user interface displaying a transactions savings list page included within a REWMS.

FIG. 39 is an example embodiment of a user interface displaying a transactions site selection page included within a REWMS.

FIGS. 40A-40D are an example embodiment of a user interface displaying a transactions site scoring page included within a REWMS.

FIG. 41 is an example embodiment of a user interface displaying a transactions survey page included within a REWMS.

FIG. 42 is an example embodiment of a user interface displaying a transactions information page included within a REWMS.

FIG. 43 is an example embodiment of a user interface displaying a transactions E-file page included within a REWMS.

FIG. 44 is an example embodiment of a user interface displaying an options summary page relating to a transaction that is accessible by a user utilizing a REWMS.

FIG. 45 is an example embodiment of a user interface displaying an entering cancellation option information page included within a REWMS.

FIG. 46 is an example embodiment of a user interface displaying a cancellation option notification page included within a REWMS.

FIG. 47 is an example embodiment of a user interface displaying an entering cancellation option penalty page included within a REWMS.

FIG. 48 is an example embodiment of a user interface displaying a cancellation option page included within a REWMS.

FIG. 49 is an example embodiment of a user interface displaying another cancellation option page included within a REWMS.

FIG. 50 is an example embodiment of a user interface displaying a third cancellation option page included within a REWMS.

FIG. 51 is an example embodiment of a user interface displaying a security deposit information page included within a REWMS.

FIG. 52 is an example embodiment of a user interface displaying a notes relating to cancellation options page included within a REWMS.

FIG. 53 is an example embodiment of a user interface displaying a work order summary page included within a REWMS.

FIG. 54 is an example embodiment of a user interface displaying a work order photographs page included within a REWMS.

FIG. 55 is an example embodiment of a user interface displaying a work order contacts page included within a REWMS.

FIG. 56 is an example embodiment of a user interface displaying a work order vouchers page included within a REWMS.

FIG. 57 is an example embodiment of a user interface displaying a work order notes page included within a REWMS.

FIG. 58 is an example embodiment of a user interface displaying a work order follow-up log page included within a REWMS.

FIG. 59 is an example embodiment of a user interface displaying a work order telephone listing page included within a REWMS.

FIG. 60 is an example embodiment of a user interface displaying a work order purchase orders page included within a REWMS.

FIG. 61 is an example embodiment of a user interface displaying a transactions images page included within a REWMS.

FIG. 62 is an example embodiment of a user interface displaying a work order savings list page included within a REWMS.

FIG. 63 is an example embodiment of a user interface displaying a work order collection list page included within a REWMS.

FIG. 64 is an example embodiment of a user interface displaying a work order E-file page included within a REWMS.

FIG. 65 is an example embodiment of a user interface displaying a maintenance reporting page included within a REWMS.

FIG. 66 is an example embodiment of a user interface displaying a contacts page included within a REWMS.

FIGS. 67A and 67B are an example embodiment of a user interface displaying a purchase order page included within a REWMS.

FIG. 68 is an example embodiment of a user interface displaying a purchase order page included within a REWMS.

FIG. 69 is an example embodiment of a user interface displaying a purchase order page included within a REWMS.

FIG. 70 is an example embodiment of a user interface displaying a purchase order page included within a REWMS.

FIG. 71 is an example embodiment of a user interface displaying a vendor's page included within a REWMS.

FIG. 72 is an example embodiment of a user interface displaying a check page included within a REWMS.

FIG. 73 is an example embodiment of a user interface displaying an identification number page included within a REWMS.

FIG. 74 is an example embodiment of a user interface displaying a team leader justification page included within a REWMS.

FIG. 75 is an example embodiment of a user interface displaying a voucher page included within a REWMS.

FIG. 76 is an example embodiment of a user interface displaying a vendor page included within a REWMS.

FIG. 77 is an example embodiment of a user interface displaying a savings page included within a REWMS.

FIG. 78 is an example embodiment of a user interface displaying an instant message entry page included within a REWMS.

FIG. 79 is an example embodiment of a user interface displaying a branch number entry page included within a REWMS.

FIG. 80 is an example embodiment of a user interface displaying a select documents page included within a REWMS.

FIG. 81 is an example embodiment of a user interface displaying a renewal amendment page included within a REWMS.

FIG. 82 is an example embodiment of a user interface displaying a document title page included within a REWMS.

FIG. 83 is an example embodiment of a user interface displaying a renewal term entry page included within a REWMS.

FIG. 84 is an example embodiment of a user interface displaying a rent steps page included within a REWMS.

FIGS. 85A and 85B are an example embodiment of a user interface displaying an operating expenses options page included within a REWMS.

FIG. 86 is an example embodiment of a user interface displaying an early terminations options page included within a REWMS.

FIG. 87 is an example embodiment of a user interface displaying a renewal options page included within a REWMS.

FIG. 88 is an example embodiment of a user interface displaying a declarations page included within a REWMS.

FIGS. 89A and 89B are an example embodiment of a user interface displaying a document created with a document generator included within a REWMS.

FIG. 90 is an example embodiment of a user interface displaying a socio-economic measurement system (SEMS) search tool included within a REWMS.

FIG. 91 is an example embodiment of a user interface displaying a design and construction projects page included within a REWMS.

FIG. 92 is an example embodiment of a user interface displaying a preferred owner program search tool included within a REWMS.

FIG. 93 is an example embodiment of a user interface displaying a retail rent comparables search tool included within a REWMS.

FIG. 94 is a user interface allowing a user to register and/or login for access to the user interface in FIG. 93.

FIG. 95 is an example embodiment of a user interface displaying a branch finder included within a REWMS.

FIG. 96 is an example embodiment of a user interface displaying a portion of branch finder function included within a REWMS.

FIG. 97 is an example embodiment of an introductory user interface accessible via a website address using a REWMS.

FIG. 98 is an example embodiment of a user interface displayed by selecting a link on the user interface in FIG. 97.

FIG. 99 is an example embodiment of a user interface for user entry of an identifying number allowing access to a branch office real estate information system through a REWMS.

FIG. 100 is an example embodiment of a user interface displaying a password entry page included within a REWMS.

FIG. 101 is an example embodiment of a user interface displaying links to provide a user with updates regarding a property through a REWMS.

FIG. 102 is one embodiment of a user interface that provides a user with a summary regarding the opening of a new branch office using a REWMS.

FIG. 103 is one embodiment of a user interface that provides a user with notes regarding a branch office using a REWMS.

FIG. 104 is one embodiment of a user interface that provides a user with an ability to send a message using a REWMS.

### DETAILED DESCRIPTION OF THE INVENTION

Example embodiments of systems and processes that facilitate integrated network-based electronic reporting and workflow process management related to a Real Estate Workflow Management System (REWMS) are described below in detail. A technical effect of the systems and processes described herein include at least one of facilitating an electronic submission of information using a client system, automating extraction of information, and web-based reporting for internal and external system users. The REWMS allows a business having at least one facility located within the United States or within the world to collect, manage, store and disseminate real estate (RE) information relating to the existing facility or a new facility among persons within or outside of the business to ensure that the facility is properly managed.

The REWMS also prompts a user through a real estate transaction by controlling the workflow of leasing or purchasing a facility in a pre-selected location. More specifically, the REWMS controls and tracks the workflow of leasing or purchasing a facility for a business by prompting a user to engage a real estate broker to investigate a potential facility, select a location of a potential facility, score the potential facility using an algorithm for determining whether the potential facility satisfies certain building requirements of the business, prepare a letter of intent to lease the potential facility, generate a lease agreement relating to the potential facility, obtain the necessary approvals from the business for the potential facility, finalize the lease agreement, record any options relating to the facility, provide a technology survey, schedule and monitor construction or repair costs for the facility, arrange for signage for the facility, and arrange for installing certain technology including a satellite system at the facility.

As used herein, the term “transaction” includes at least one of leasing a facility to be associated with the business, renewing an existing lease for a facility associated with the business, and purchasing a facility to be associated with the facility. The facility may include a building and a piece of real property.

REWMS also stores, tracks, and manages RE information for the business, which includes information relating to the leasing or acquisition of a facility as described above. In addition, the REWMS manages infrastructure updates for maintaining the facility after the facility has been leased or acquired including conducting technology surveys of the facility, scheduling and monitoring construction or repair costs for the facility, arranging for signage for the facility, arranging for installing certain technology systems within the facility, and processing at least one of work orders, purchase orders, vouchers, invoices, and payments to vendors for work performed at the facility. For example, if a roof of a facility requires repair, a user located at the facility is prompted to submit a work order for the roof repair to the business through the REWMS. In one embodiment, the work order is submitted through the REWMS. In another embodiment, the work order is submitted and the information is then entered into the REWMS. The work order is processed through the REWMS by the business. The business will then issue a purchase order (PO) to the facility through the REWMS such that the facility may hire a vendor (i.e., a roofer) to repair the roof. The invoice for the roof repair may also be submitted through the REWMS. Alternatively, the invoice may be submitted and the information from the invoice entered into the REWMS. The REWMS processes the invoice by matching the invoice to the purchase order. The vendor may then be paid for the work performed. The REWMS also stores and tracks all work orders, POs, invoices, and work performed at the facility.

The REWMS enables the business to store, track, and view each transaction or facility managed by the business, contact information for each facility associated with the business, vouchers submitted by the facilities, and vendors used and approved by the business for providing work or services to the facilities.

In one embodiment of the present invention, the business is the party using the REWMS to manage its facilities. In another embodiment, the business outsources the management of these facilities to an outside third-party. In such an embodiment, the third-party will use the REWMS, and the REWMS will include a client access portal which will enable the business to access at least some of the RE information stored in the REWMS.

In the REWMS, RE information is stored in the database. The network based REWMS provides convenient access to RE information, including at least one of location of each facility, contact for each facility, work performed and costs incurred at each facility, and terms and conditions of lease agreements for each facility including at least one of rent, a period for paying the rent (i.e., monthly, quarterly, or yearly), a term of the lease, options, and responsibility for expenses. A user must be authorized to gain access into the REWMS. In the example embodiment, once the REWMS home page is accessed, the user will be able to choose from a list of transactions assigned to the user or a worklist assigned to the user showing a workflow including active stages, future stages, and past stages of the leasing or acquisition process. Once the user selects a transaction to be reviewed, the user can review RE information relating to that transaction or facility. In addition, if the user selects a particular workflow, the user can view and update tasks to be performed relating to a transaction. In the example embodiment, only an authorized user can access the RE information.

In one embodiment, the system is a computer program embodied on a computer readable medium implemented utilizing Java® and Structured Query Language (SQL) with a client user interface front-end for administration and a web interface for standard user input and reports. (Java is a registered trademark of Sun Microsystems, Inc., Palo Alto, Calif.). In an example embodiment, the system is web enabled and is run on a business-entity's intranet. In yet another embodiment, the system is fully accessed by individuals having an authorized access outside the firewall of the business-entity through the Internet. In a further example embodiment, the system is being run in a Windows® NT environment (Windows is a registered trademark of Microsoft Corporation, Redmond, Wash.). The application is flexible and designed to run in various different environments without compromising any major functionality.

The systems and processes are not limited to the specific embodiments described herein. In addition, components of each system and each process can be practiced independent and separate from other components and processes described herein. Each component and process also can be used in combination with other assembly packages and processes.

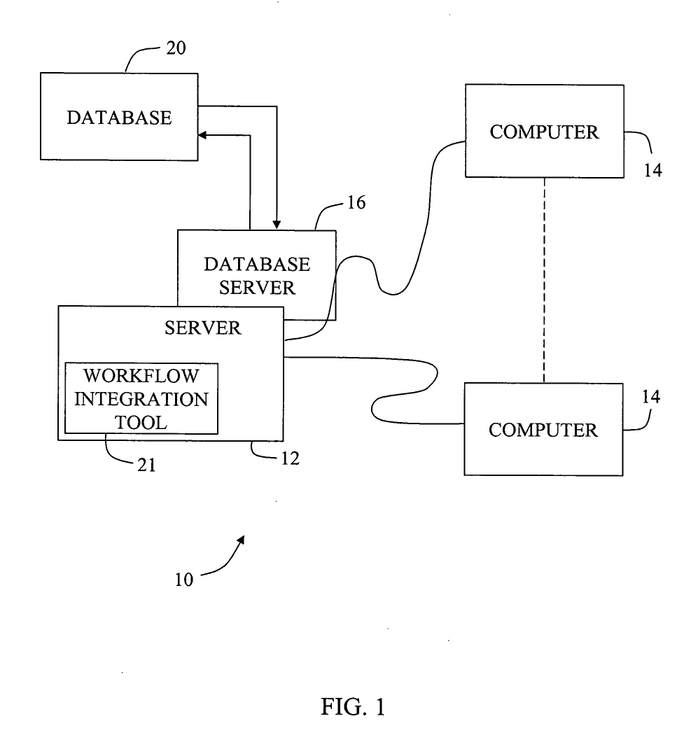

FIG. 1 is a simplified block diagram of a Real Estate Workflow Management System (REWMS) 10 including a server system 12, and a plurality of client sub-systems, also referred to as client systems 14, connected to server system 12. In one embodiment, client systems 14 are computers including a web browser, such that server system 12 is accessible to client systems 14 via the Internet. Client systems 14 are interconnected to the Internet through many interfaces including a network, such as a local area network (LAN) or a wide area network (WAN), dial-in-connections, cable modems and special high-speed ISDN lines. Client systems 14 could be any device capable of interconnecting to the Internet including a web-based phone, personal digital assistant (PDA), or other web-based connectable equipment. A database server 16 is connected to a database 20 containing information on a variety of matters, as described below in greater detail. In one embodiment, centralized database 20 is stored on server system 12 and can be accessed by potential users at one of client systems 14 by logging onto server system 12 through one of client systems 14. In an alternative embodiment database 20 is stored remotely from server system 12 and may be non-centralized.

In the example embodiment, server 12 also includes a workflow integration tool 21. As explained below, workflow integration tool 21 enables REWMS 10 to prompt a user through a real estate transaction by controlling the workflow of leasing or purchasing a facility in a pre-selected location. More specifically, tool 21 controls and tracks the workflow of leasing or purchasing a facility for a business by prompting a user to engage a real estate broker to investigate a potential facility, select a location of a potential facility, score the potential facility using an algorithm for determining whether the potential facility satisfies certain building requirements of the business, prepare a letter of intent to lease the potential facility, generate a lease agreement relating to the potential facility, obtain the necessary approvals from the business for the potential facility, finalize the lease agreement, record any options relating to the facility, provide a technology survey, schedule and monitor construction or repair costs for the facility, arrange for signage for the facility, and arrange for installing certain technology including a satellite system at the facility.

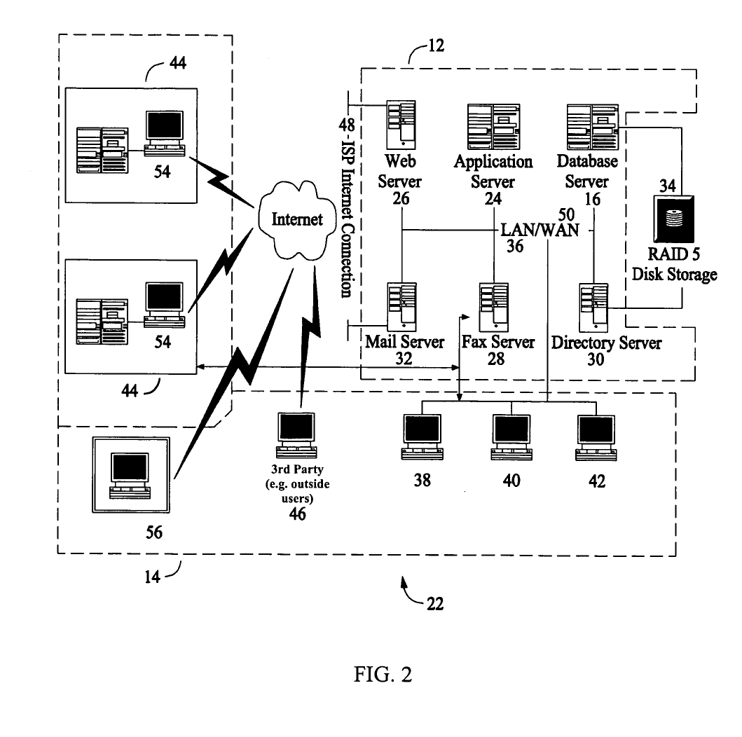

FIG. 2 is an expanded version block diagram of an example embodiment of a server architecture of a REWMS 22. Components in system 22, identical to components of system 10 (shown in FIG. 1), are identified in FIG. 2 using the same reference numerals as used in FIG. 1. System 22 includes server system 12 and client systems 14. Server system 12 further includes database server 16, an application server 24, a web server 26, a fax server 28, a directory server 30, and a mail server 32. A disk storage unit 34 is coupled to database server 16 and directory server 30. Servers 16, 24, 26, 28, 30, and 32 are coupled in a local area network (LAN) 36. In addition, a system administrator's workstation 38, a user workstation 40, and a supervisor's workstation 42 are coupled to LAN 36. Alternatively, workstations 38, 40, and 42 are coupled to LAN 36 via an Internet link or are connected through an Intranet.

Each workstation, 38, 40, and 42 is a personal computer having a web browser. Although the functions performed at the workstations typically are illustrated as being performed at respective workstations 38, 40, and 42, such functions can be performed at one of many personal computers coupled to LAN 36. Workstations 38, 40, and 42 are illustrated as being associated with separate functions only to facilitate an understanding of the different types of functions that can be performed by individuals having access to LAN 36. In an example embodiment, client system 14 includes workstation 40 which can be used by a user internal to the business or a designated outside user to review RE information relating to a facility or transaction associated with the business.

Server system 12 is configured to be communicatively coupled to various individuals, including employees 44 and third parties, e.g., designated outside users, 46 via an ISP Internet connection 48. The communication in the example embodiment is illustrated as being performed via the Internet, however, any other wide area network (WAN) type communication can be utilized in other embodiments, i.e., the systems and processes are not limited to being practiced via the Internet. In addition, and rather than WAN 50, local area network 36 could be used in place of WAN 50.

In the example embodiment, any authorized individual having a workstation 54 can access REWMS 22. At least one of the client systems includes a manager workstation 56 located at a remote location. Workstations 54 and 56 are personal computers having a web browser. Also, workstations 54 and 56 are configured to communicate with server system 12. Furthermore, fax server 28 communicates with remotely located client systems, including a client system 56 via a telephone link. Fax server 28 is configured to communicate with other client systems 38, 40, and 42 as well.

System 10 accumulates a variety of confidential data and has different access levels to control and monitor the security of and access to system 10. Authorization for access is assigned by system administrators on a need to know basis. In one embodiment, access is provided based on job functions. In yet another embodiment, system 10 provides access based on a business-entity. The administration/editing capabilities within system 10 are also restricted to ensure that only authorized individuals have access to modify or edit the data existing in the system. System 10 manages and controls access to system data and information.

The architectures of system 10 as well as various components of system 10 are exemplary only. Other architectures are possible and can be utilized in connection with practicing the processes described below.

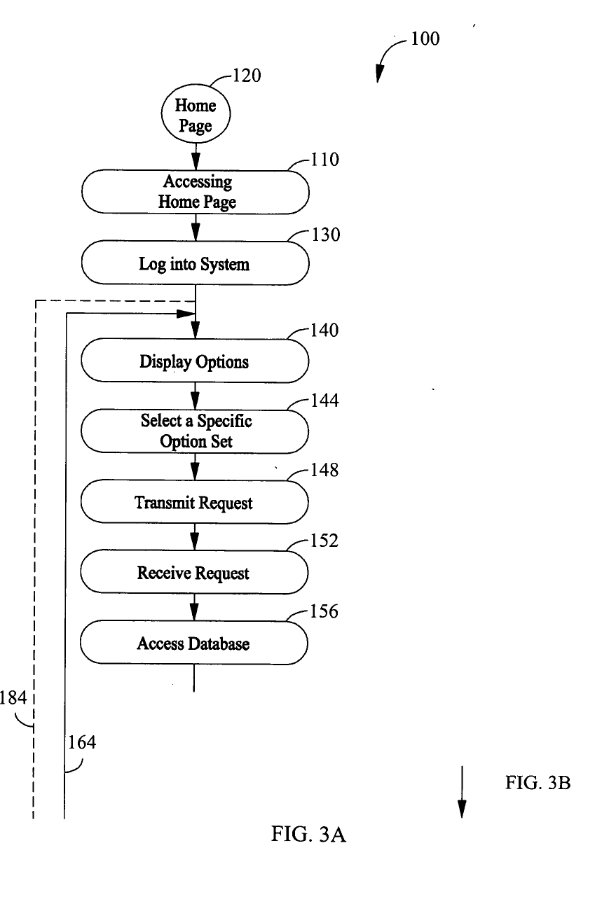

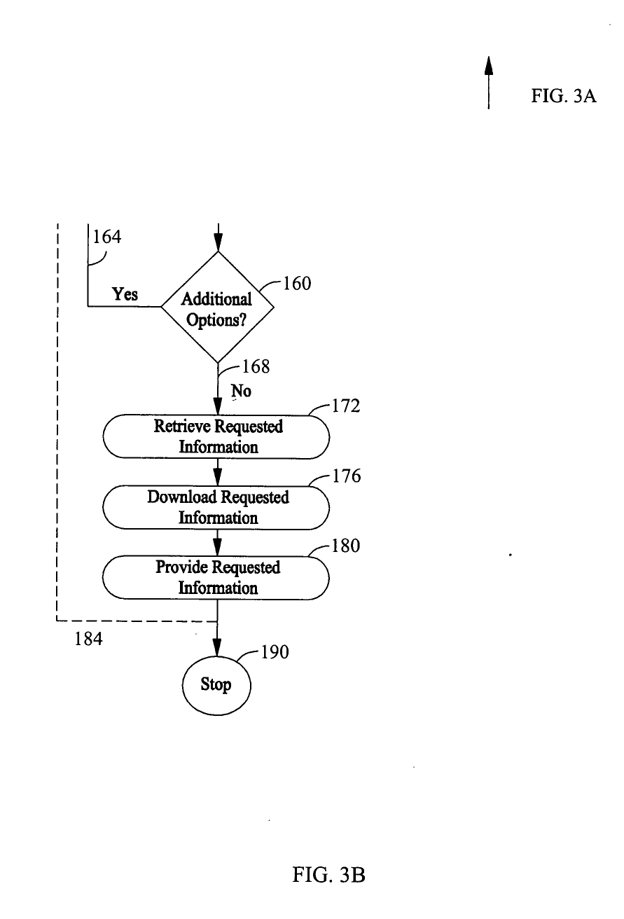

FIGS. 3A and 3B show a flowchart 100 illustrating example processes utilized by system 10. The technical effect of REWMS 10 is achieved by a user first accessing 110 a user interface, such as a home page 120, of the web site through client system-14 (shown in FIG. 1). In one embodiment, client system 14, as well as server system 12, are protected from access by unauthorized individuals. The user logs-in 130 to system 10 using a password (not shown) and an employee user login for security.

Client system 14 displays 140 options available to the user through links, check boxes, or pull-down lists. Once the user selects 144 an option (in one embodiment, relating to a transaction or a facility associated with the business) from the available links, the request is transmitted 148 to server system 12. Transmitting 148 the request is accomplished, in one embodiment, either by click of a mouse or by a voice command. Once server system 12 (shown in FIG. 1) receives 152 the request, server system 12 accesses 156 database 20 (shown in FIG. 1). System 10 determines 160 if additional narrowing options are available. In one embodiment, additional narrowing options relate to the selected transaction or facility, and include check boxes, hyperlinks, buttons, and pull-down lists. If additional narrowing options are available 164, system 10 displays 140 the options relating to the prior option selected by the user on client system 14. The user selects 144 the desired option and transmits the request 148. Server system 12 receives the request 152 and accesses 156 database 20. When system 10 determines that additional options 160 are not available 168, system 10 retrieves 172 requested information from database 20. The requested information is downloaded 176 and provided 180 to client system 14 from server 12. The user can continue to search 184 database 20 for other information or exit 190 from system 10.

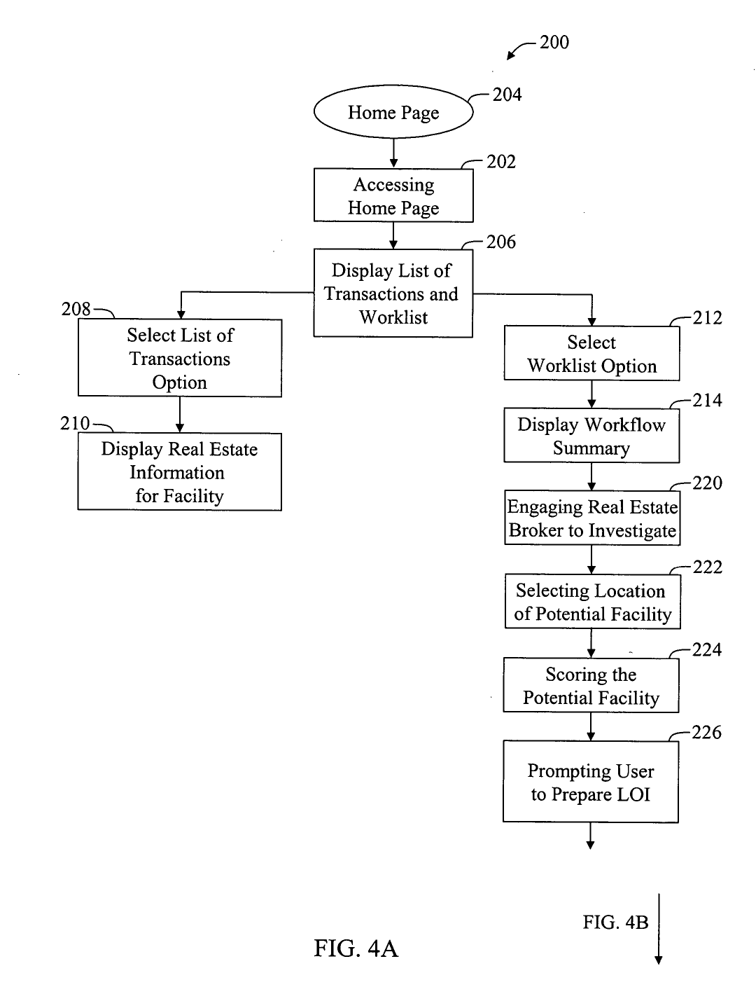

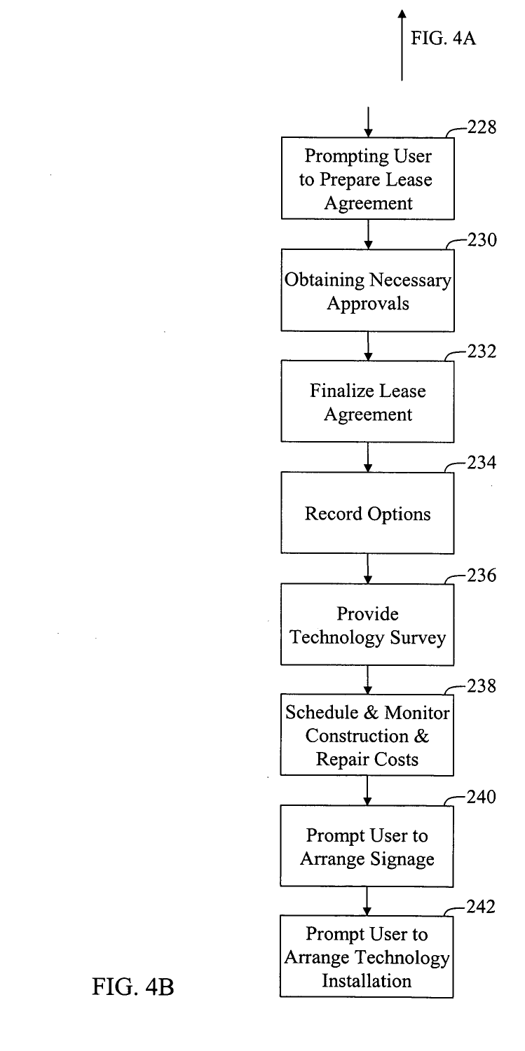

FIGS. 4A and 4B show a flowchart 200 illustrating a more detailed example processes utilized by system 10 (shown in FIG. 1) including workflow integration tool 21 (shown in FIG. 1). The technical effect of REWMS 10 is achieved by a user first accessing 202 a user interface, such as a home page 204, of the web site through client system 14 (shown in FIG. 1). Client system 14 displays 206 at least one of a list of transactions and a worklist assigned to the user. In the example embodiment, if the user selects 208 a transaction from the list of transactions, client system 14 displays 210 RE information for the facility corresponding to that transaction including at least one of a location of the facility, a contact person assigned to the facility, and the terms and conditions of a lease agreement for the facility. If, however, the users selects 212 the worklist option, client system 14 displays 214 a workflow summary including active stages, future stages, and past stages of a transaction.

System 10 is configured to generate the workflow summaries for display on client system 14 including the active, future, and past stages displayed on the client system. These stages include each stage of the transaction as designated by system 10 that has been performed, needs to be performed, and may be performed in the future in order to complete the transaction.

For example, system 10 is configured to prompt a user using the worklist option through a transaction including at least one of engaging 220 a real estate broker to investigate a potential facility, selecting 222 a location of a potential facility, scoring 224 the potential facility using an algorithm for determining whether the potential facility satisfies certain building requirements of the business, preparing 226 a letter of intent to lease the potential facility, generating 228 a lease agreement relating to the potential facility, obtaining 230 the necessary approvals from the business for the potential facility, finalizing 232 the lease agreement, recording 234 any options relating to the facility, providing 236 a technology survey, scheduling and monitoring 238 construction or repair costs for the facility, arranging 240 signage for the facility, and arranging 242 installation of certain technology systems at the facility including a satellite system.

System 10 also processes work orders, purchase orders, invoices and payment for repair work at a facility. System 10 stores the information, referred to herein as Real Estate (RE) information, such that the business may manage these facilities.

Workflow

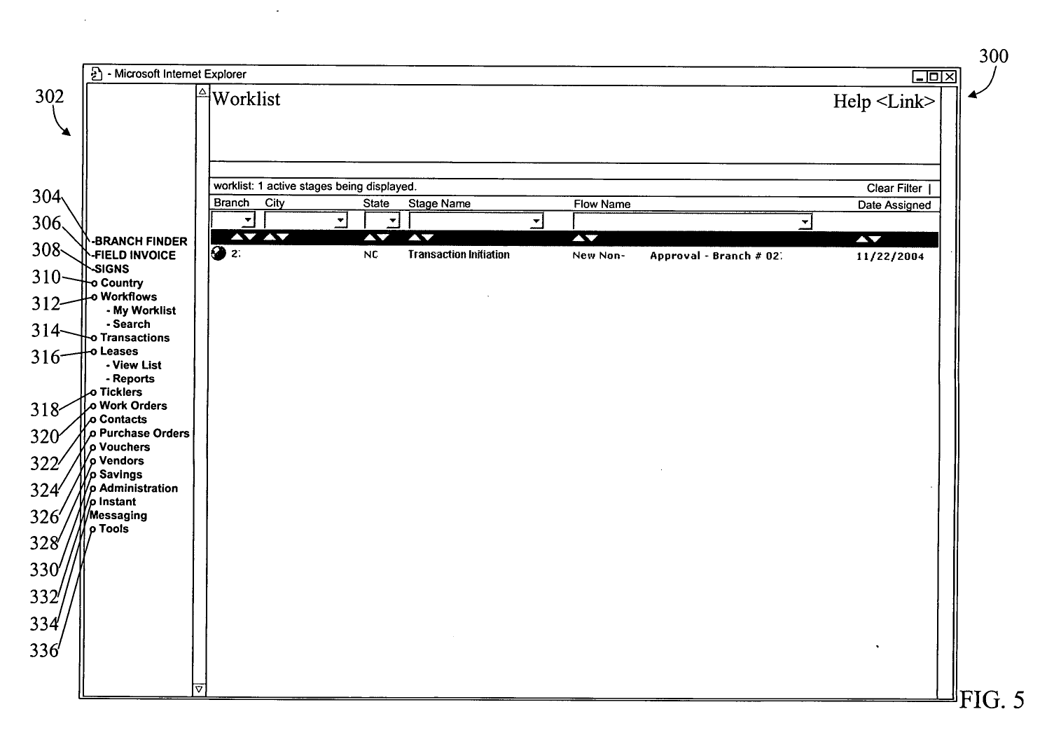

FIG. 5 through FIG. 22 are example embodiments of user interfaces displaying workflow pages included within REWMS 10 (shown in FIG. 1). These user interfaces are displayed when the workflow tool option is selected by a user.

FIG. 5 is an example embodiment of a user interface 300 displaying a worklist page included within REWMS 10 (shown in FIG. 1). In the example embodiment, user interface 300 displays along the left-side a navigation bar 302 including a plurality of links. Navigation bar 302 is displayed on numerous screen pages included within REWMS 10 to better enable a user to navigate the system.

Navigation bar 302 includes a branch finder link 304, a field invoice link 306, a signs link 308, a country link 310, a workflows link 312, a transactions link 314, a leases link 316, a ticklers link 318, a work orders link 320, a contacts link 322, a purchase orders link 324, a vouchers link 326, a vendors link 328, a savings link 330, an administration link 332, an instant messaging link 334, and a tools link 336. In the example embodiment, user interface 300 also displays a branch pull-down list, a city pull-down list, a state pull-down list, a stage name pull-down list, a flow name pull-down list, and a date assigned data field. User interface 300 enables a user to view any transactions assigned to the user that have been included within the user's worklist.

In the example embodiment, user interface 300 lists a single transaction indicating that the user must initiate a transaction. By clicking on the transaction initiation entry, system 10 displays a screen that prompts the user to enter a transaction manager for this particular transaction.

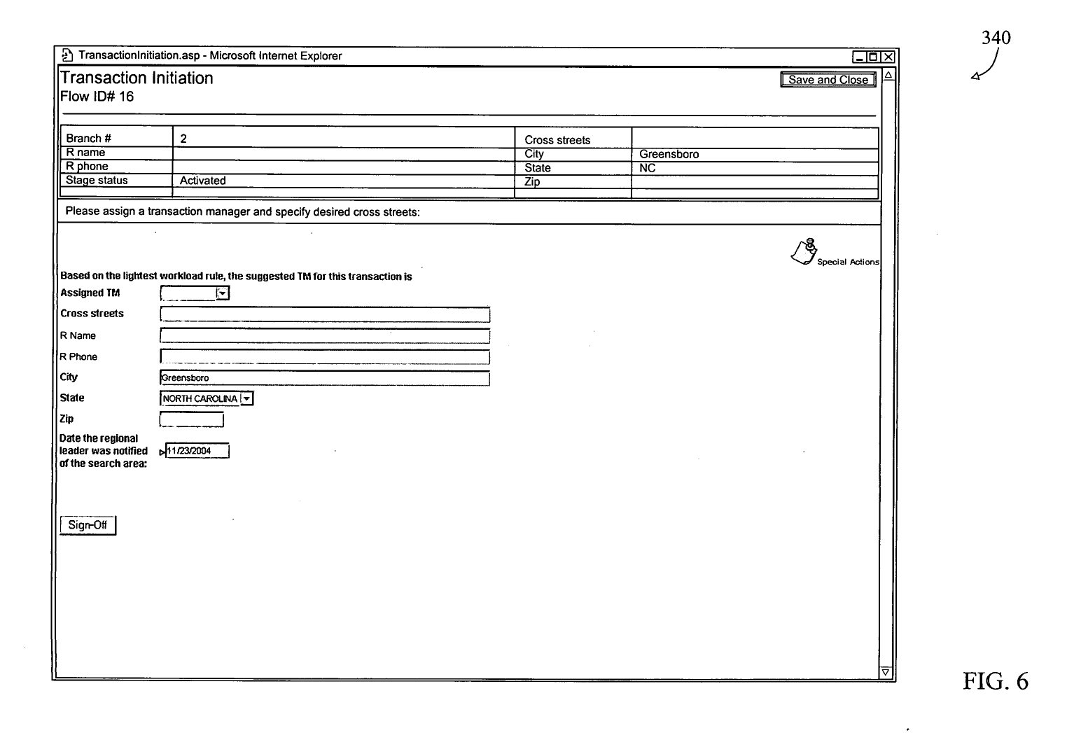

FIG. 6 is an example embodiment of a user interface 340 displaying a transaction initiation page included within REWMS 10 (shown in FIG. 1). In the example embodiment, user interface 340 is displayed when the user clicks on the transaction initiation entry displayed in FIG. 5. User interface 340 prompts a user to assign a transaction manager, and specify desired cross streets for a particular transaction. In this case, the transaction relates to a facility to be leased by the business.

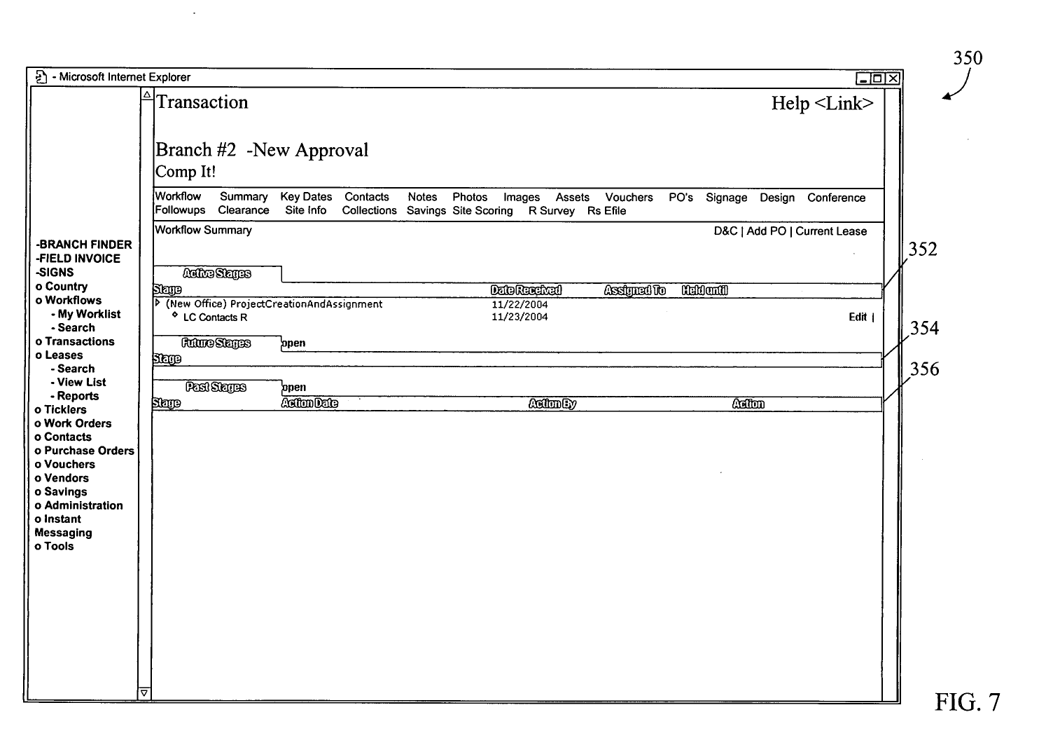

FIG. 7 is an example embodiment of a user interface 350 displaying a workflow summary page included within REWMS 10 (shown in FIG. 1). In the example embodiment, user interface 350 includes navigation bar 302 (shown in FIG. 5) and a tool bar positioned along the top of user interface 350. The tool bar includes options, such as, workflow summary, key dates, contacts, notes, photos, images, assets, vouchers, POs, signage, design, conference, follow-ups, clearance, site info, collections, savings, site scoring, R survey, Rs, and Efile. User interface 350 also displays an active stages section 352, a future stages section 354, and a past stages section 356. Active stages section 352 displays those tasks to be performed within a predetermined period of time and in a recommended sequence to progress the transaction toward completion. Future stages section 354 includes tasks that will likely need to be performed in the future in a recommended sequence to complete the transaction. Past stages section 356 includes those tasks that have already been performed to progress the transaction toward completion.

In one embodiment, the tasks listed in active stages section 352 and the future stages section 354 are listed in a recommended order to be performed for a typical transaction. However, the sequence for performing these tasks can be customizable based on the type of transaction being performed.

In the example embodiment, user interface 350 indicates that the user assigned to this transaction has been prompted to contact the “R” (Representative or Field Representative or Lessee Representative) as part of the transaction process. By clicking on this entry, system 10 displays another page that prompts the user to contact the “R” and then sign off the page to indicate that that particular task has been performed.

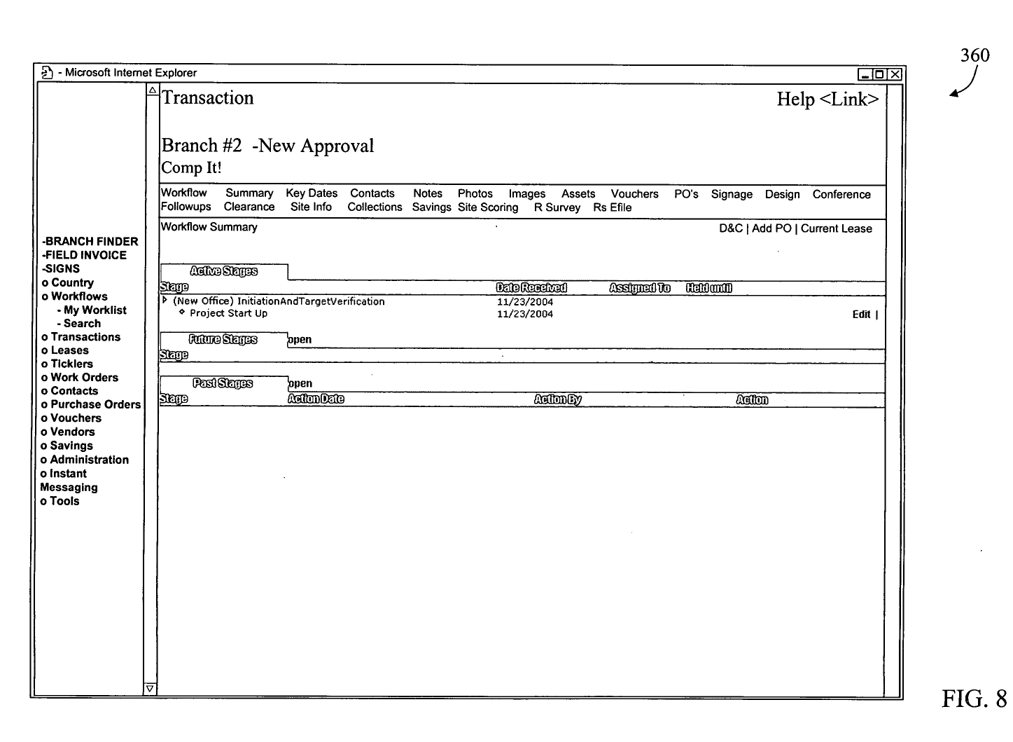

FIG. 8 is an example embodiment of a user interface 360 displaying a workflow summary page included within REWMS 10 (shown in FIG. 1). In the example embodiment, user interface 360 shows that one of the active stages includes a project start up for a new office facility. By clicking on the project start up entry included within the active stages section, a page is displayed that prompts the user to enter additional information relating to the location of the facility including whether the “R” rejects the street intersection where the potential facility is located. From this page, a user can also click on a POP (Preferred Owner Program) link, which enables the user to search for shopping centers and other major business located within a designated radius of the selected intersection.

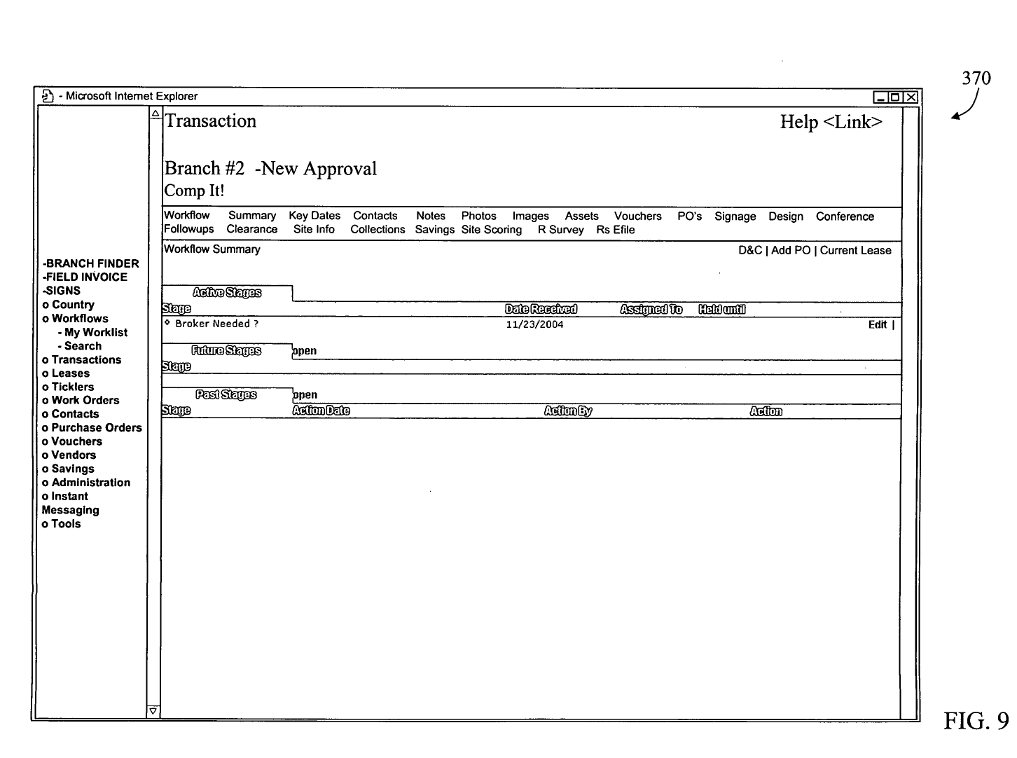

FIG. 9 is an example embodiment of a user interface 370 displaying a workflow summary page included within REWMS 10 (shown in FIG. 1). In the example embodiment, user interface 370 includes a broker needed task entry included within the active stages section. By clicking on the broker needed entry, system 10 displays another page (not shown) that prompts the user to designate whether a real estate broker (REB) will be needed as part of this transaction. System 10 prompts the user to input whether to use a broker or whether to not use a broker. Once this task is completed, the information is stored within system 10 and the workflow summary page is updated. If it is determined that a real estate broker will be needed as part of the transaction, system 10 prompts the user to enter the information relating to the real estate broker to be used.

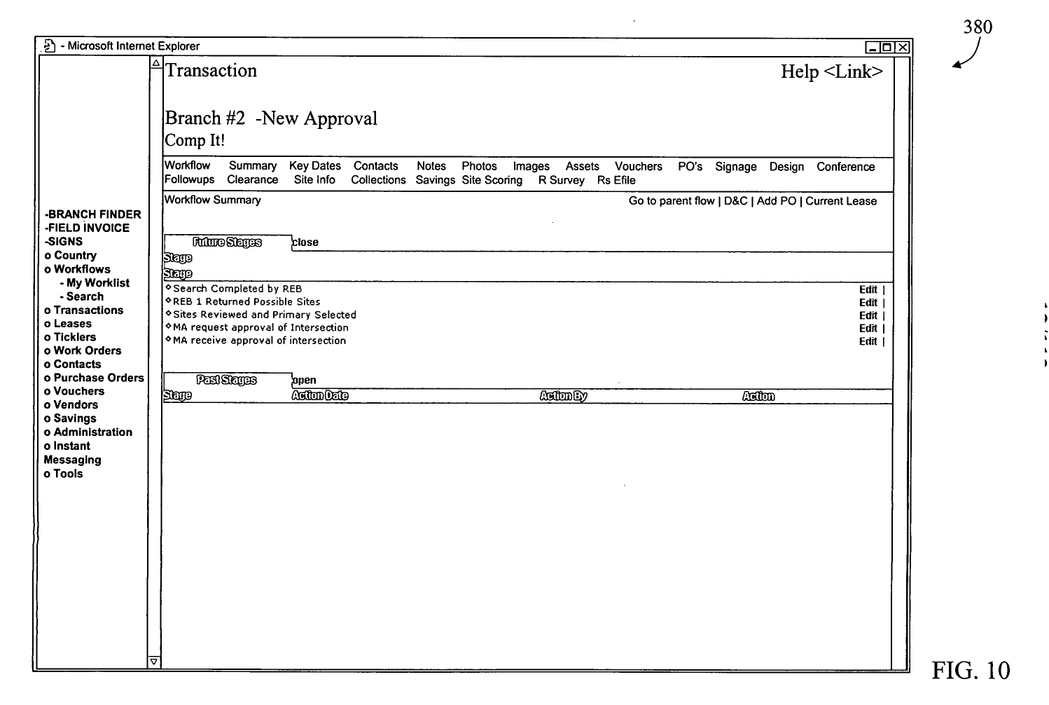

FIG. 10 is an example embodiment of a user interface 380 displaying a workflow summary page included within REWMS 10 (shown in FIG. 1). In the example embodiment, user interface 380 includes several task entries shown within the future stages section. These entries include search completed by real estate broker (REB); REB 1 returned possible sites; sites reviewed and primary selected; MA (Market Analysis) request approval of intersection; and MA receive approval of intersection. These tasks all relate to locating and approving the selection of a facility to be leased by the business.

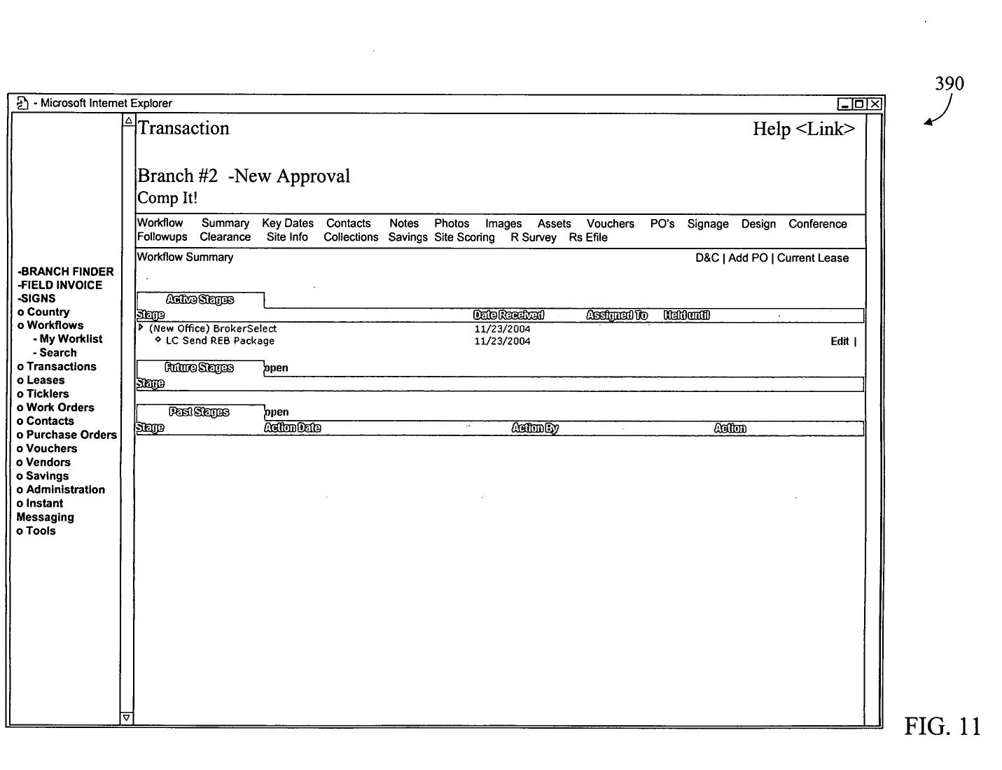

FIG. 11 is an example embodiment of a user interface 390 displaying a workflow summary page included within REWMS 10 (shown in FIG. 1). In the example embodiment, user interface 390 includes a LC (Leasing Coordinator) send REB package entry included within the active stages section. By clicking on the LC send REB package entry, system 10 displays a page (not shown) that provides the user with the contact information for the broker assigned to this transaction and includes a package sent button (not shown). By clicking on the package sent button, the user indicates that the primary site search package has been sent to the indicated broker. System 10 then provides that primary site search package to the broker and updates the workflow summary.

In the example embodiment, the LC can be an employee of the business or can be an employee of an outside company responsible for managing properties of the business.

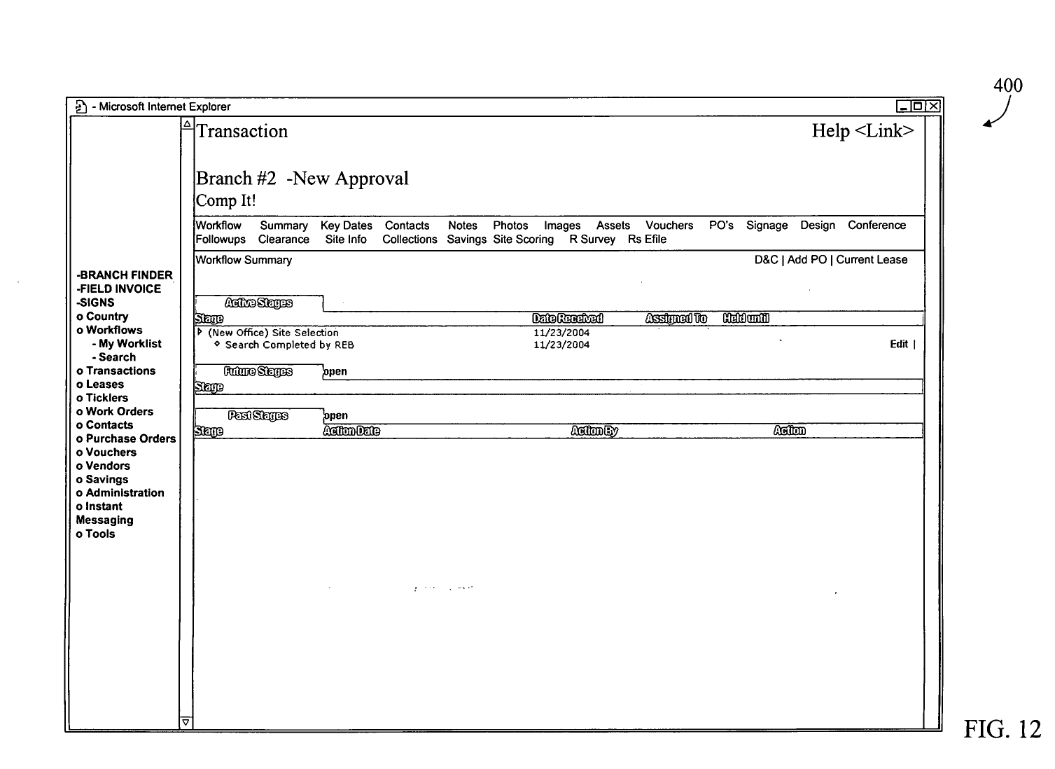

FIG. 12 is an example embodiment of a user interface 400 displaying a workflow summary page included within REWMS 10 (shown in FIG. 1). In the example embodiment, user interface 400 displays a search completed by REB entry included within the active stages section. By clicking on the search completed by REB entry, system 10 displays a page (not shown) that lists the sites located by the REB satisfying the business' search request. The user is then prompted to select a primary site from the list of sites provided by the REB. System 10 then prompts the user to send a request to market analysis for analyzing the location of the selected primary site. Once completed, system 10 updates the workflow summary.

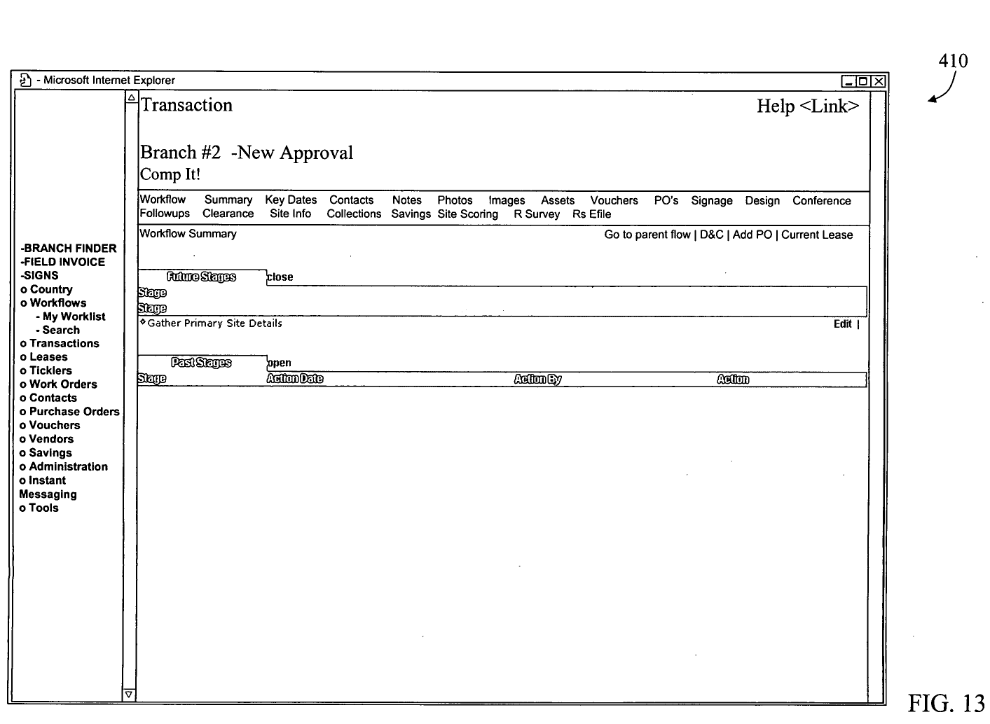

FIG. 13 is an example embodiment of a user interface 410 displaying a workflow summary page included within REWMS 10 (shown in FIG. 1). In the example embodiment, user interface 410 includes a gather primary site details entry included within the future stages section. By clicking on the gather primary site details entry, system 10 displays several pages (not shown) that prompt the user to enter information so that details can be gathered relating to the primary site, and prompt the user to request business approvals from a business leader (BL) and a property locator (PL).

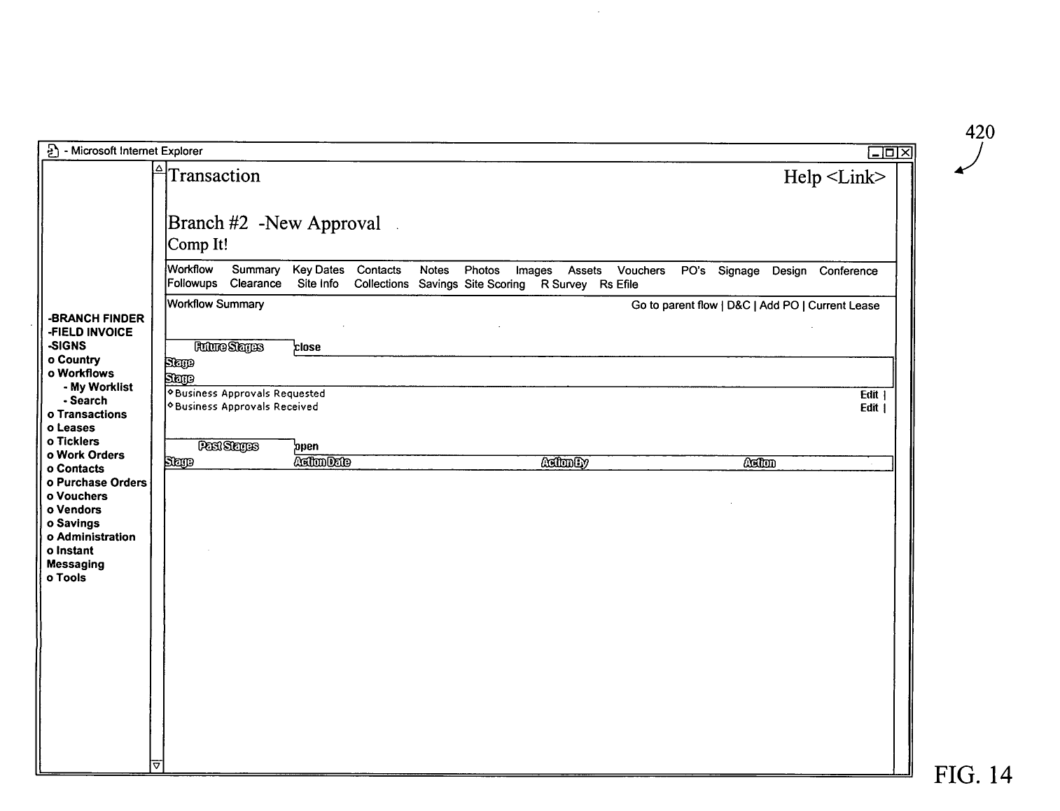

FIG. 14 is an example embodiment of a user interface 420 displaying a workflow summary page included within REWMS 10 (shown in FIG. 1). In the example embodiment, user interface 420 includes a business approvals requested entry, and a business approvals received entry included within the future stages section. By clicking on these entries, system 10 displays several pages (not shown) that prompt the user to enter a date that approval was received from a business leader, and a date that approval was received from a property locator. Once entered, system 10 updates the workflow summary.

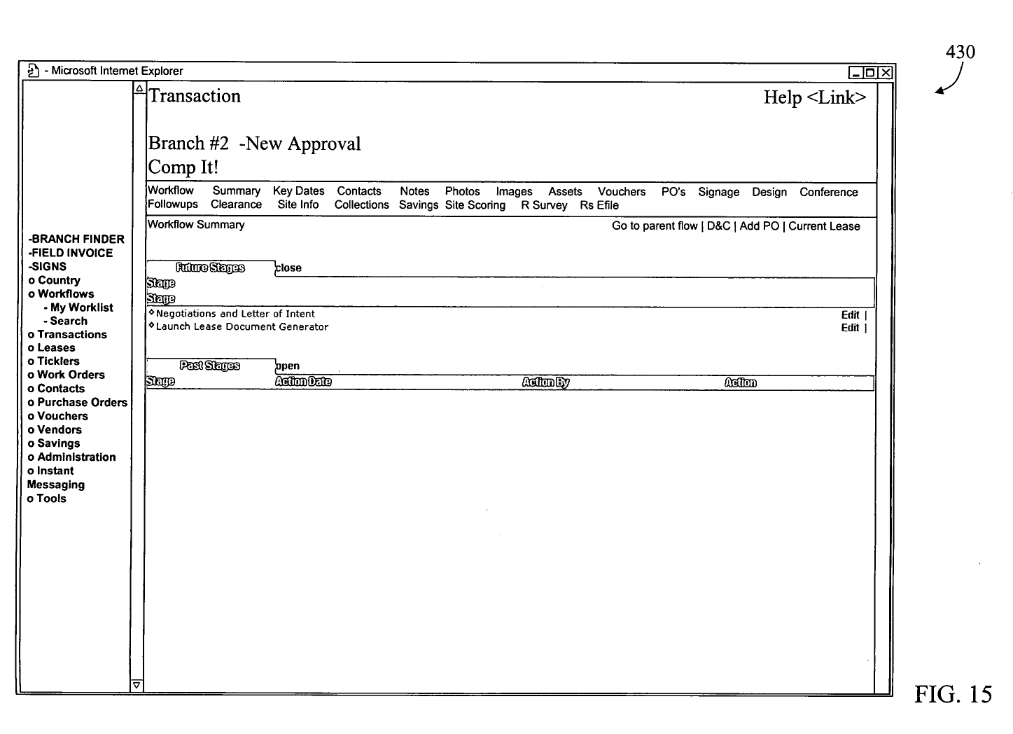

FIG. 15 is an example embodiment of a user interface 430 displaying a workflow summary page included within REWMS 10 (shown in FIG. 1). In the example embodiment, user interface 430 includes a negotiations and letter of intent entry, and a launch lease document generator entry included within the future stages section. By selecting the negotiations and letter of intent entry, system 10 prompts the user to negotiate a letter of intent for leasing or purchasing the facility located at the primary site. This task is performed after the appropriate approvals have been obtained for the facility located at the primary site.

By selecting the launch lease document generator entry, system 10 prompts the user to prepare a lease agreement to be submitted to the landlord (LLD) of the approved facility such that the business can enter into a lease agreement with the landlord. As explained below, the lease document generator prompts the user to enter certain specific information, and then uses the entered information to generate a lease agreement that includes certain pre-approved terms and conditions.

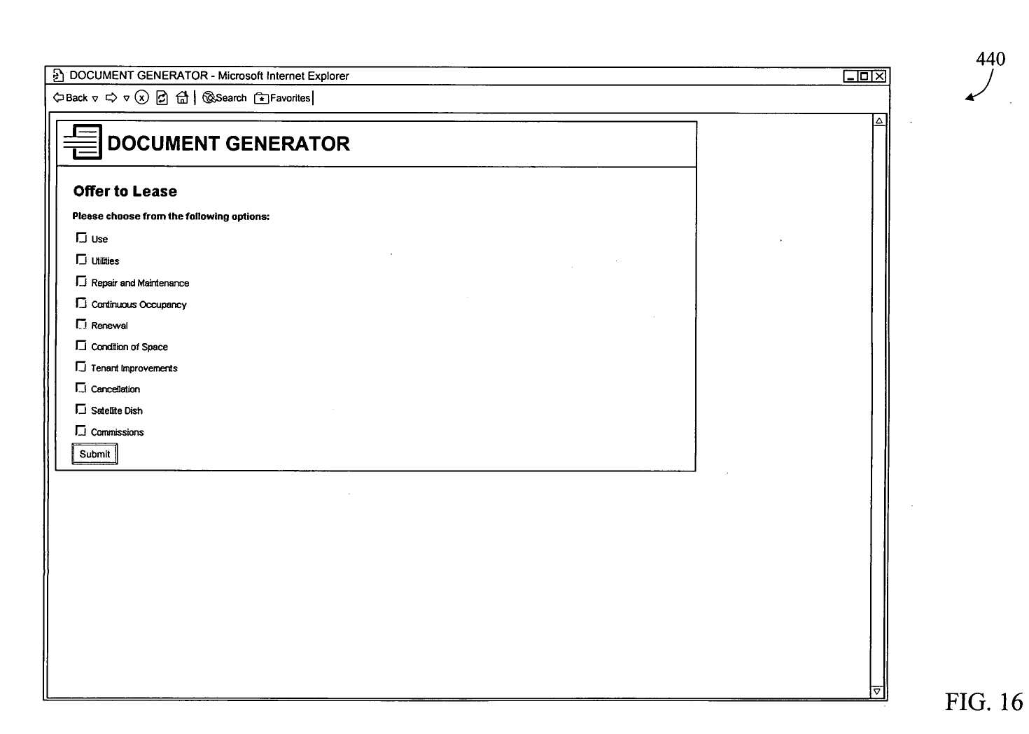

FIG. 16 is an example embodiment of a user interface 440 displaying an offer to lease document generator page included within REWMS 10 (shown in FIG. 1). In the example embodiment, user interface 440 includes several options including a use check box, a utilities checkbox, a repair and maintenance checkbox, a continuous occupancy checkbox, a renewal checkbox, a condition of space checkbox, a tenant improvements checkbox, a cancellation checkbox, a satellite dish checkbox, and a commissions checkbox. By selecting one of these checkboxes, the user prompts system 10 to generate a document corresponding to the selected checkbox. Based on the selected checkbox, system 10 displays a series of pages that prompt the user to enter certain specific information relating to the facility to be leased including at least one of entering a branch number for the facility, choosing the type of documents to be generated, and selecting options to be included within the lease agreement including, but not limited to, early termination, option to renew, restricted use, tenant improvements, repair and maintenance, agency disclosure, free rent, and continuous occupancy.

In addition, in the example embodiment, the user is prompted to provide at least the following information in generating the lease agreement: landlord contacts, landlord information, address of facility, satellite dish information, occupancy and commencement of term, option to renew, use of facility, utilities to be provided at the facility, parking at the facility, repair and maintenance at the facility, compliance with laws and ordinances, holdover, continuous occupancy, term of the lease, and rent to be paid by the tenant. After the information is provided, system 10 generates a lease agreement incorporating the information provided by the user and including certain pre-approved terms and conditions that apply to the leasing of the facility by the business. System 10 then transmits this information to the landlord for review and approval. Once approved by the landlord, the lease agreement can be executed by both parties and then stored in system 10.

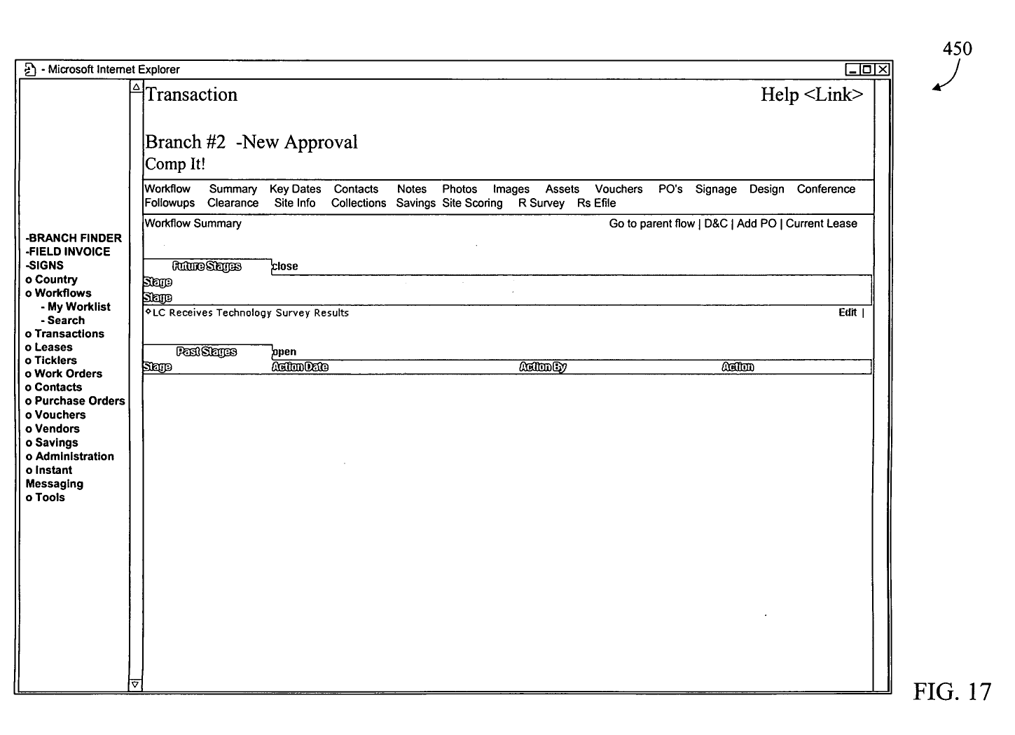

FIG. 17 is an example embodiment of a user interface 450 displaying a workflow summary page included within REWMS 10 (shown in FIG. 1). In the example embodiment, user interface 450 includes an LC (Leasing Coordinator) receives technology survey results entry included within the future stages section. By clicking on the LC receives technology survey results entry, system 10 displays a series of pages (not shown) that prompt the user to input information relating to the installation of a satellite system at the facility. The information entered by the user relating to the satellite system includes at least one of how the satellite is to be mounted to the facility including at least one of a ground mount, NPM, other, penetrating roof mount, pole mount, ridge mount, or tall pole. User interface 450 prompts the user to insure that the satellite system is installed at the facility such that the facility can communicate with the business.

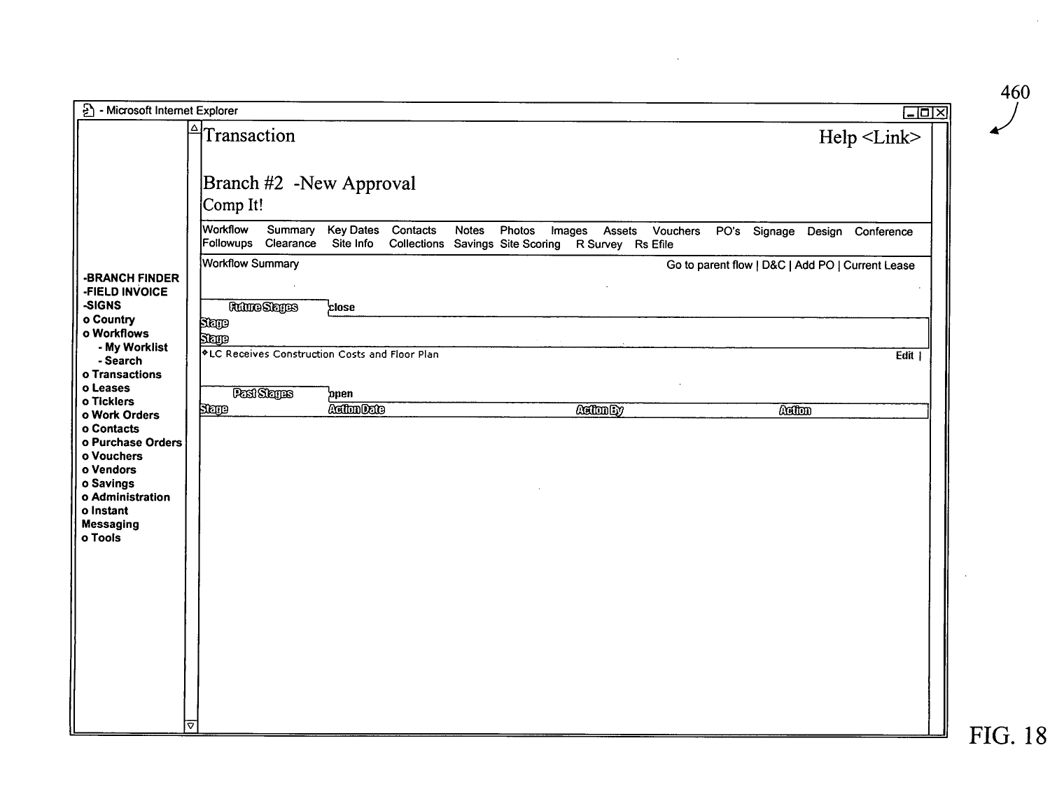

FIG. 18 is an example embodiment of a user interface 460 displaying a workflow summary page included within REWMS 10 (shown in FIG. 1). In the example embodiment, user interface 460 displays an LC (Leasing Coordinator) receives construction costs and floor plan entry included within the future stages section. By clicking on the LC receives construction costs and floor plan entry, system 10 displays at least one page (not shown) prompting the user to enter whether the construction pricing and the floor plan have been received. By entering this information, user interface 460 is updated to indicate that the construction costs and floor plan have been received.

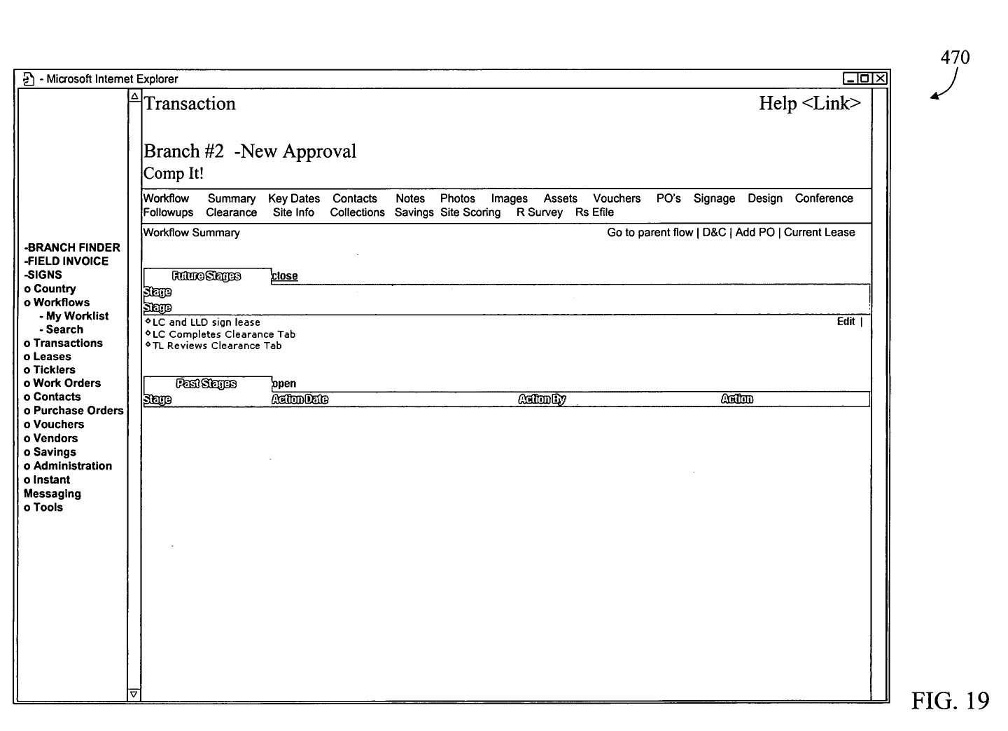

FIG. 19 is an example embodiment of a user interface 470 displaying a workflow summary page included within REWMS 10 (shown in FIG. 1). In the example embodiment, user interface 470 displays several entries included within the future stages section. The entries include LC (Leasing Coordinator) and LLD (Landlord) sign lease, LC completes clearance tab, and TL (Team Leader) reviews clearance tab. By clicking on the LC and LLD sign lease entry, the system prompts the user to enter the dates the lease agreement was signed by the LLD and by the LC. This information is then stored within system 10 and user interface 470 is updated to show that the LC and LLD have signed the lease.

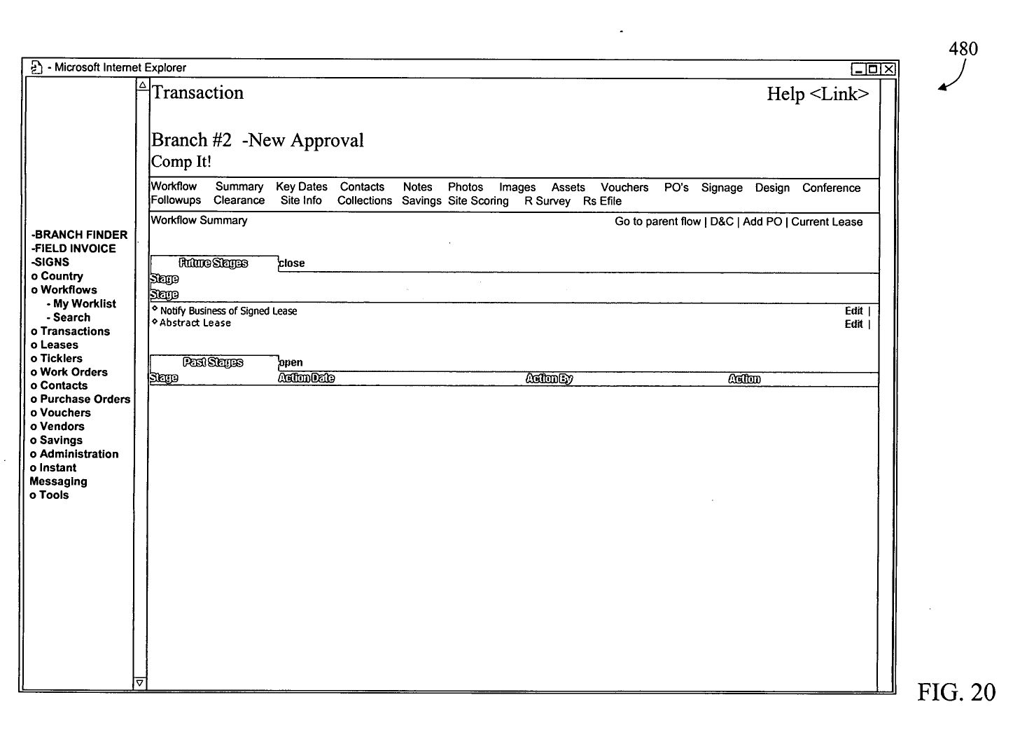

FIG. 20 is an example embodiment of a user interface 480 displaying a workflow summary page included within REWMS 10 (shown in FIG. 1). In the example embodiment, user interface 480 displays two (2) entries within the future stages section. The entries include notify business of signed lease, and abstract lease. By clicking on the notify business of signed lease entry, system 10 prompts the user to electronically send notification to the business advising the business that the lease has been signed by all parties. By selecting the abstract lease entry shown on user interface 480, system 10 prompts the user to enter whether an auto abstract of the lease should be generated by system 10. This information is then stored within REWMS 10 and user interface 480 is updated to show that these tasks have been completed.

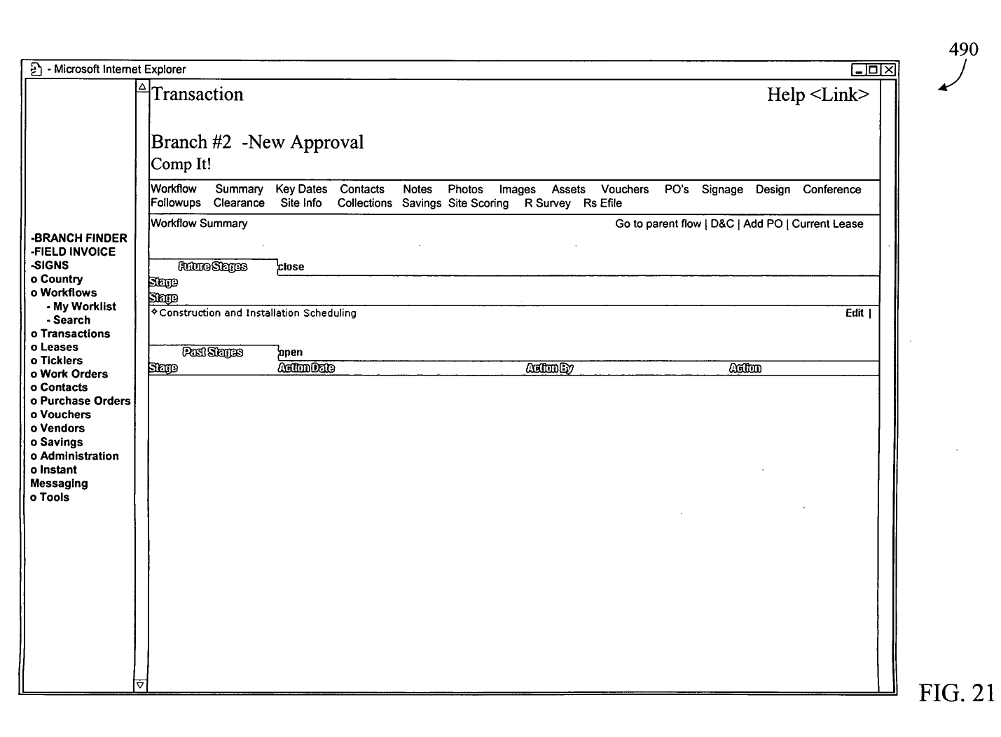

FIG. 21 is an example embodiment of a user interface 490 displaying a workflow summary page included within REWMS 10 (shown in FIG. 1). In the example embodiment, user interface 490 includes a construction and installation scheduling entry included within the future stages section. User interface 490 prompts a user to enter information into system 10 indicating when certain construction and/or installation will be performed at the facility. After the construction and/or installation is performed, system 10 updates user interface 490 showing that these tasks have been completed.

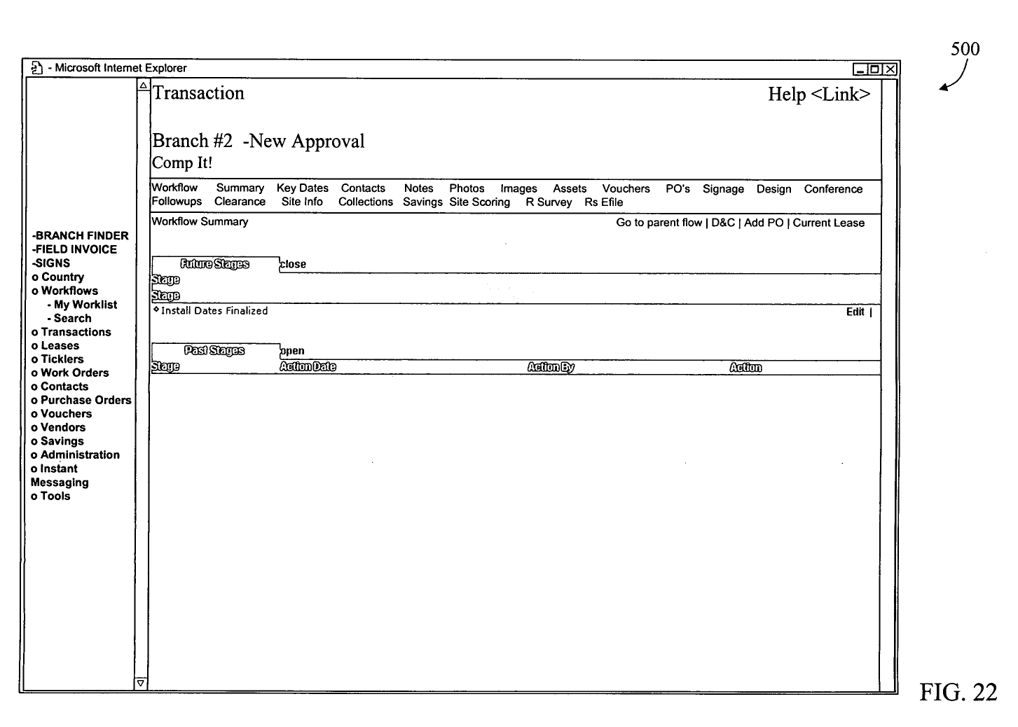

FIG. 22 is an example embodiment of a user interface 500 displaying a workflow summary page included within REWMS 10 (shown in FIG. 1). In the example embodiment, user interface 500 displays an installed dates finalized entry within the future stages section. By selecting the install dates finalized entry on user interface 500, system 10 prompts the user to enter the dates that the technology systems will be installed at the facility. These technology systems may include a satellite system. After entering this information, system 10 updates user interface 500 showing that this task has been completed.

Transactions

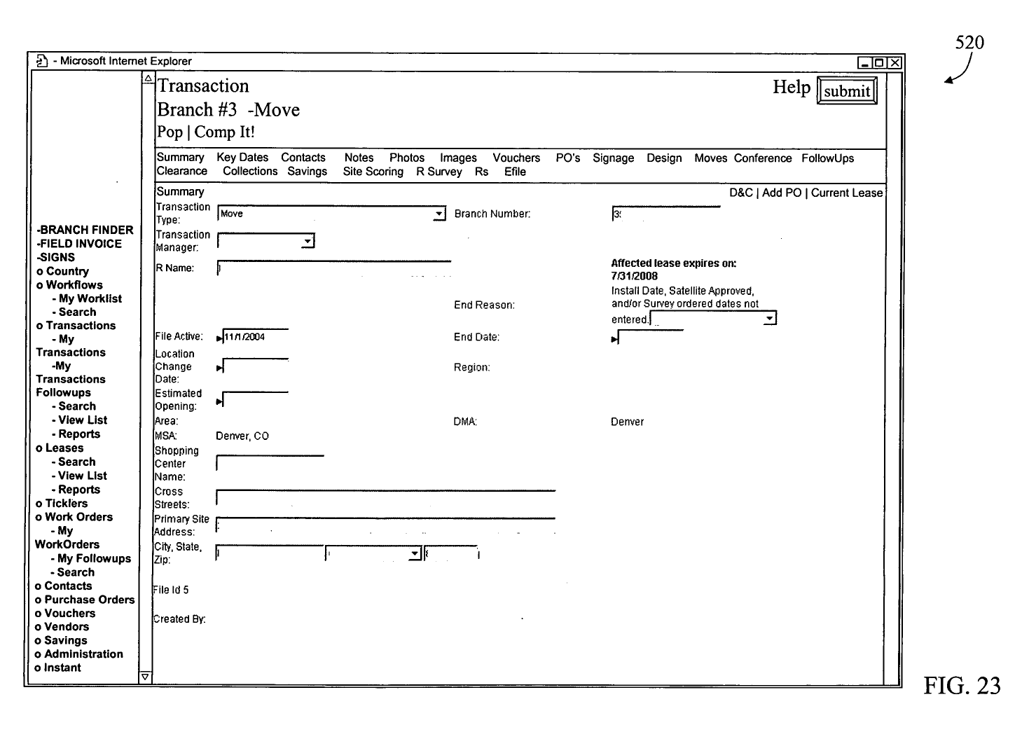

FIG. 23 through FIG. 43 are example embodiments of user interfaces displaying transaction pages included within REWMS 10 (shown in FIG. 1). These user interfaces are displayed when the transactions tool option (transactions link 314 shown in FIG. 5) is selected by a user.

FIG. 23 is an example embodiment of a user interface 520 displaying a transactions summary page included within REWMS 10 (shown in FIG. 1). In the example embodiment, user interface 520 provides an interface allowing a user to enter summary information regarding transactions. Specifically, a user can select a transaction type and a transaction manager. A lessee representative name can also be entered. As used herein, “R” denotes the name of a representative for the lessee in the field. A branch number can be entered, a file active date, an end date, a location change date, an estimated opening date, a shopping center name may be entered, in addition to cross streets, a primary site address, city state and zip code for the entered branch number.

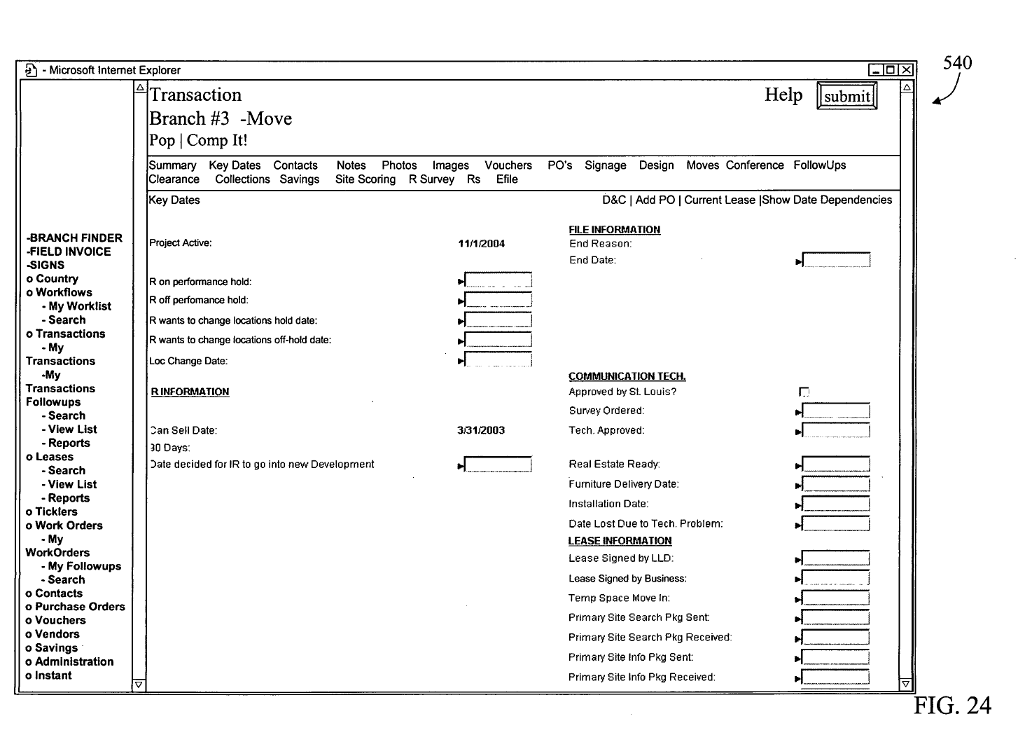

FIG. 24 is an example embodiment of a user interface 540 displaying a transactions key dates page included within REWMS 10 (shown in FIG. 1). In the example embodiment, user interface 540 provides an interface allowing a user to enter key dates associated with a transaction. Key dates include a project active date, “R” on performance hold date, “R” off performance hold date, “R” wants to change locations hold date, “R” wants to change locations off date, and LOC change date. Also information related to the lessee representative includes a can sell date and a date decided for the lessee representative to go into new development. Other date information with a transaction includes a survey order date, technology approved date, real estate ready date, furniture delivery date, installation date, and dates lost to technical problems. Lease information includes a date the lease is signed by the landlord, the date the lease is signed by the lessee, a temporary space move in date, a primary site search package sent date, a primary site search package received date, a primary site information package sent date, and a primary site information package received date.

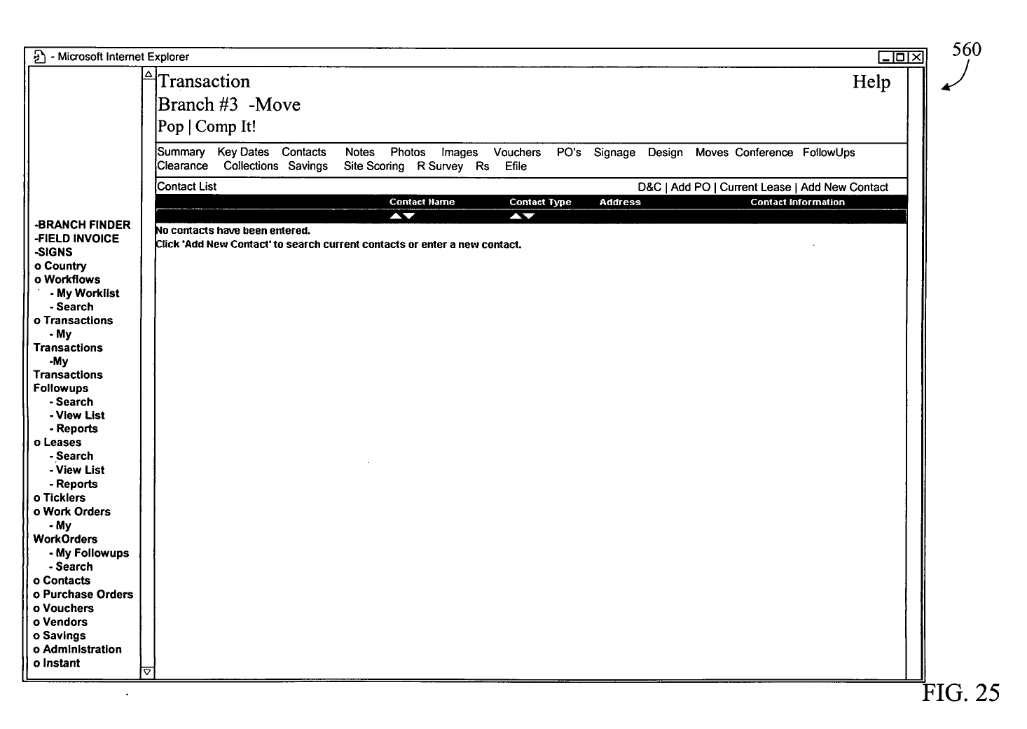

FIG. 25 is an example embodiment of a user interface 560 displaying a transactions contacts page included within REWMS 10 (shown in FIG. 1). In the example embodiment, user interface 560 allows the user to access or enter contacts in a contact list including a contact name, a contact type, an address for the contact and information, for example, a phone number for a contact. In order to add a new contact, there is a link entitled, Add New Contact, which may be selected by a user.

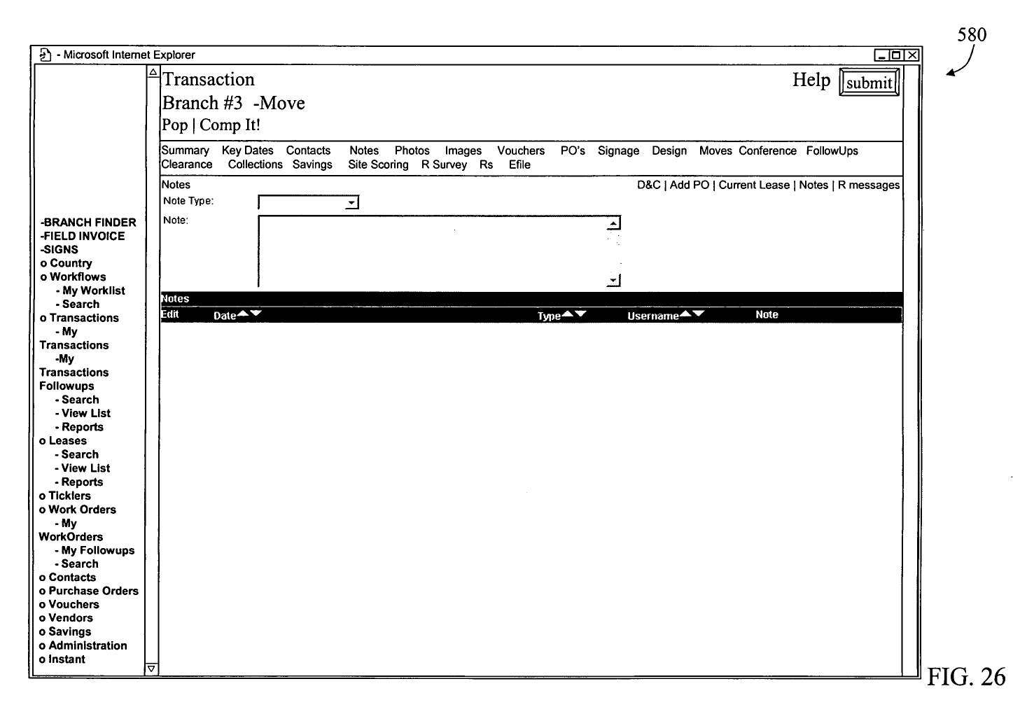

FIG. 26 is an example embodiment of a user interface 580 displaying a transactions notes page included within REWMS 10 (shown in FIG. 1). In the example embodiment, user interface 580 allows the user to access and enter notes relating to a transaction. As illustrated in user interface 580, a user may select a note type and enter a text field for the particular note. A user may also select and edit previously entered notes by selecting notes, by scrolling by date, type or by user name as shown in user interface 580.

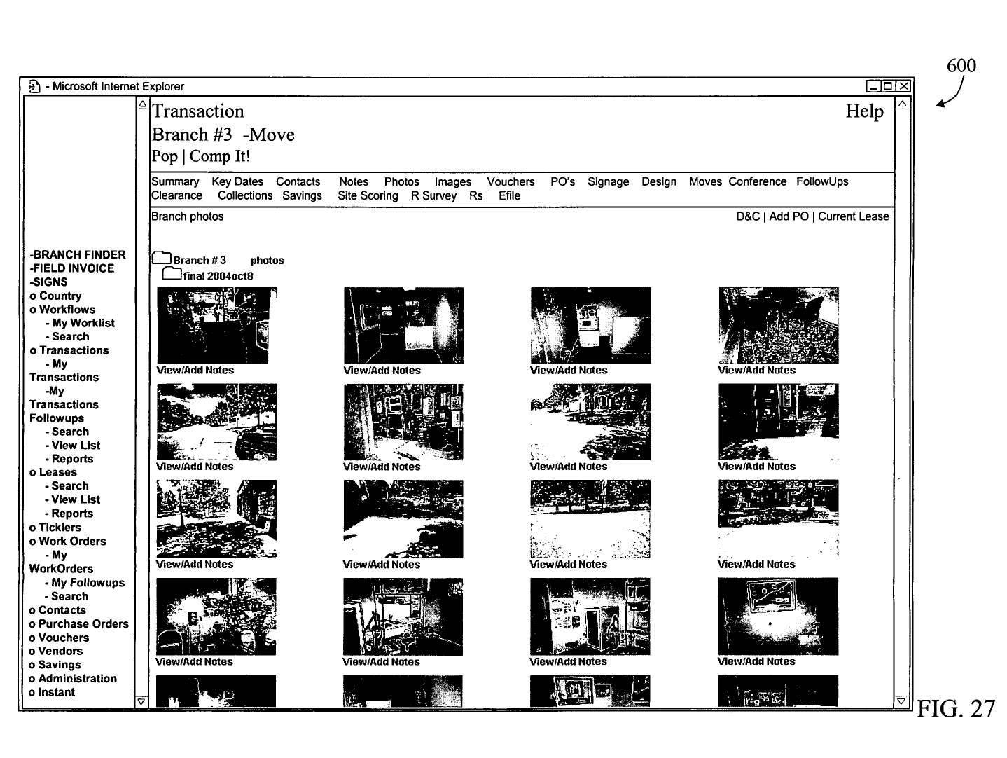

FIG. 27 is an example embodiment of a user interface 600 displaying a transactions photographs page included within REWMS 10 (shown in FIG. 1). In the example embodiment, user interface 600 is configured to display photographs associated with a transaction (i.e., a photograph of the facility). By selecting one of the photographs of the transaction, the user may view or add the notes associated with a particular photograph.

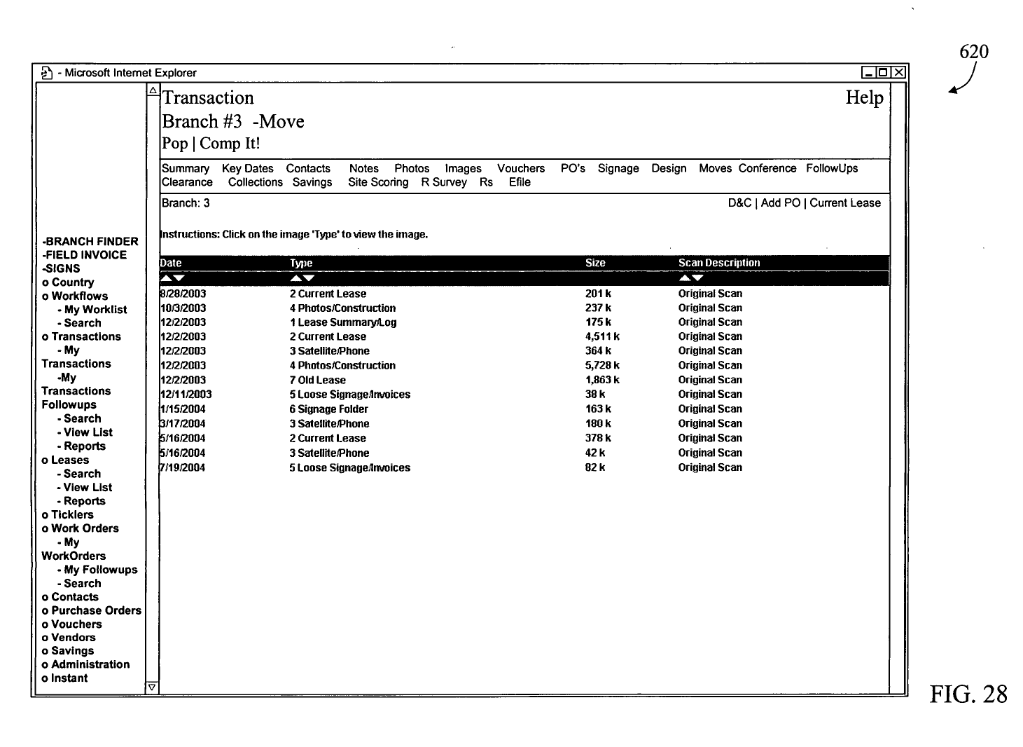

FIG. 28 is an example embodiment of a user interface 620 displaying a transactions images page included within REWMS 10 (shown in FIG. 1). In the example embodiment, user interface 620 allows the user to select stored images associated with the transaction. Examples of such images that a user may select and view include, but are not limited to, the current lease, photos during construction, satellite and phone images, an old lease, signage folders, and loose signage and invoices.

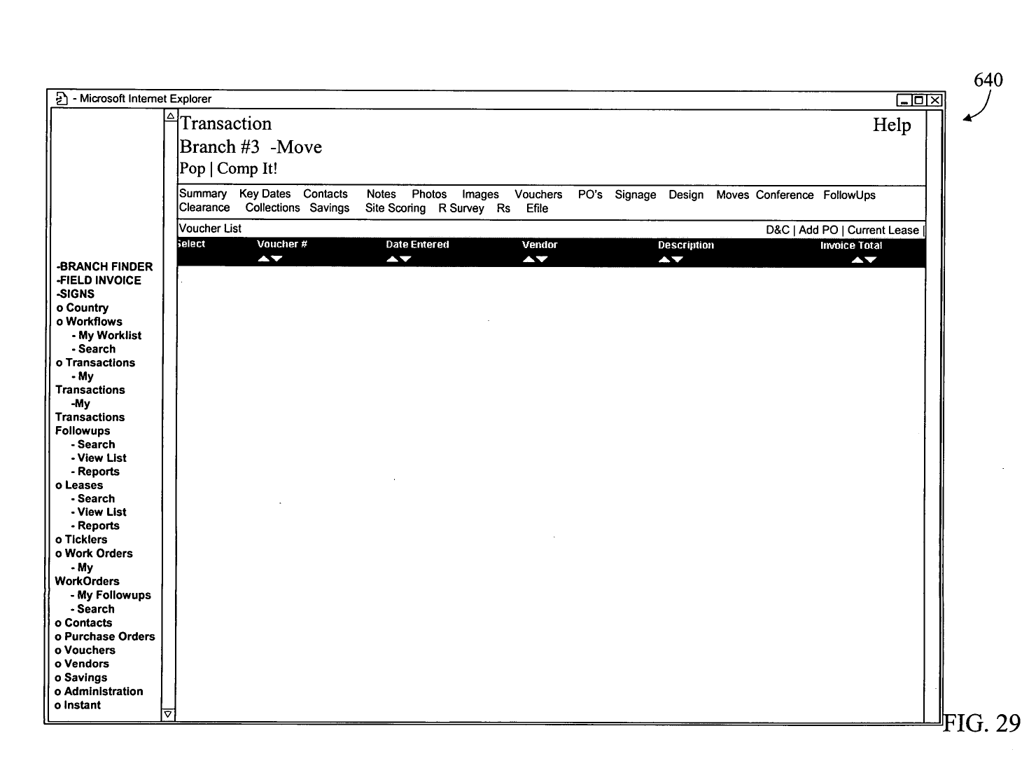

FIG. 29 is an example embodiment of a user interface 640 displaying a transactions vouchers page included within REWMS 10 (shown in FIG. 1). In the example embodiment, user interface 640 allows the user to select and display vouchers associated with the transaction. As illustrated in user interface 640, a user may sort vouchers by a voucher number, a date entry, a vendor, a description, and an invoice total.

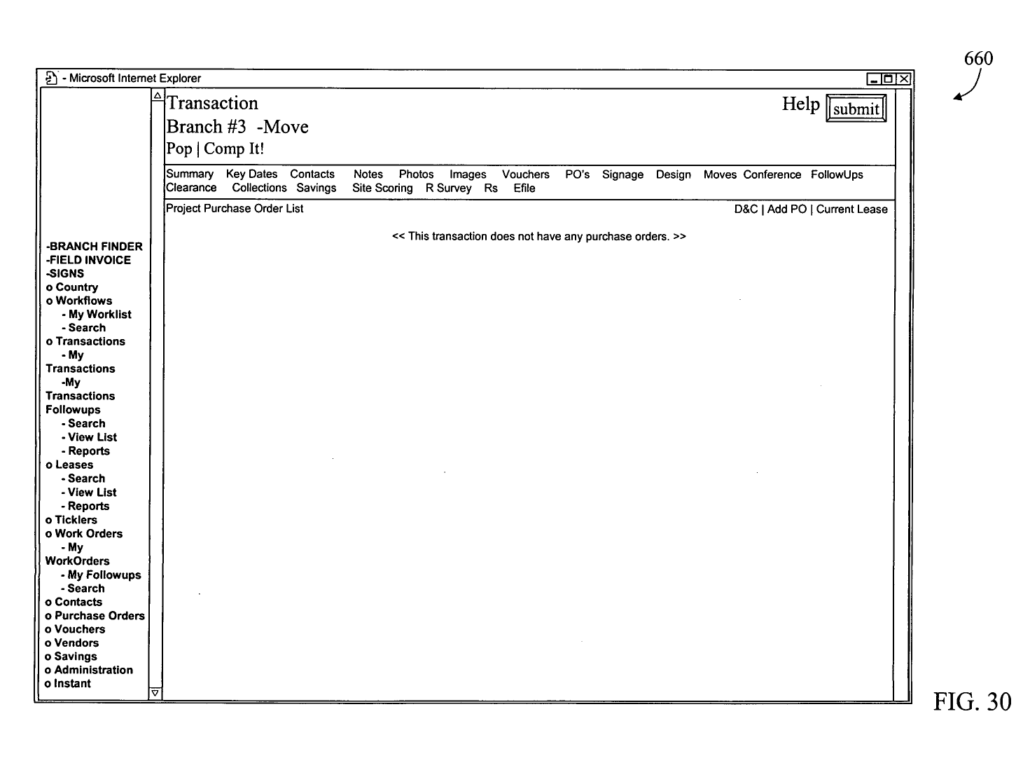

FIG. 30 is an example embodiment of a user interface 660 displaying a transactions purchase orders page included within REWMS 10 (shown in FIG. 1). In the example embodiment, user interface 660 displays a list of project purchase orders associated with a transaction. Similarly to the voucher list displayed in FIG. 29, a user may select stored purchase orders by scrolling through a choice of purchase order numbers, date entry, vendors, and description.

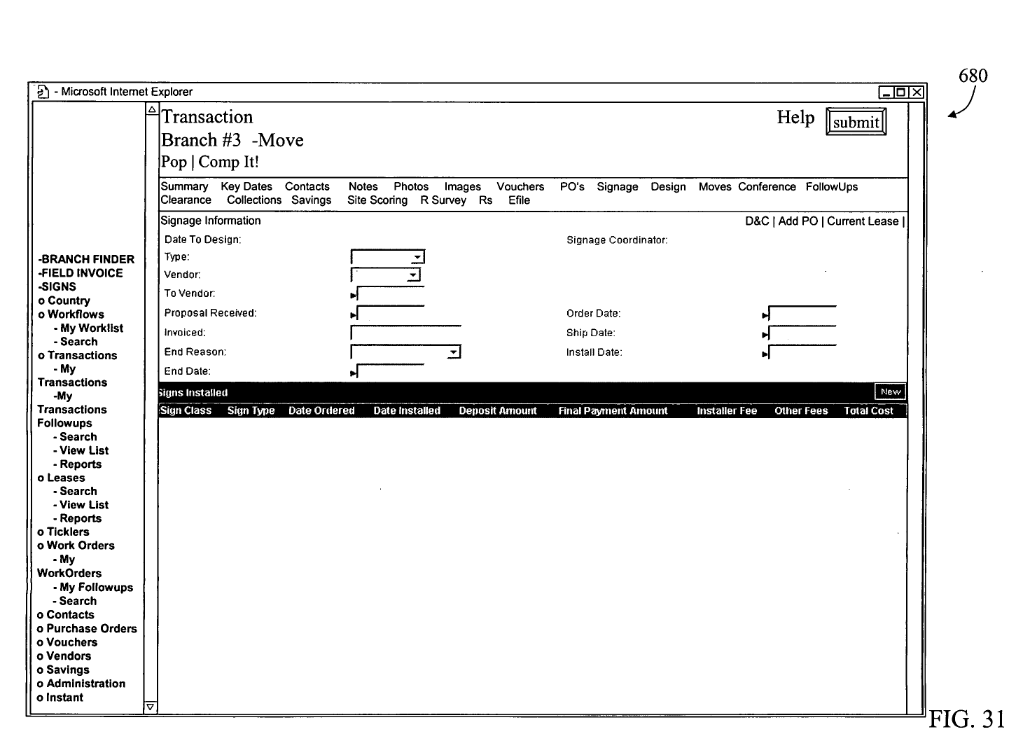

FIG. 31 is an example embodiment of a user interface 680 displaying a transactions signage information page included within REWMS 10 (shown in FIG. 1). In the example embodiment, user interface 680 allows a user to access and enter information regarding signage for a transaction location. Information that can be entered by a user relating to signage includes a type, a vendor, a proposal received date, a to vendor date, an invoice date, an end reason for removing the signage, and an end date. Also, an order date, a ship date and an install date may be entered. In addition to entry of signage information for new signs, a user may also view information relating to previously installed signs. Information for previously installed signs stored within REWMS 10, (shown in FIG. 1) include sign class, sign type, date ordered, date installed, deposit amount, final payment, installer fee, other fees and total cost.

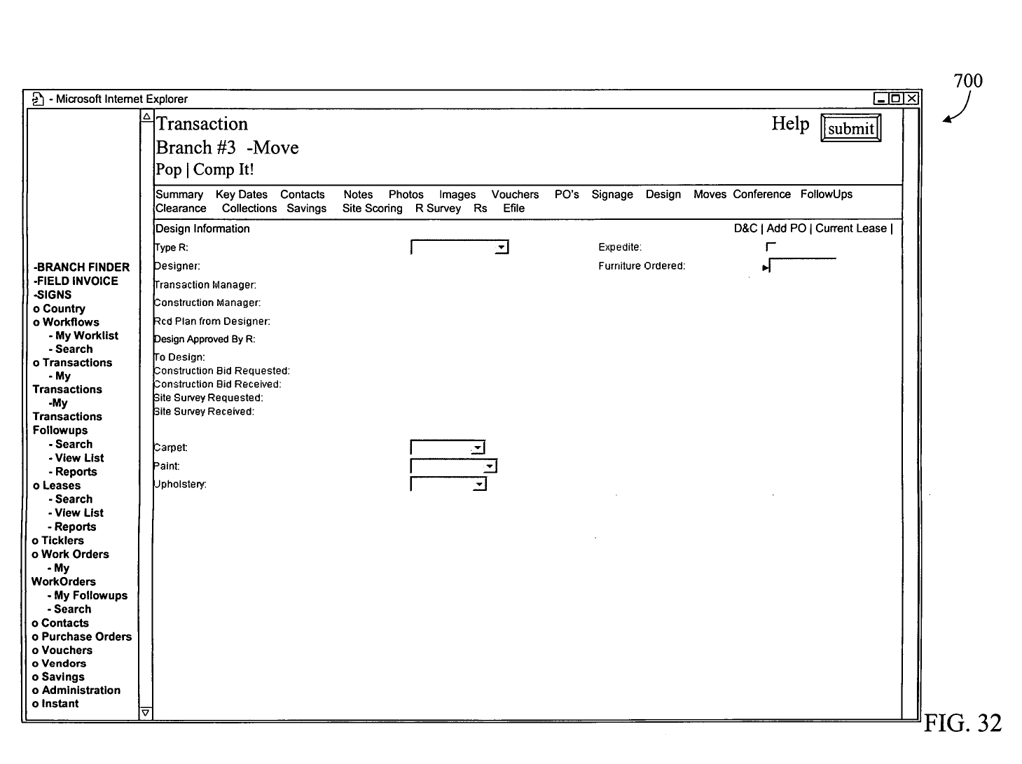

FIG. 32 is an example embodiment of a user interface 700 displaying a transactions design information page included within REWMS 10 (shown in FIG. 1). In the example embodiment, user interface 700 allows a user to enter and view design information relating to a specific transaction. Design information that might be entered by a user include the type of lessee representative, if the order design should be expedited, and a date that furniture is ordered for the facility. Dates for carpet, paint and upholstery may also be entered by a user through user interface 700. An additional design information that might be viewed or entered by a user include name of designer, name of a transaction manager, a construction manager, whether or not the plan from the designer has been received, whether or not the design has been approved by the lessee representative, and, also relating to the design, whether the construction bids have been requested and received and if the site survey has been requested and received.

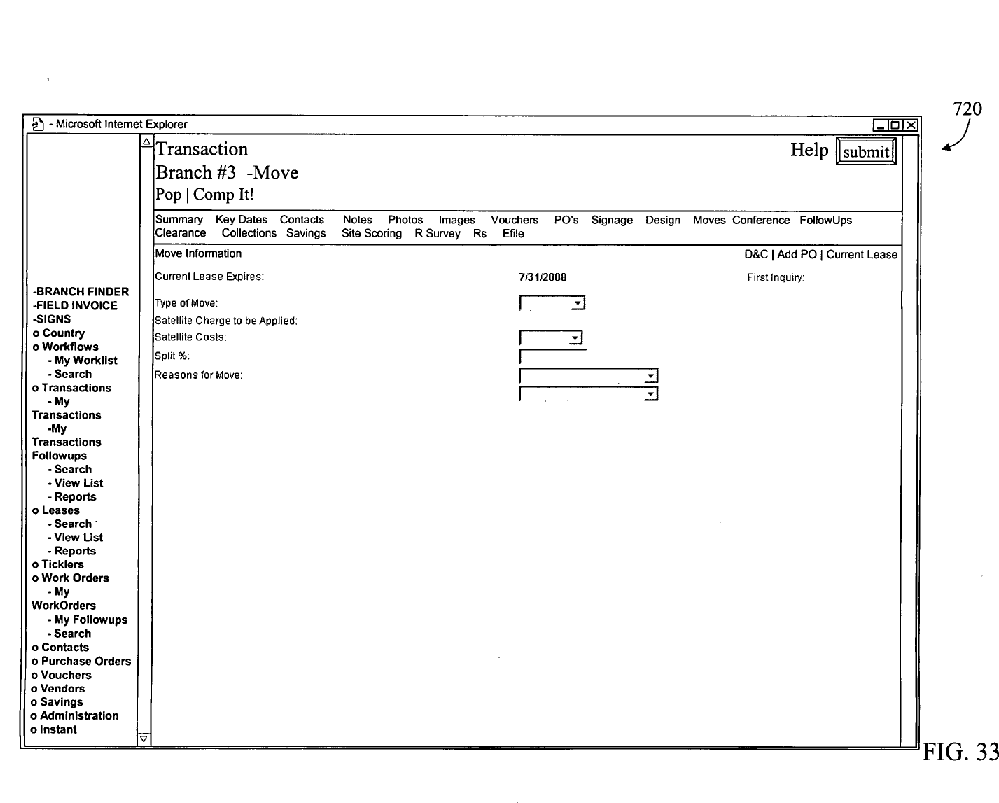

FIG. 33 is an example embodiment of a user interface 720 displaying a transactions move information page included within REWMS 10 (shown in FIG. 1). In the example embodiment, user interface 720 provides an interface allowing a user to view or enter, move information relating to a transaction. Specifically, a date that a current lease expires, type of move data may be entered, satellite cost for the move, a split percentage and reasons for the move maybe entered or viewed by a user.

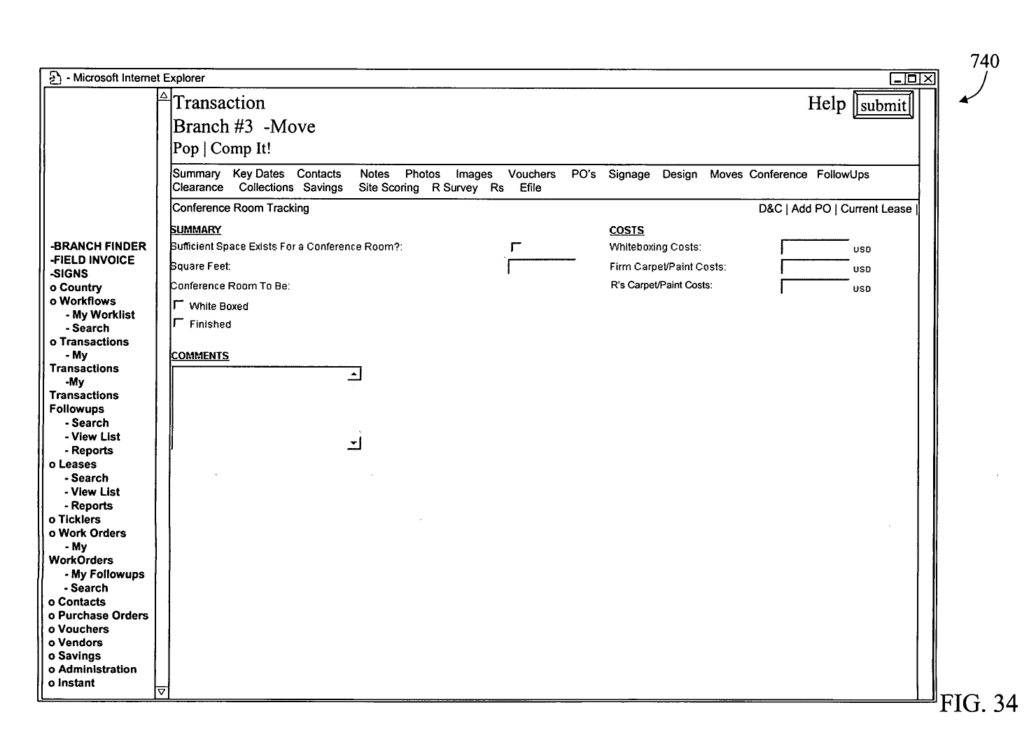

FIG. 34 is an example embodiment of a user interface 740 displaying a transactions conference room tracking page included within REWMS 10 (shown in FIG. 1). In the example embodiment, user interface 740 allows a user to view or enter conference room tracking data associated with a transaction. Summary information includes whether or not sufficient space exists for a conference room and the number of square feet for the conference room, if the conference room is to be white boxed or finished and also a text box is provided where a user can enter comments. Costs associated with preparation of the conference room may also be entered including white boxing costs, firm carpet and paint costs, and lessee representative's carpet and paint costs.

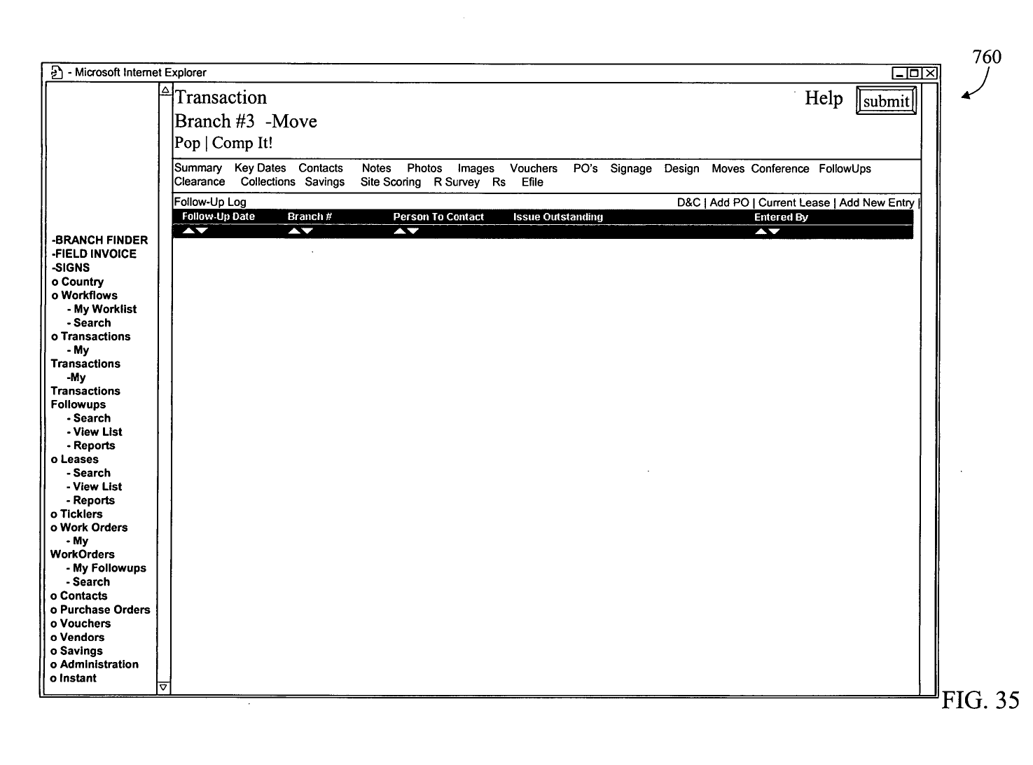

FIG. 35 is an example embodiment of a user interface 760 displaying a transactions follow-up log page included within REWMS 10 (shown in FIG. 1). In the example embodiment, user interface 760 displays a follow-up log associated with a transaction. Information in the follow-up log which is selectable and viewable by a user includes a follow-up date, a branch number, name of a person to contact, any outstanding issues and an entered by field to identify the user who entered the follow-up information.

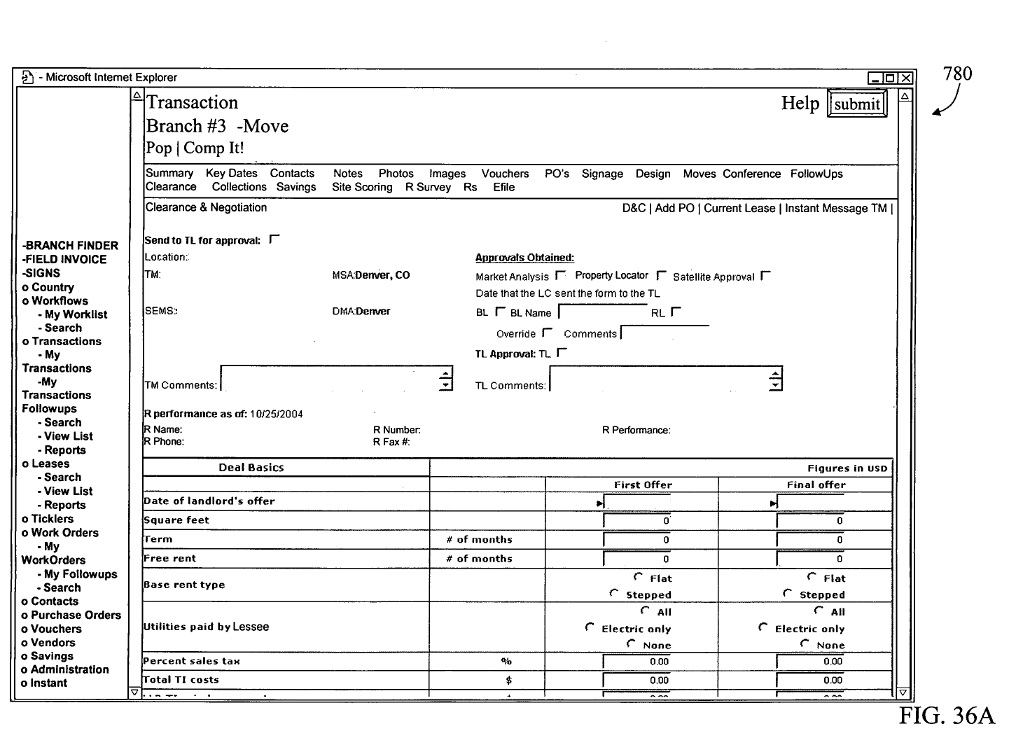

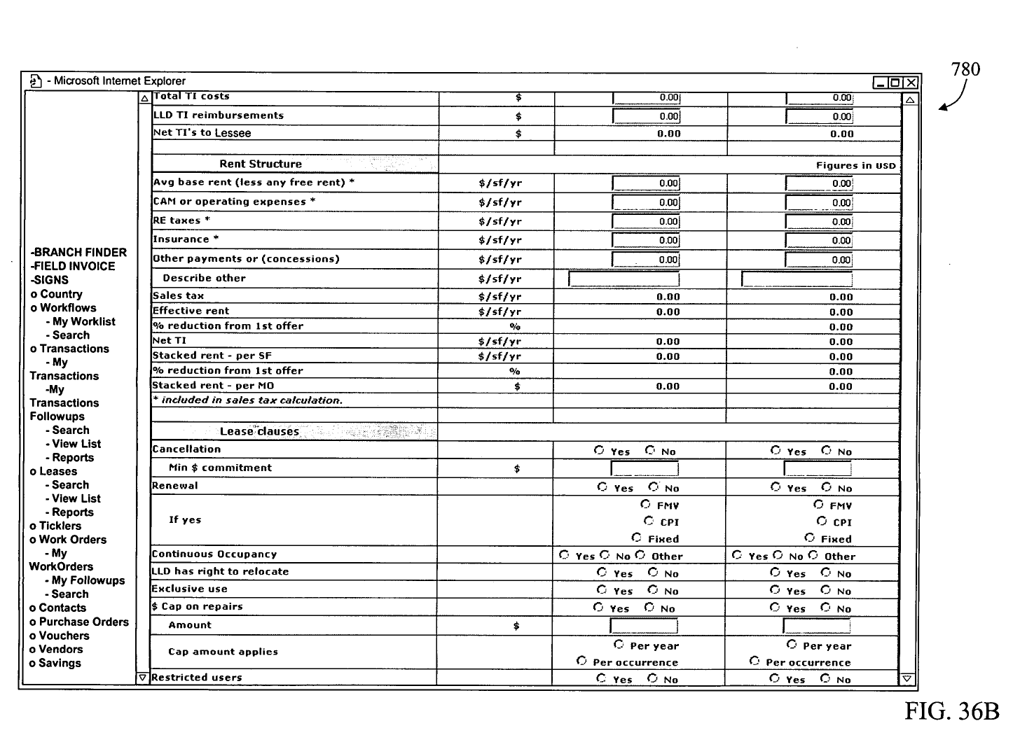

FIGS. 36A and 36B are an example embodiment of a user interface 780 displaying a transactions clearance and negotiation page included within REWMS 10 (shown in FIG. 1). In the example embodiment, user interface 780 allows a user to enter and view clearance and negotiation data associated with a transaction. Data relating to the negotiation of the transaction includes a location of the particular property, a transaction manager for the transaction, metropolitan statistical area (MSA) and a direct marketing area (DMA). In the example embodiment, Denver, Colo. is both the metropolitan statistical area and the direct marketing area. Approvals for the negotiation and lease or purchase of the property in question include approvals by a business leader (BL), field manager or regional leader (RL), and a team leader (TL). Other approvals required include market analysis (MA), property locator (PL) and satellite approval. Basics of the deal or transaction are also entered utilizing user interface 780 including for both a first offer and a final offer, a date of the landlord's offer, square feet of the facility, the term of the lease, if a lease, any free rent period that might be part of the deal, who will pay the utilities, which utilities, for example, will be paid by lessee, a percentage of the sales tax, total cost, landlord reimbursements, a rent structure broken down in dollars per square foot per year, and any lease clauses that may be a part of the terms of a lease.

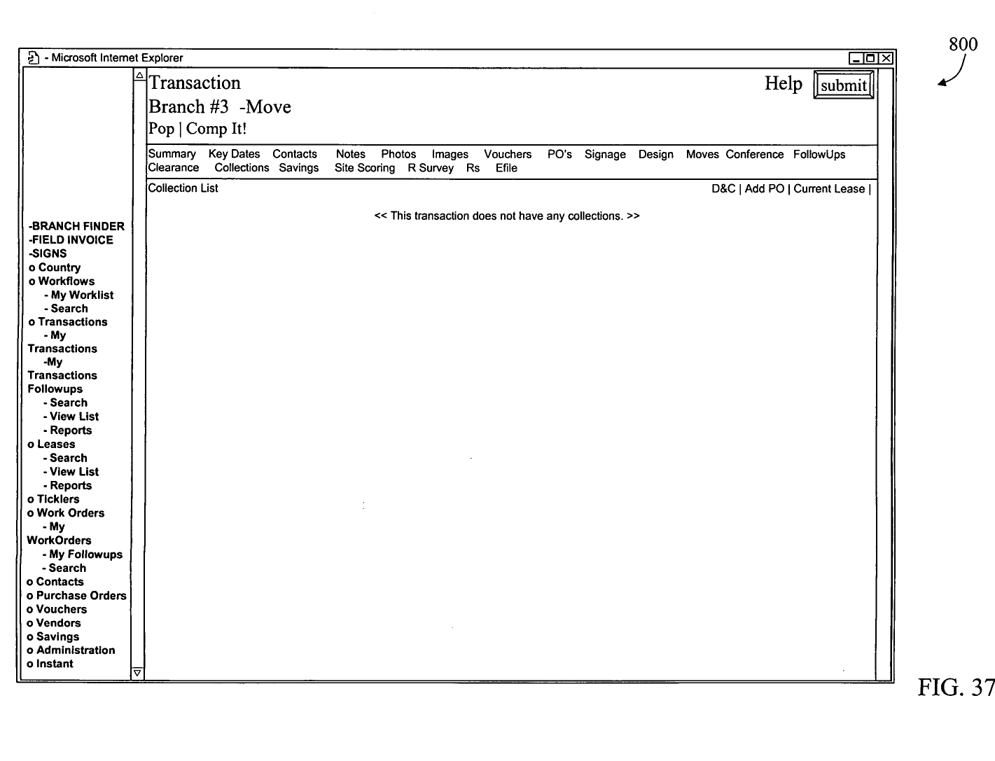

FIG. 37 is an example embodiment of a user interface 800 displaying a transactions collection list page included within REWMS 10 (shown in FIG. 1). In the example embodiment, user interface 800 displays a collection list associated with a particular transaction.

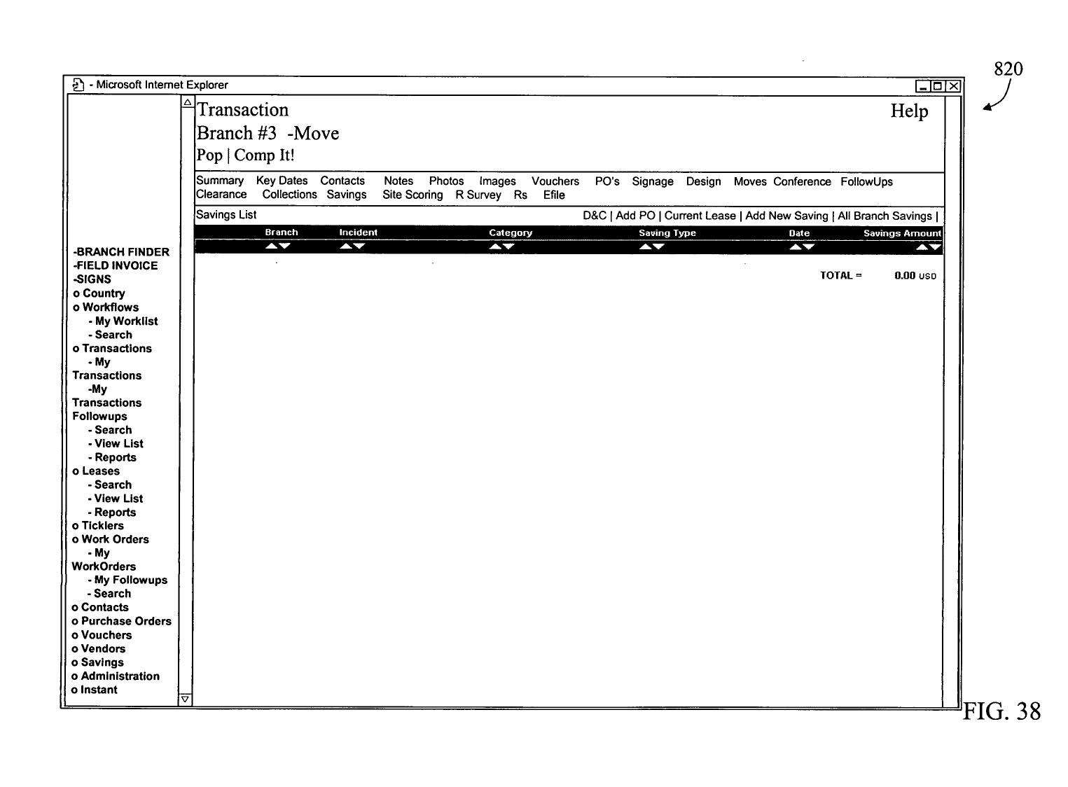

FIG. 38 is an example embodiment of a user interface 820 displaying a transactions savings list page included within REWMS 10 (shown in FIG. 1). In the example embodiment, user interface 820 displays a savings list associated with a transaction including a branch, an incident number, a category number, savings type, a date and a savings amount. A user accessing user interface 820 may sort the savings list by any of these date types.

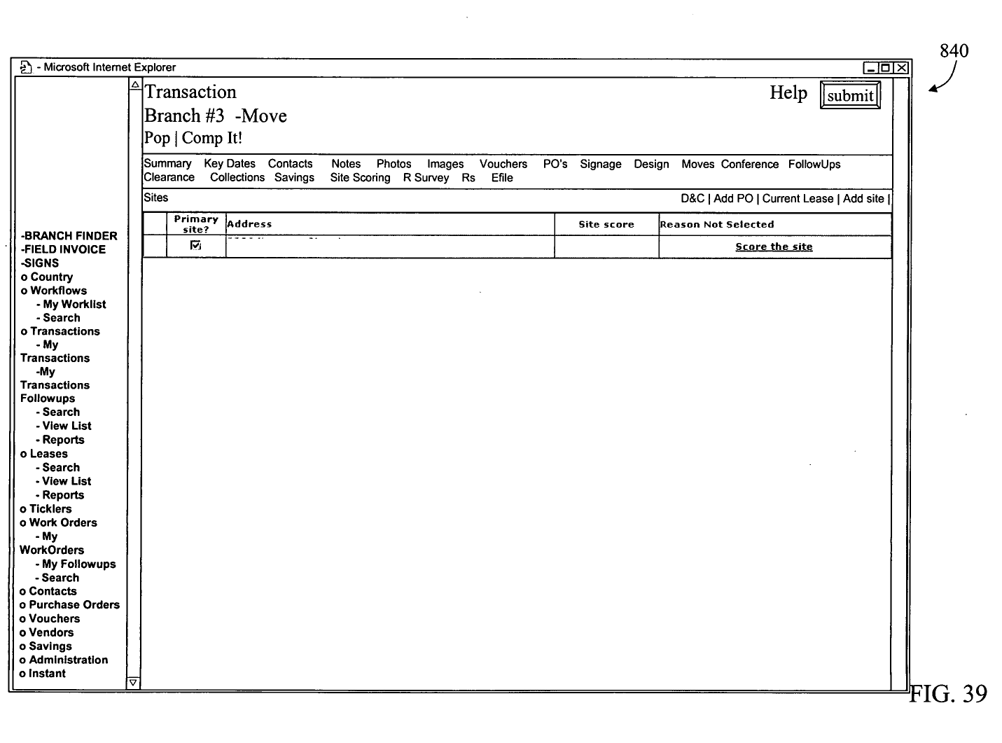

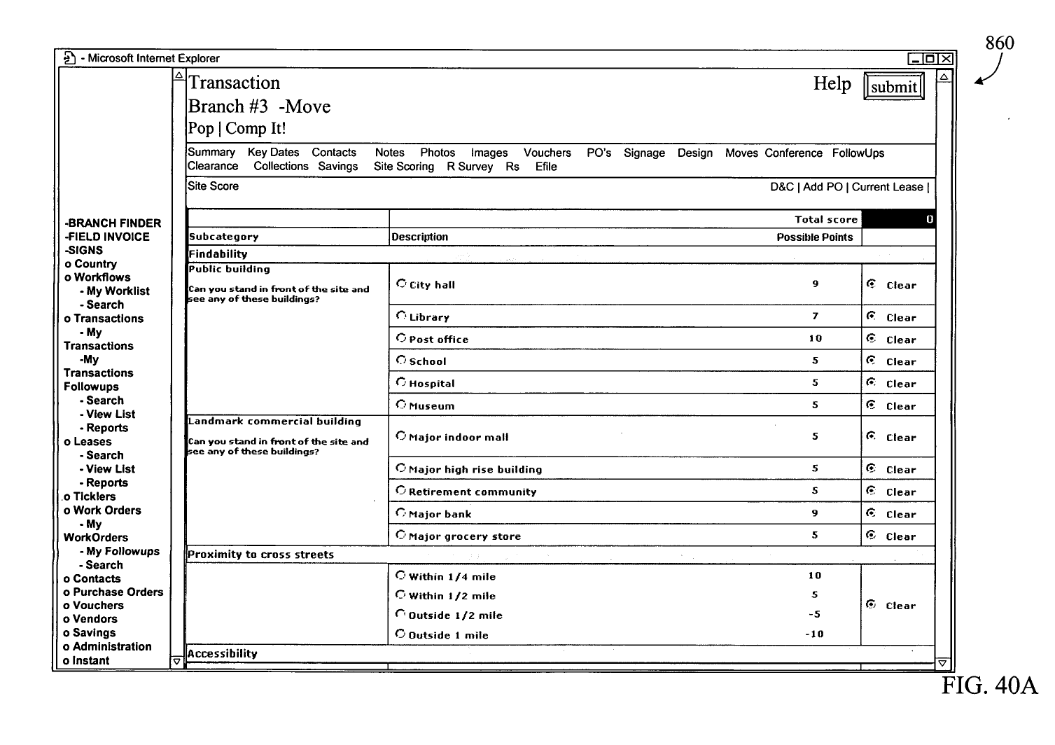

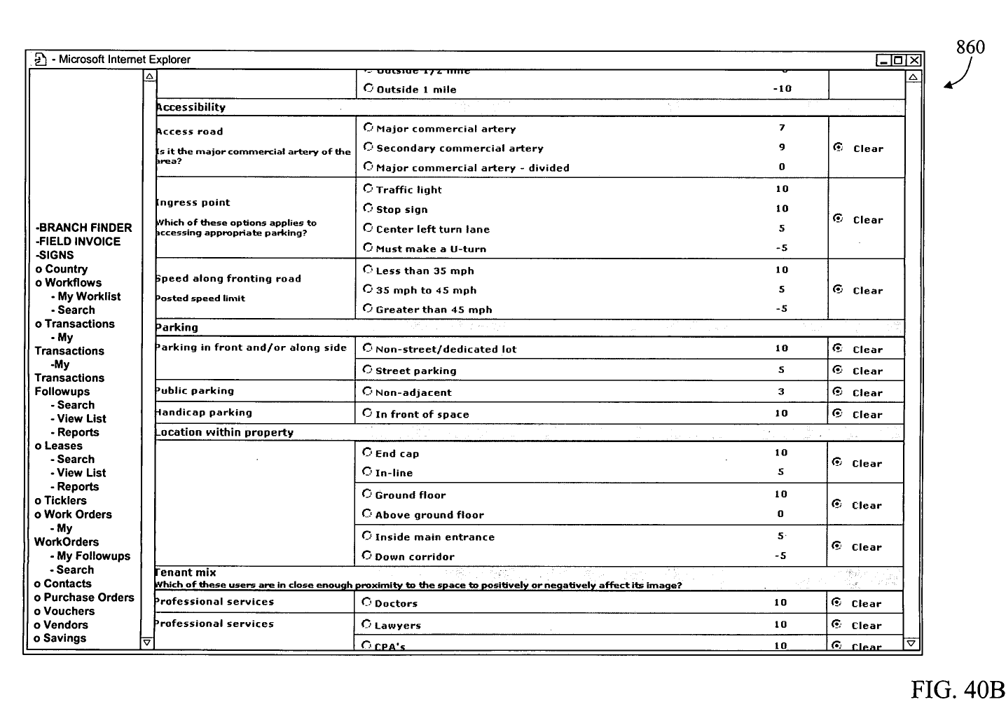

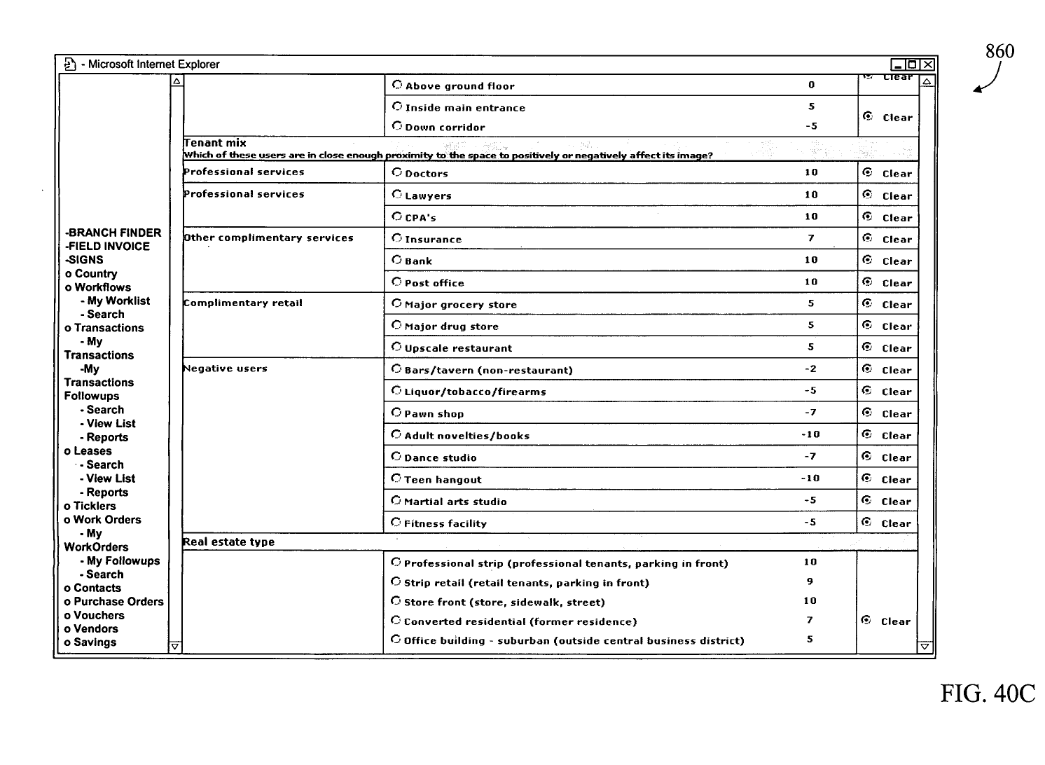

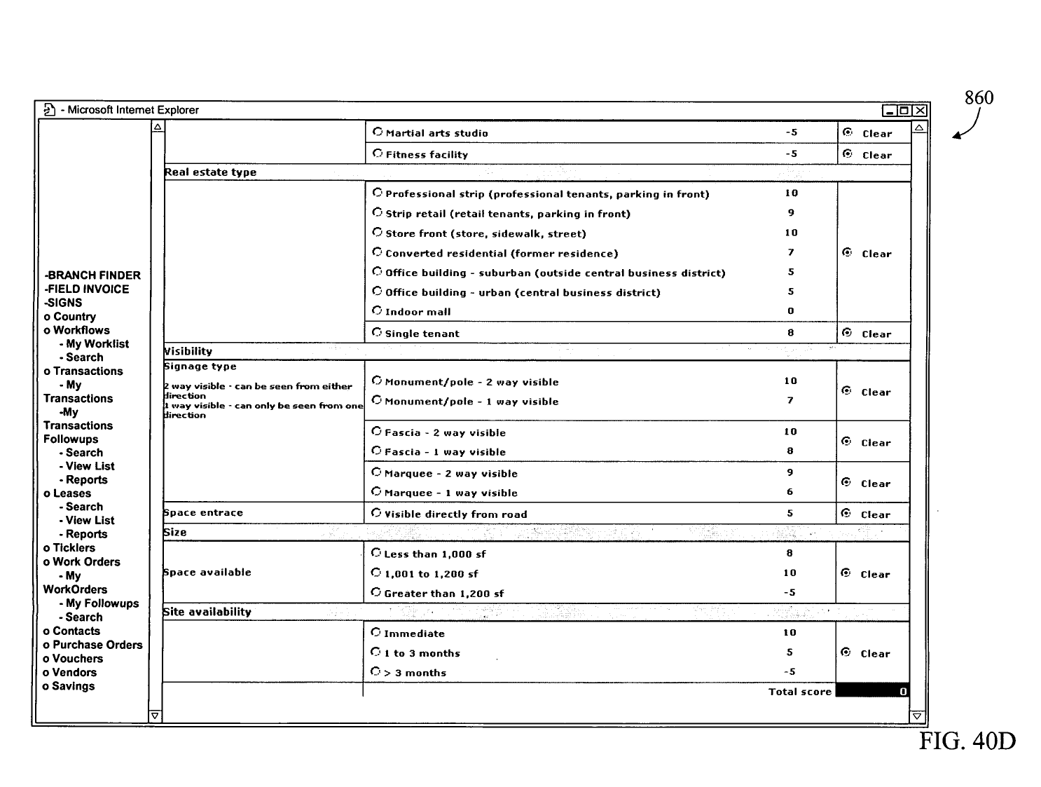

FIG. 39 is an example embodiment of a user interface 840 displaying a transactions site selection page included within REWMS 10 (shown in FIG. 1). In the example embodiment, user interface 840 allows a user to select a site associated with a particular transaction for purposes of scoring the site. A checkbox is provided where the user may indicate if the address is a primary site. The user may also select to score a particular site using a link embedded within user interface 840. Selection of such a link in user interface 840 causes REWMS system 10 (shown in FIG. 1) to display user interface 860 (shown in FIGS. 40A-40D).

FIGS. 40A-40D are an example embodiment of a user interface 860 displaying a transactions site scoring page included within REWMS 10 (shown in FIG. 1). In the example embodiment, user interface 860 displays scoring information for a site associated with a transaction. Variables utilized in scoring a site include a fundability. For example, is it near public buildings or landmark commercial buildings, proximity to cross streets, accessibility, is there an access road, a description of the ingress point, speed along the fronting road, parking, whether or not there is in front or alongside parking, public parking or handicap parking. Portions of the site scores are also influenced by the location of the site within a property. For example, is it the end of the property, on the ground floor, above ground floor.

Also, a tenant mix is utilized in assigning a score to a site. For example, whether professional services are provided within the site are considered. Examples include doctors, lawyers, CPAs and other complimentary services including insurance, bank and post office. Complimentary retail sites include grocery stores, drug stores, upscale restaurants. Negative tenant mix parameters would include bars, firearms, liquor, tobacco, pawn shops, adult stores, dance studios, teenager hangouts, martial arts studios and fitness facilities. The type of real estate for a site is also important in assigning a score. Choices include professional strip, strip retails, storefront, converted residential, office buildings, suburban or urban, indoor mall, or if the site is a single tenant site. Visibility is also important to assigning a score to a site. If there are monuments or poles that are visible, fascia that is visible, one-way or two-way marquees and if the entrance to the site is visible from the road. Also, size is important, square footage, to assigning a score to a site and availability of the site, for example, immediately, one to three months, or greater than three months is also important in assigning a score to a possible site.

In the example embodiment, at least the variables listed above are considered when site scoring a transaction. In another embodiment, other variables may be considered or may be weighted differently depending upon the type of business using the system. The variables listed herein are for exemplary purposes and are in no way intended to be limiting.

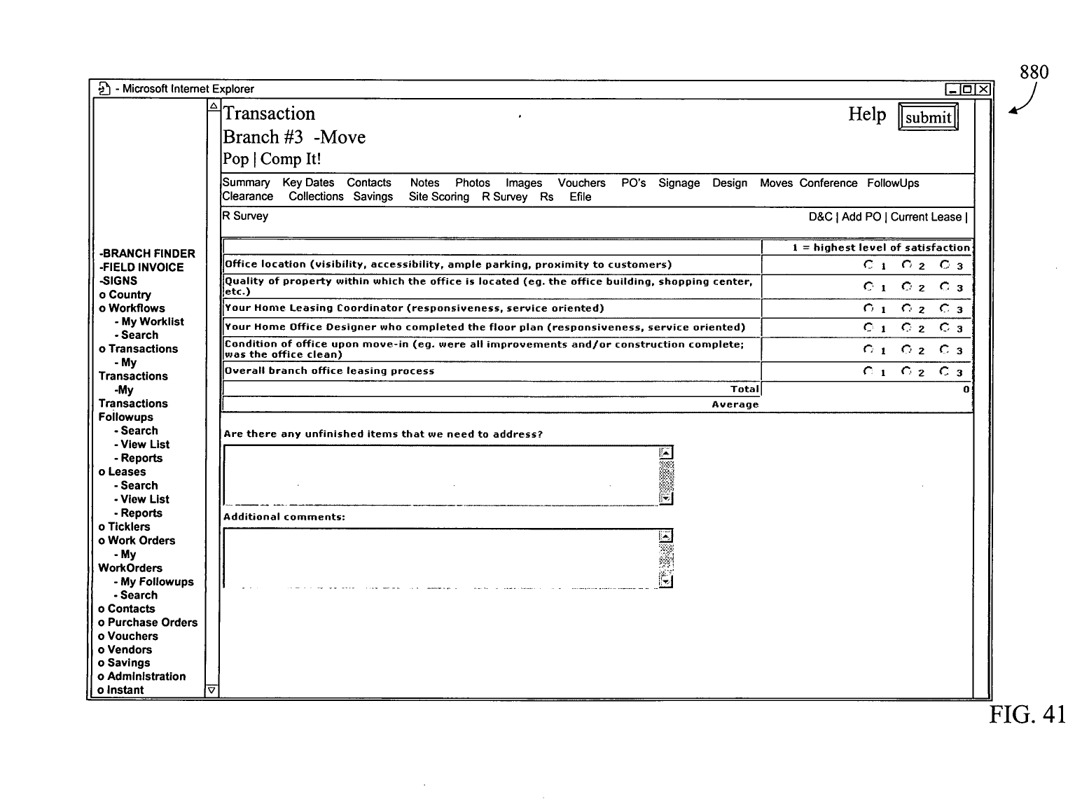

FIG. 41 is an example embodiment of a user interface 880 displaying a transactions survey page included within REWMS 10 (shown in FIG. 1). In the example embodiment, user interface 880 provides a lessee representative an interface to enter the survey information relating to the site of a transaction. The lessee representative user can enter levels of satisfaction with, for example, office location, quality of property, a home leasing coordinator, a home office designer, condition of office upon moving, and the overall branch office leasing process. Also, the lessee representative user may enter notes relating to any unfinished items in the rented or purchased space that need to be addressed and any additional comments that the lessee representative may have.

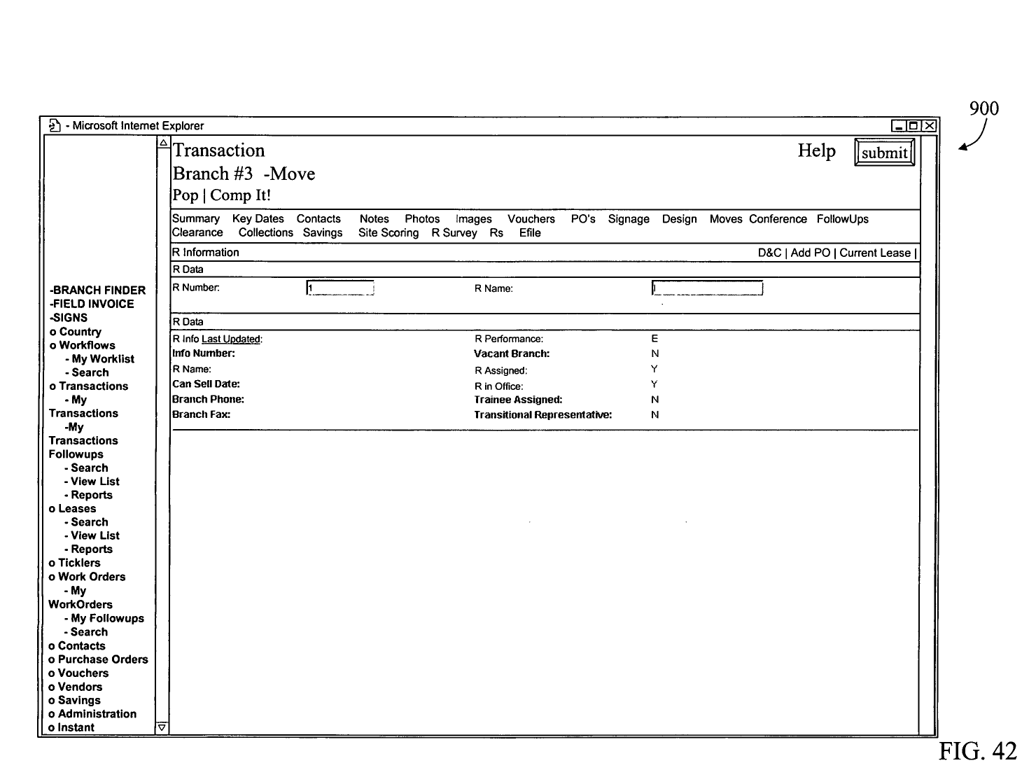

FIG. 42 is an example embodiment of a user interface 900 displaying a transactions information page included within REWMS 10 (shown in FIG. 1). In the example embodiment, user interface 900 allows a user to enter information regarding the lessee representatives. For example, if the lessee representative is a representative of a large corporation or other company, a number and a name for the lessee representative may be entered. Also, data for such a lessee representative may be viewed including a last update date of the lessee representative information, also the lessee representative number, name, a selling date, a phone number, performance of the lessee representative, whether or not their branch is vacant. If a new lessee representative has been assigned or is in the office and if the lessee representative has a trainee or transitional representative in the office.

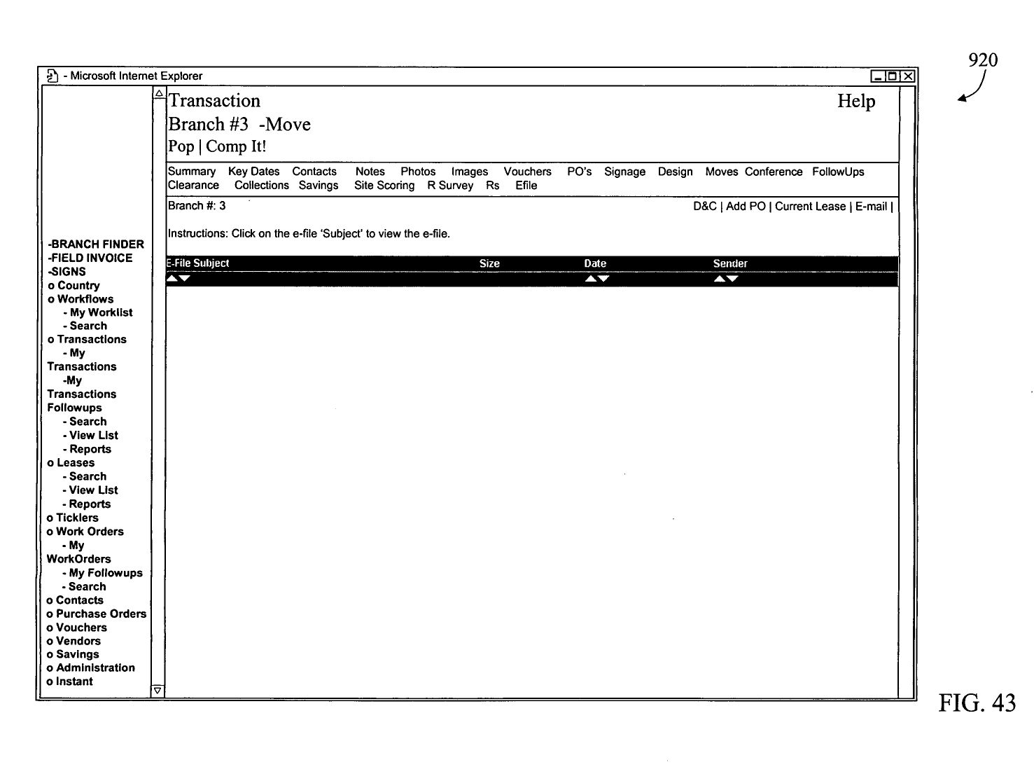

FIG. 43 is an example embodiment of a user interface 920 displaying a transactions E-file page included within REWMS 10 (shown in FIG. 1). In the example embodiment, user interface 920 displays and allows the user to select E-file subjects associated with the transaction. Those are selectable by the subject matter, by date or by sender.

Options Wizard

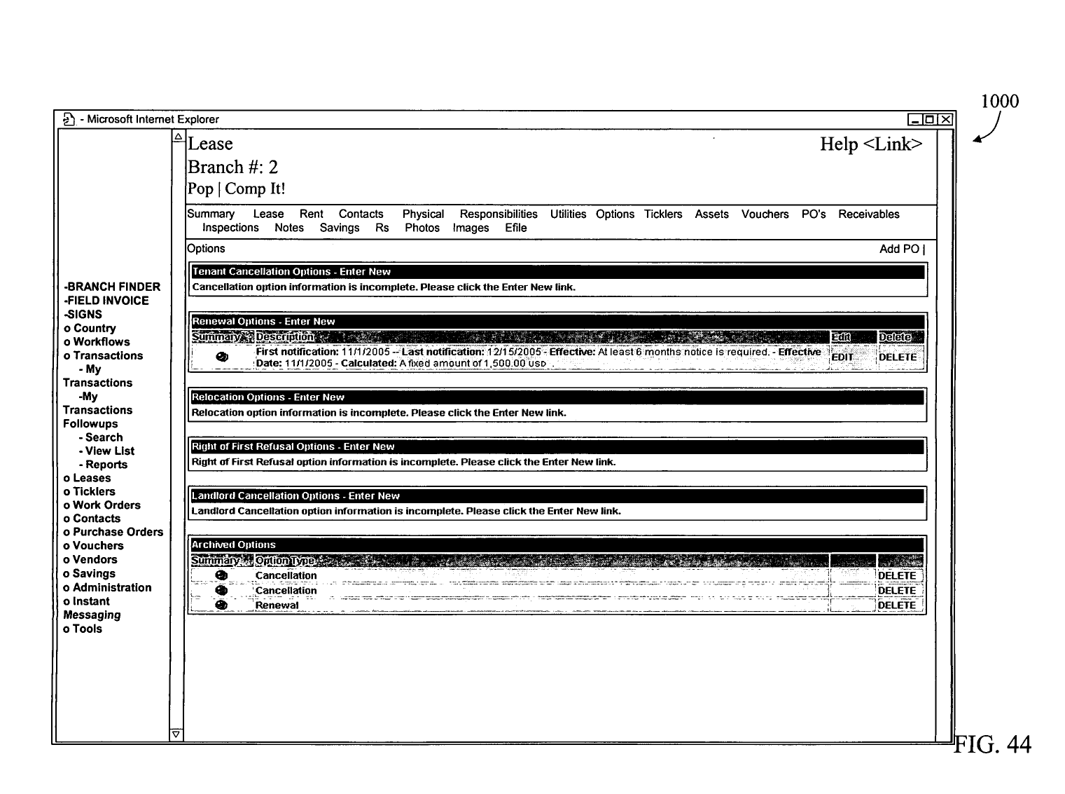

FIG. 44 through FIG. 52 are example embodiments of user interfaces relating to an options wizard included within REWMS 10 (shown in FIG. 1) which is utilized in entering and accessing transaction data. These user interfaces are displayed when the transactions tool option (transactions link 314 shown in FIG. 5) is selected by a user.

More specifically, FIG. 44 is an example embodiment of a user interface 1000 displaying an options summary page relating to a transaction that is accessible by a user utilizing REWMS 10 (shown in FIG. 1). The summarized options include, but are not limited to, a tenant cancellation option, renewal options, relocation options, right of first refusal options, landlord cancellation options and archived options.

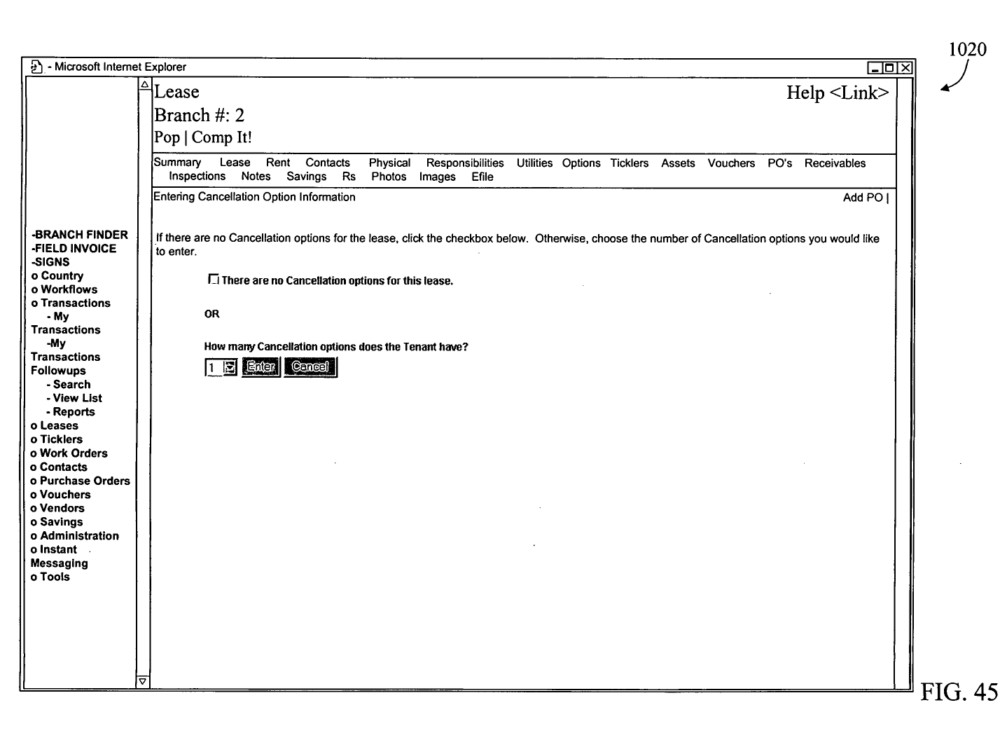

FIG. 45 is an example embodiment of a user interface 1020 displaying an entering cancellation option information page included within REWMS 10 (shown in FIG. 1). In the example embodiment, user interface 1020 provides an interface allowing a user to enter cancellation or option information, specifically whether or not there are cancellation options for a lease or how many cancellation options does the tenant have from one to whatever number is programmed into REWMS 10 (as shown by the pull down box).

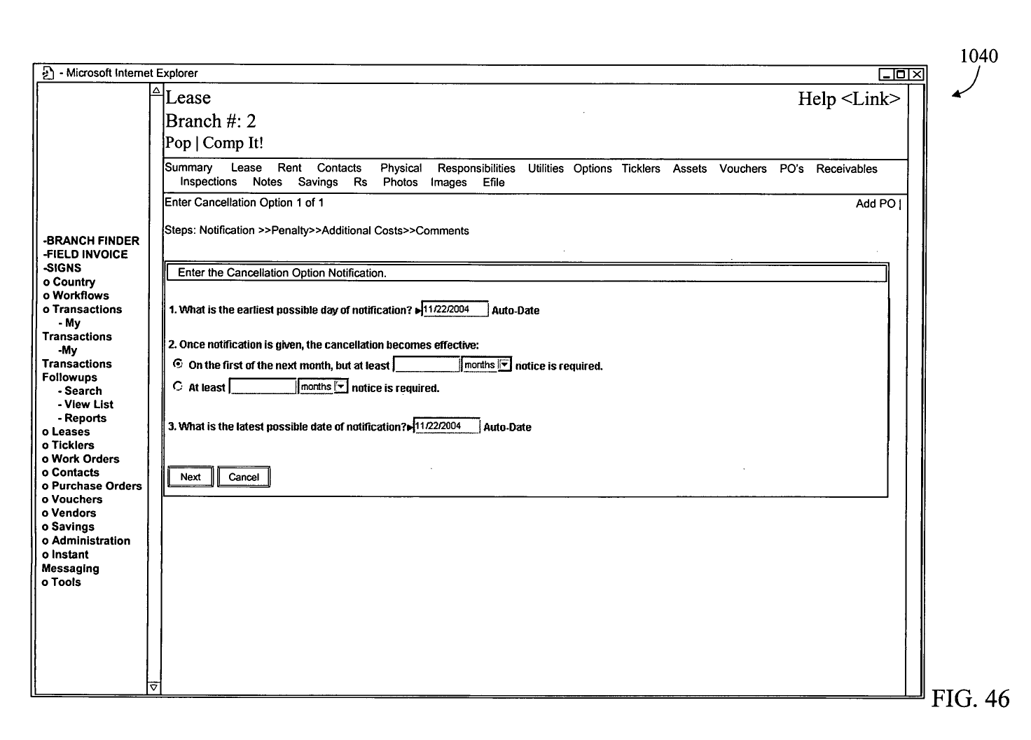

FIG. 46 is an example embodiment of a user interface 1040 displaying a cancellation option notification page included within REWMS 10 (shown in FIG. 1). In the example embodiment, user interface 1040 provides an interface allowing a user to enter cancellation option notification information. For example, what is the earliest possible date of notification. Once notification is given, the cancellation becomes effective on either the first of the next month or at least some number of months enterable by the user. Also, what is the latest possible date of notification regarding the cancellation.

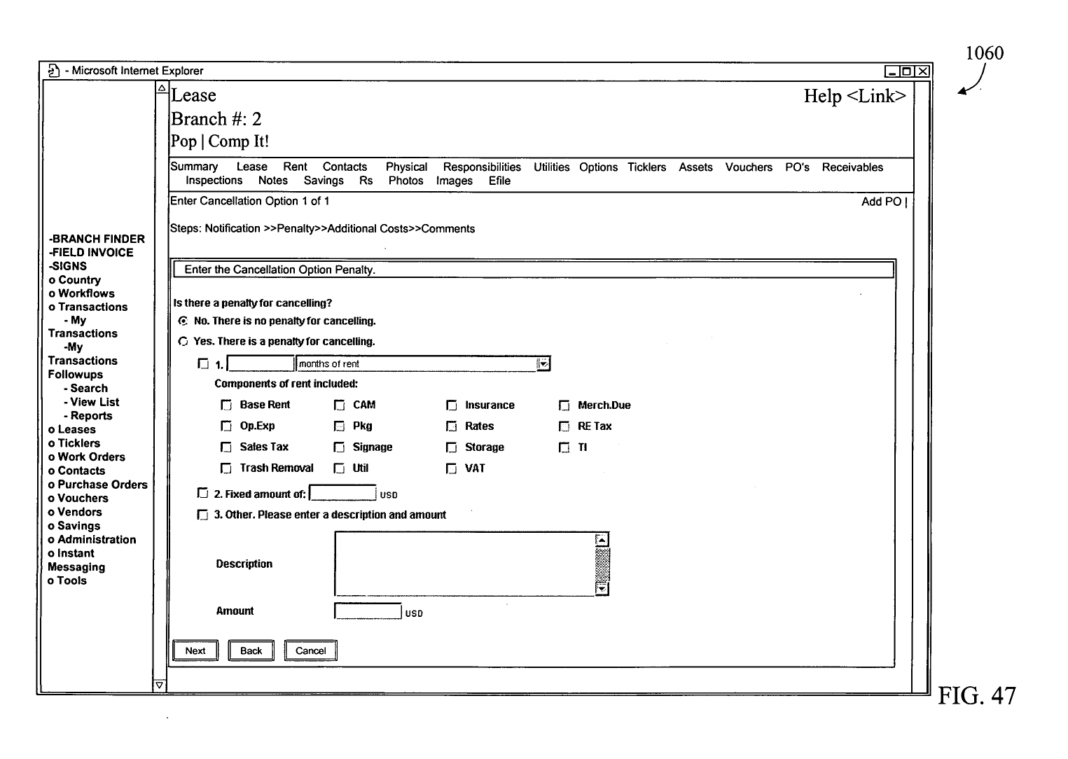

FIG. 47 is an example embodiment of a user interface 1060 displaying an entering cancellation option penalty page included within REWMS 10 (shown in FIG. 1). In the example embodiment, user interface 1060 provides an interface allowing a user to enter cancellation option penalties. First of all, whether or not there is or is not a penalty for canceling and what is the penalty? For example, some number of months of rent and components of rent include base rent, operating expenses, sales tax, trash removal, packaging, signage, utilities, insurance, storage, merchandise due, real estate tax. Or if there is a penalty for canceling, it could be a fixed amount in dollars or it may be another amount and a text entry box is used to describe the cancellation penalty in an associated amount.

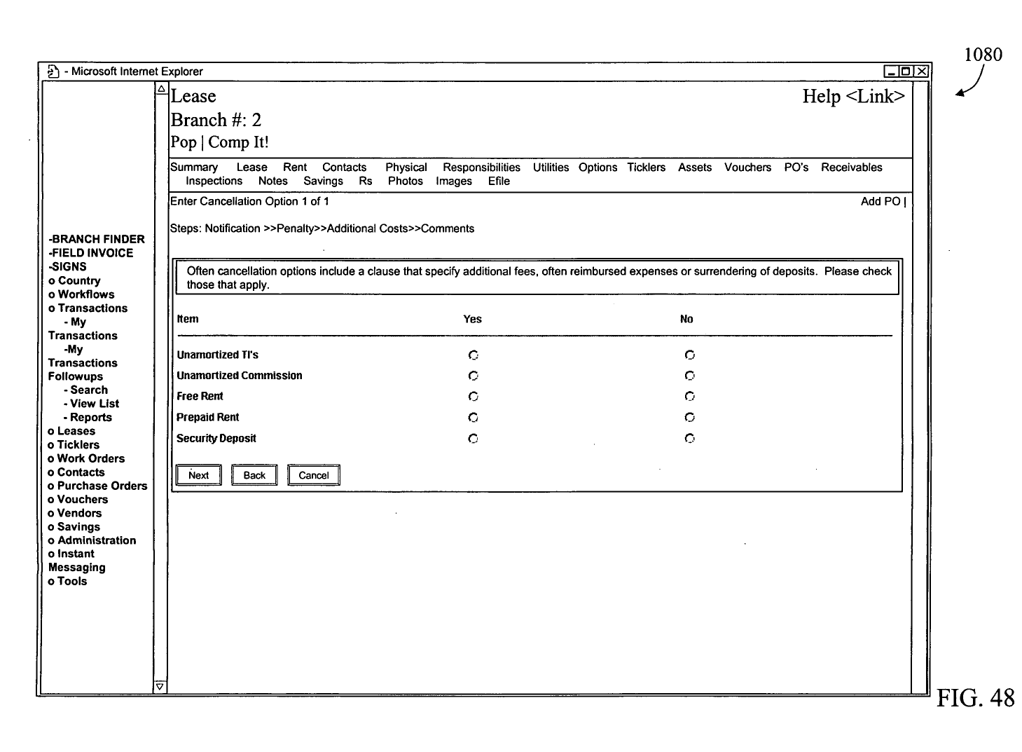

FIG. 48 is an example embodiment of a user interface 1080 displaying a cancellation option page included within REWMS 10 (shown in FIG. 1). In the example embodiment, user interface 1080 provides an interface allowing a user to enter cancellation options whether or not there are unamortized TIs (tenant improvements) on amortized commissions, free rent, prepaid rent or a security deposit.

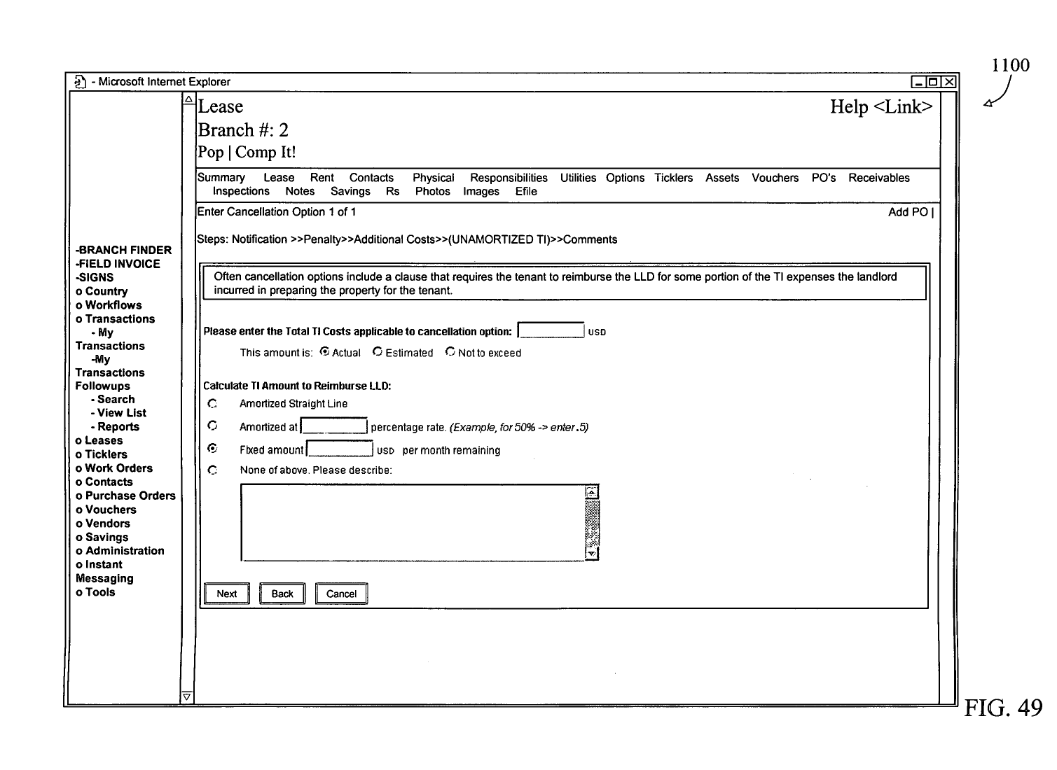

FIG. 49 is an example embodiment of a user interface 1100 displaying another cancellation option page included within REWMS 10 (shown in FIG. 1). In the example embodiment, user interface 1100 provides an interface allowing a user to enter cancellation options including the total TI cost applicable to a cancellation option and whether this amount is actual estimated or a not to exceed. User interface 1100 also displays calculated TI amount to reimburse the landlord including whether it's amortized straight line, amortized at a percentage rate, a fixed amount per month, or none of the above with a text entry option explaining the calculated amount reimbursable to the landlord.

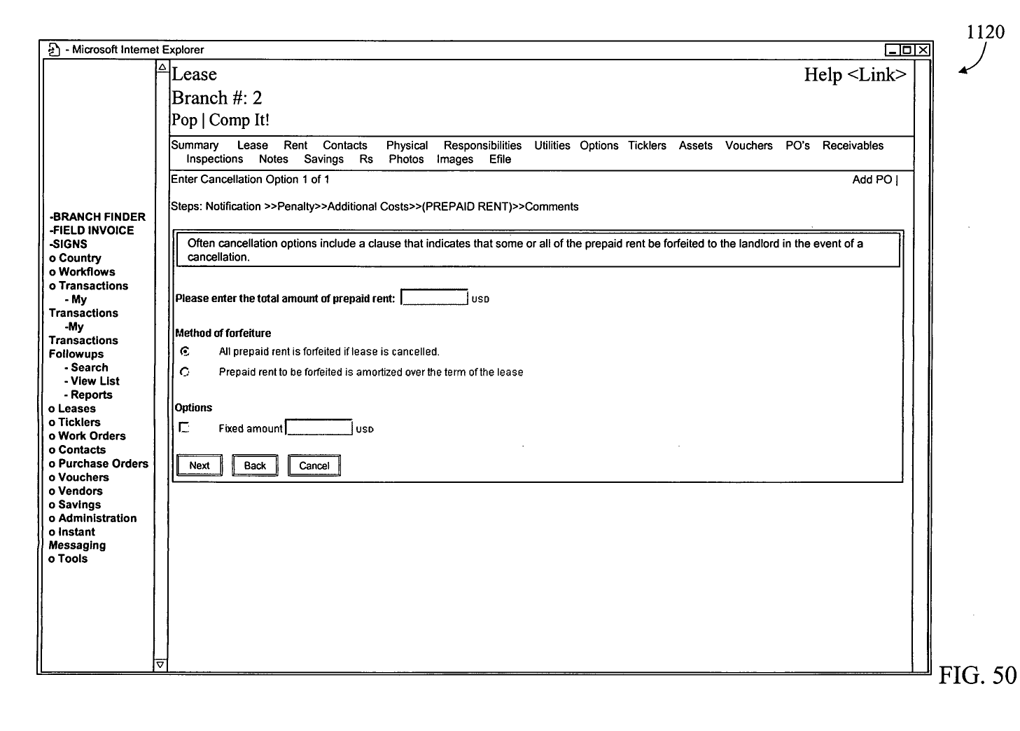

FIG. 50 is an example embodiment of a user interface 1120 displaying a third cancellation option page included within REWMS 10 (shown in FIG. 1). In the example embodiment, user interface 1120 provides an interface allowing a user to enter the total amount of prepaid rent, and a method of forfeiture. More specifically, the data entered includes whether or not all prepaid rent is forfeited if the lease is cancelled, or if prepaid rent to be forfeited is amortized over the term of the lease. Another option is a fixed amount.

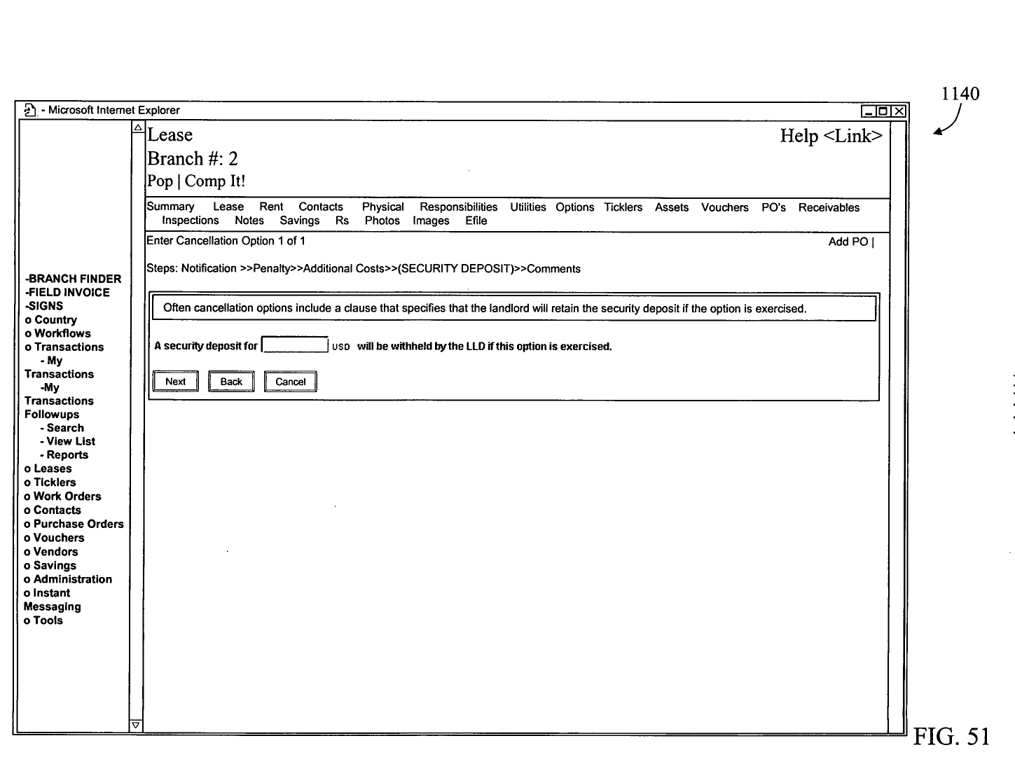

FIG. 51 is an example embodiment of a user interface 1140 displaying a security deposit information page included within REWMS 10 (shown in FIG. 1). In the example embodiment, user interface 1140 provides an interface allowing a user to enter the amount of the security deposit that will be withheld by the landlord if the cancellation option is exercised.

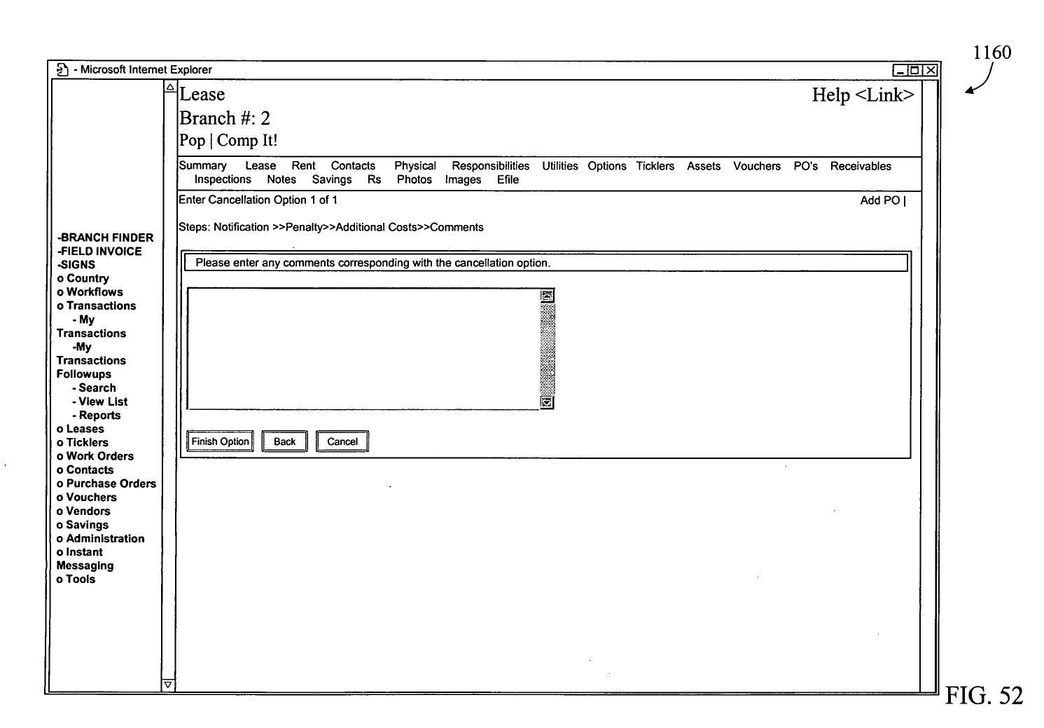

FIG. 52 is an example embodiment of a user interface 1160 displaying a notes relating to cancellation options page included within REWMS 10 (shown in FIG. 1). In the example embodiment, user interface 1160 provides an interface allowing a user to enter any comments corresponding with the cancellation option. A text box is provided for the user to enter such comments.

Work Orders

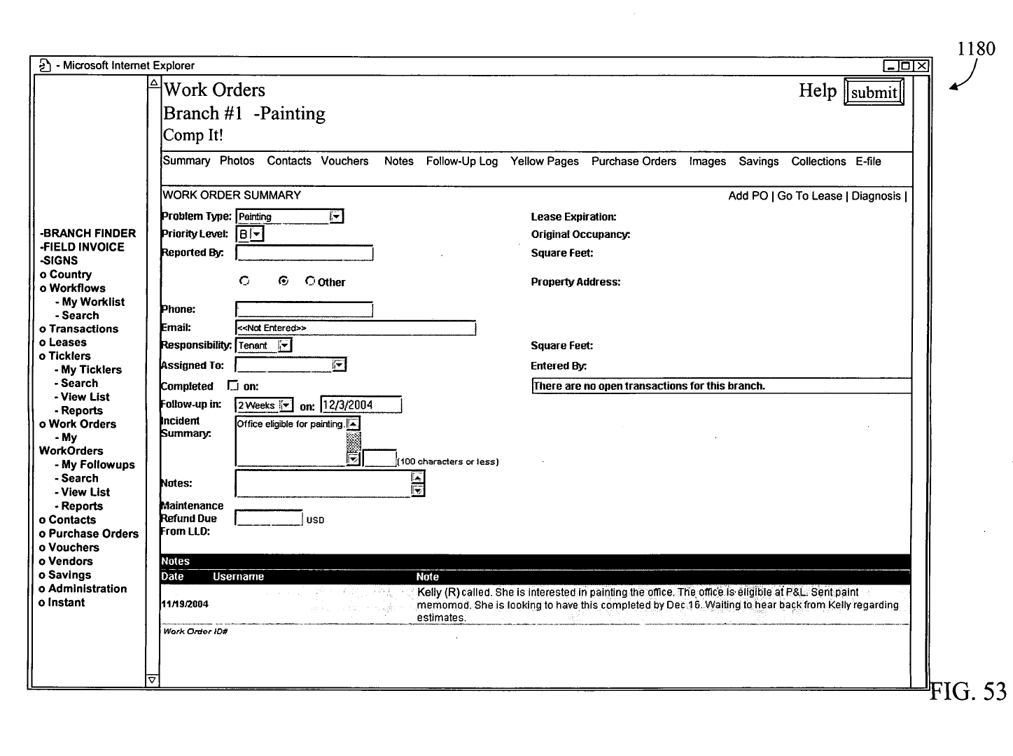

FIG. 53 through FIG. 65 are example embodiments of user interfaces displaying work order pages included within REWMS 10 (shown in FIG. 1). These user interfaces are displayed when the work orders tool option (work orders link 320 shown in FIG. 5) is selected by a user.

FIG. 53 is an example embodiment of a user interface 1180 displaying a work order summary page included within REWMS 10 (shown in FIG. 1). In the example embodiment, user interface 1180 provides an interface allowing a user to enter summary information regarding work orders. More specifically, user interface 1180 allows a user to enter a problem type (e.g., painting), a priority level, who the problem is being reported by, contact information, responsibility (i.e., tenant or landlord), who the problem has been assigned to, a follow up period and date, a summary of the problem, notes, and any maintenance refund due for the landlord. Also included is data describing the property, for example, an address, size, and lease data for the property. A notes section allows a user to access additional work order summaries.

In the example embodiment, REWMS 10 processes work orders submitted on behalf of a facility to the business for work that needs to be done at the facility. In one embodiment, the work order is submitted through REWMS 10. In another embodiment, the work order is submitted not using REWMS 10, but the information included in the work order is entered into REWMS 10 for processing. The work order is processed using REWMS 10.

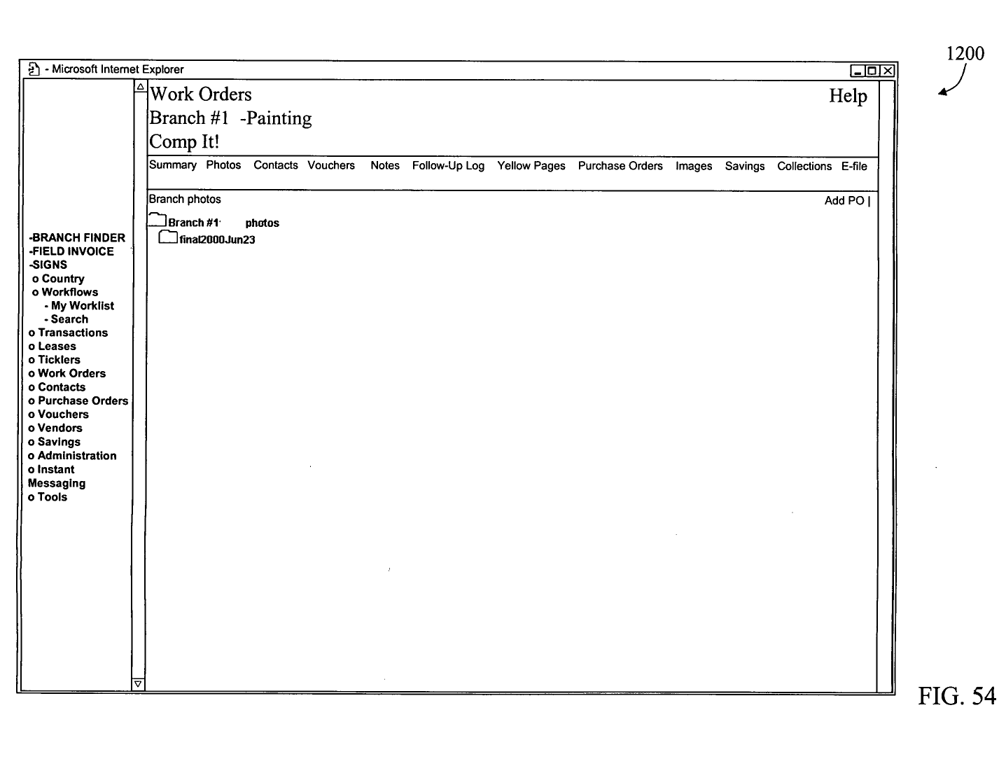

FIG. 54 is an example embodiment of a user interface 1200 displaying a work order photographs page included within REWMS 10 (shown in FIG. 1). In the example embodiment, user interface 1200 is configured to display photographs of the property associated with the work order. In one embodiment, by selecting one of the photographs of the transaction, the user may view or add the notes associated with a particular photograph.

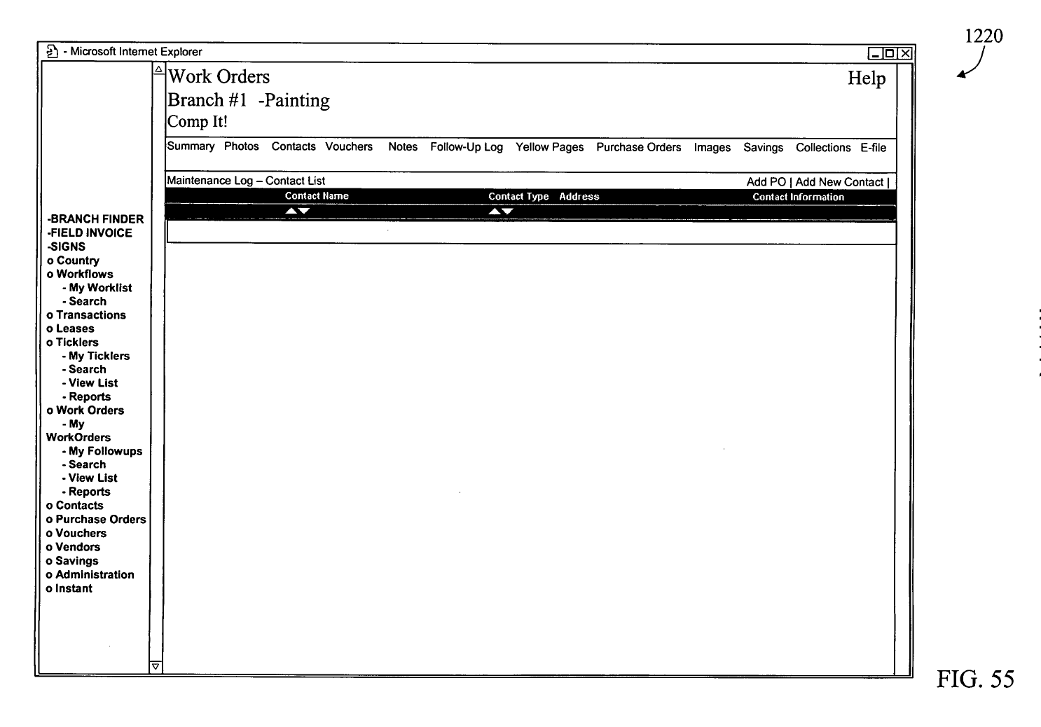

FIG. 55 is an example embodiment of a user interface 1220 displaying a work order contacts page included within REWMS 10 (shown in FIG. 1). In the example embodiment, user interface 1220 allows the user to access or enter contacts in a contact list including a contact name, a contact type, an address for the contact and information, for example, phone and fax numbers for a contact. In order to add a new contact, there is a link entitled, Add New Contact, which may be selected by a user.

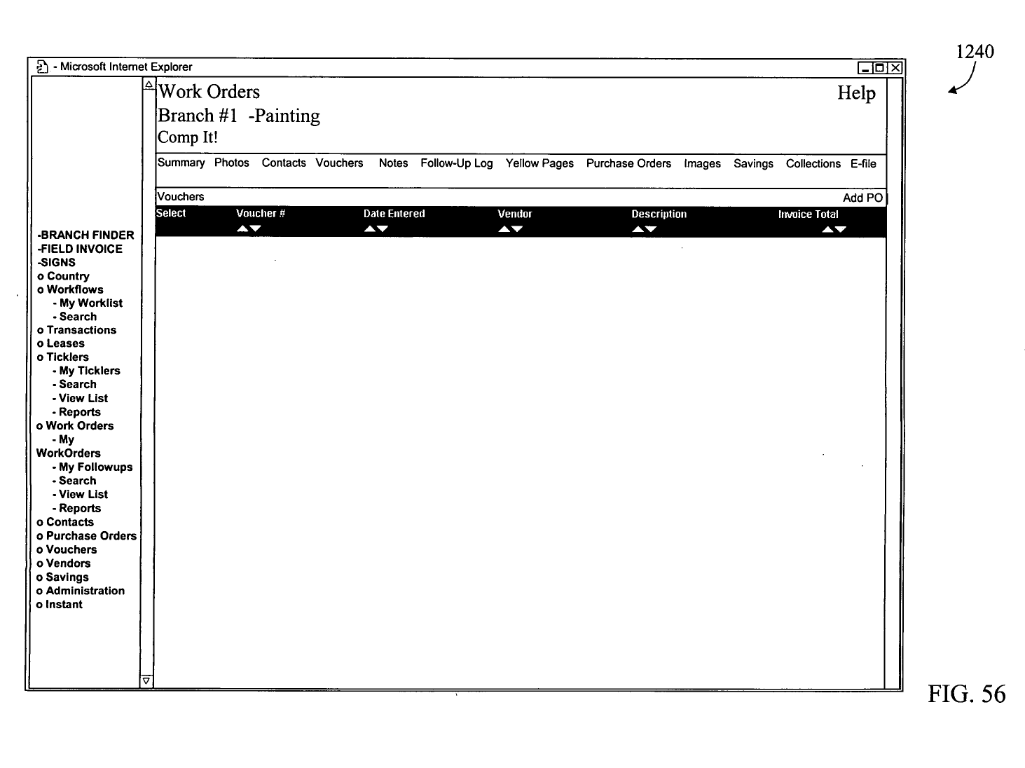

FIG. 56 is an example embodiment of a user interface 1240 displaying a work order vouchers page included within REWMS 10 (shown in FIG. 1). In the example embodiment, user interface 1240 allows the user to select and display vouchers associated with a work order. As illustrated in user interface 1240, a user may sort vouchers by a voucher number, a date entry, a vendor, a description, and an invoice total.

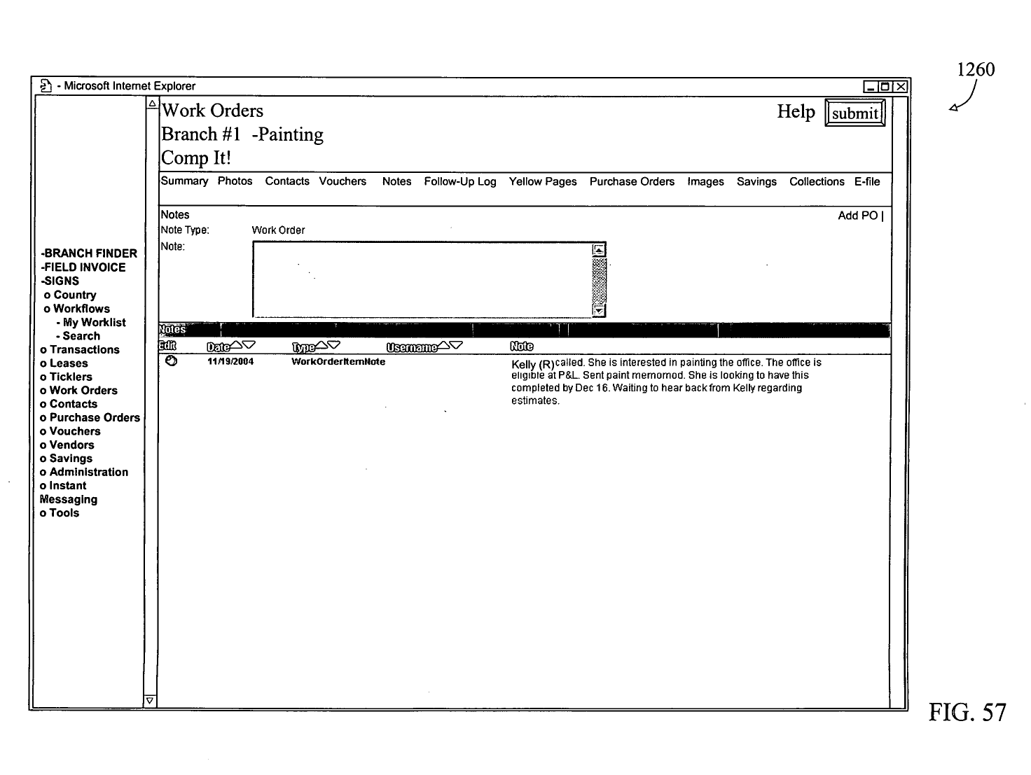

FIG. 57 is an example embodiment of a user interface 1260 displaying a work order notes page included within REWMS 10 (shown in FIG. 1). In the example embodiment, user interface 1260 allows the user to access and enter notes relating to a work order. As illustrated in user interface 1260, a user may select a note type and enter a text field for the particular note. A user may also select and edit previously entered notes by selecting particular notes, or selecting by scrolling through dates, types or by user names as shown in user interface 1260.

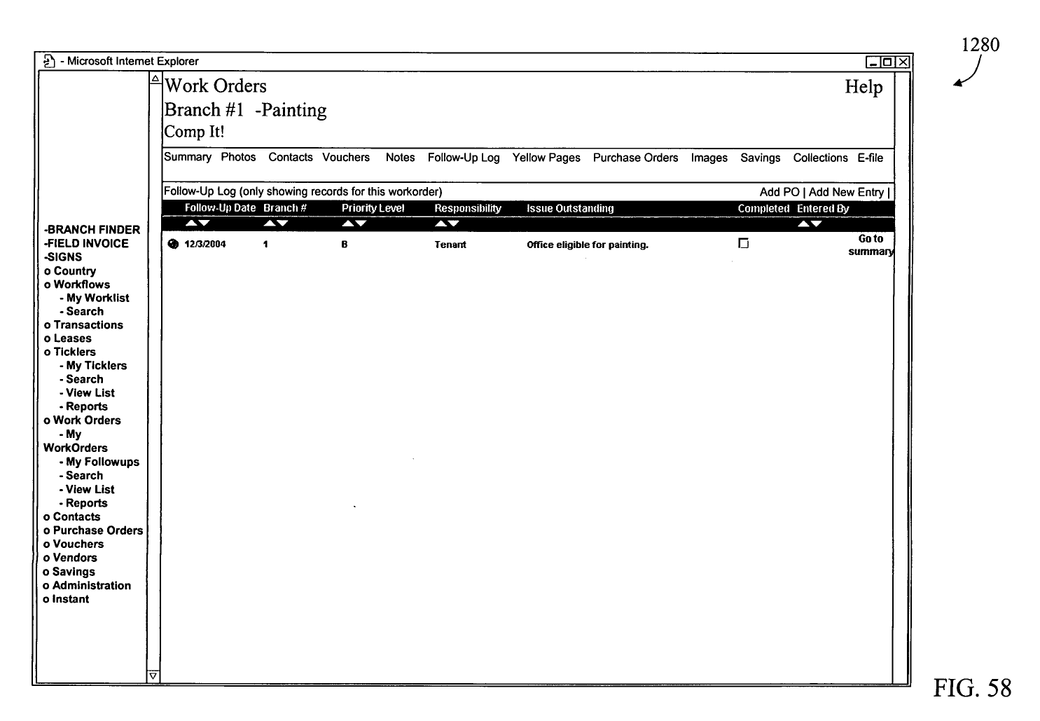

FIG. 58 is an example embodiment of a user interface 1280 displaying a work order follow-up log page included within REWMS 10 (shown in FIG. 1). In the example embodiment, user interface 1280 displays a follow-up log associated with a work order. Information in the follow-up log which is selectable and viewable by a user includes a follow-up date, a branch number, a priority level, a responsible person, any outstanding issues, a check box indicating if the follow-up was completed, and an entered by field to identify the user who entered the follow-up information.

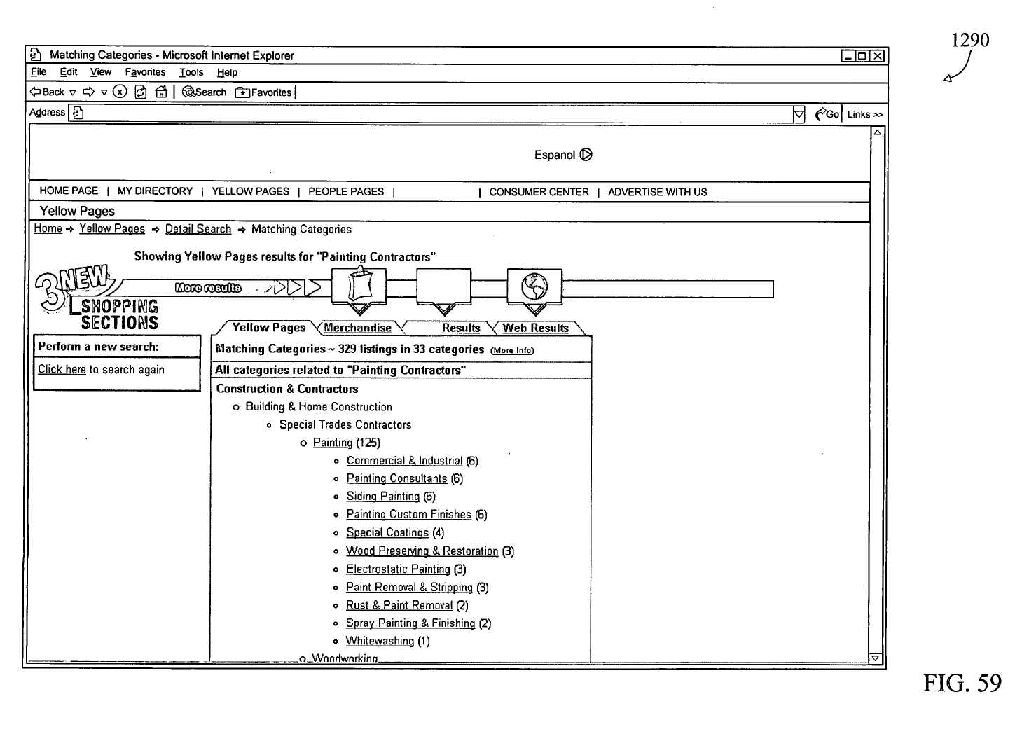

FIG. 59 is an example embodiment of a user interface 1290 displaying a work order telephone listing page included within REWMS 10 (shown in FIG. 1). In the example embodiment, user interface 1290 displays telephone listings that may associated with a work order. In the illustrated embodiment, for example, links to telephone listings for painting contractors are included.

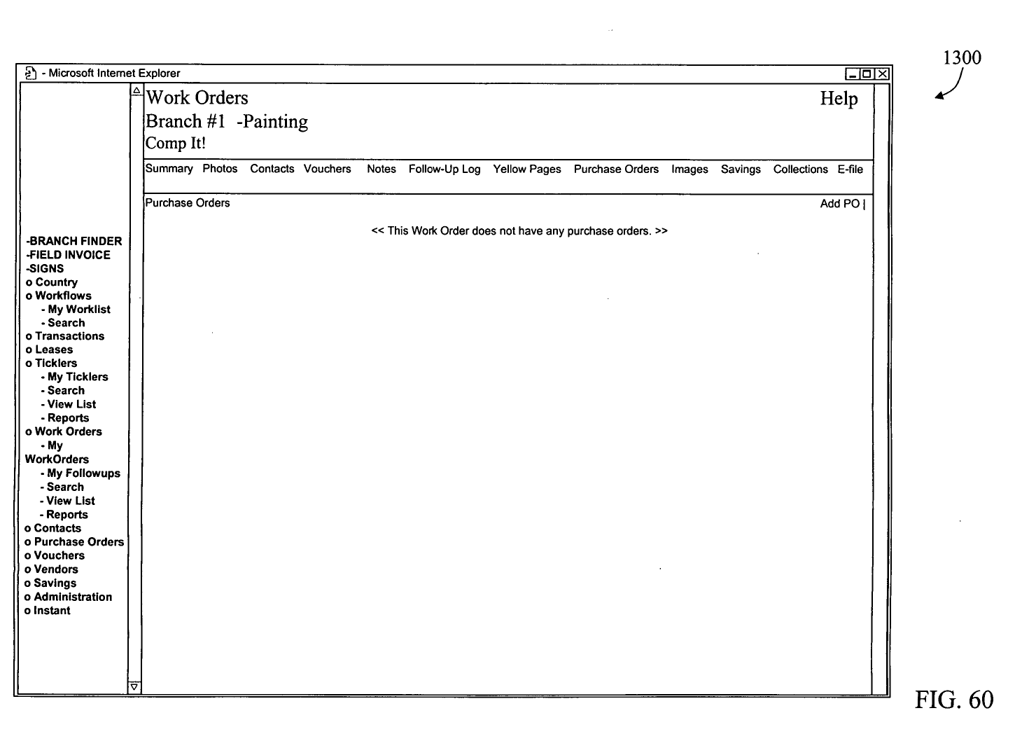

FIG. 60 is an example embodiment of a user interface 1300 displaying a work order purchase orders page included within REWMS 10 (shown in FIG. 1). In the example embodiment, user interface 1300 displays a list of purchase orders associated with a work order. In one embodiment, not illustrated, a user may select stored purchase orders by scrolling through a choice of purchase order numbers, date entry, vendors, and a description.

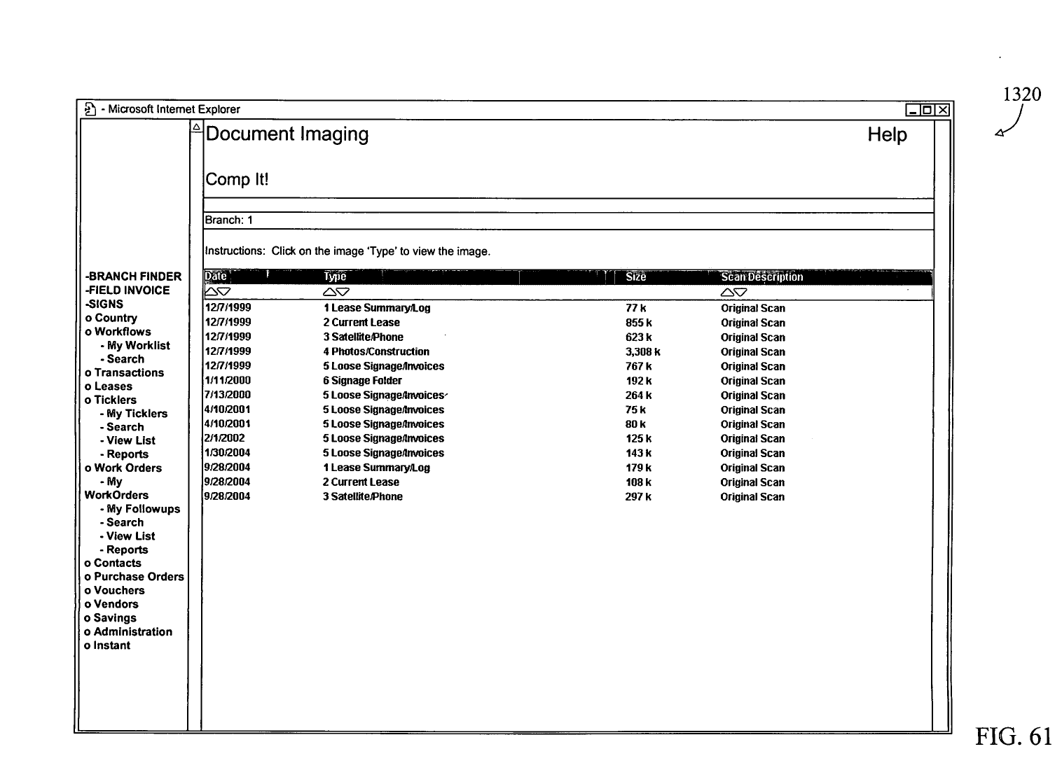

FIG. 61 is an example embodiment of a user interface 1320 displaying a work order images page included within REWMS 10 (shown in FIG. 1). In the example embodiment, user interface 1320 allows the user to select stored images associated with the work order. Examples of such images that a user may select and view include, but are not limited to, the current lease, photos during construction, satellite and phone images, an old lease, signage folders and loose signage and invoices.

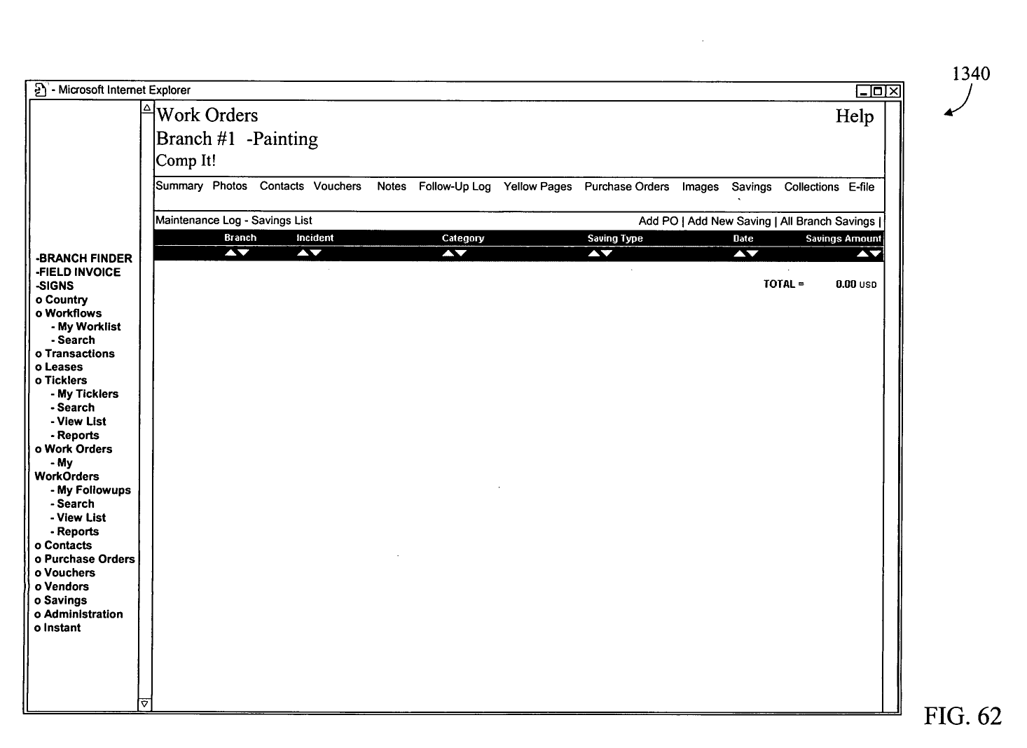

FIG. 62 is an example embodiment of a user interface 1340 displaying a work order savings list page included within REWMS 10 (shown in FIG. 1). In the example embodiment, user interface 1340 displays a savings list associated with a work order including a branch, an incident number, a category number, savings type, a date and a savings amount. A user accessing user interface 1340 may sort the savings list by any of these categories.

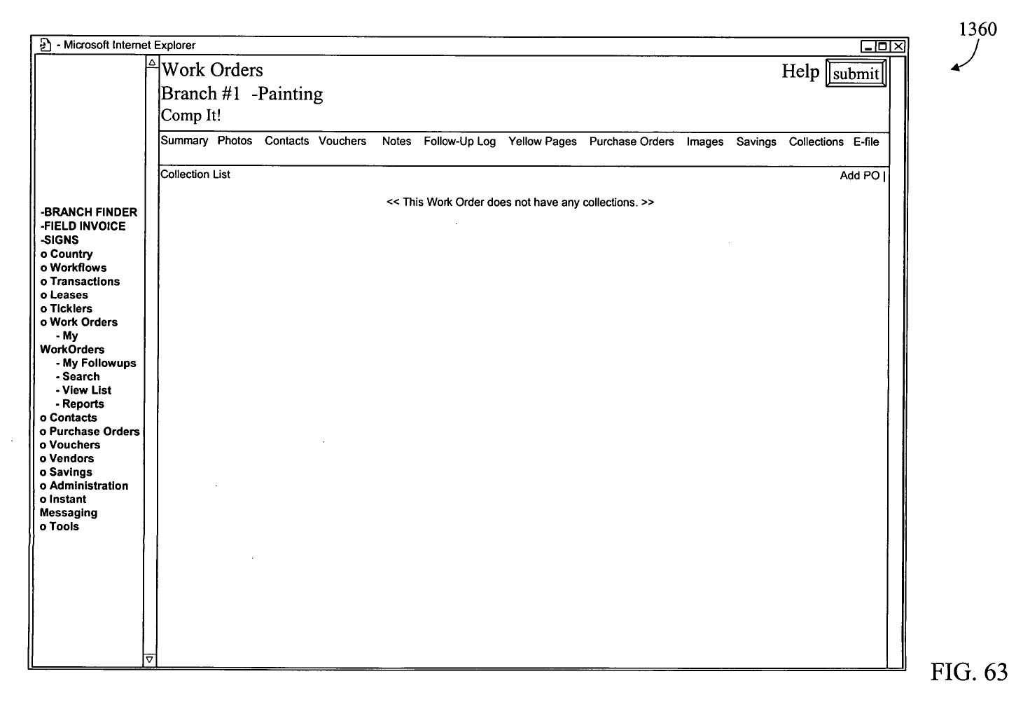

FIG. 63 is an example embodiment of a user interface 1360 displaying a work order collection list page included within REWMS 10 (shown in FIG. 1). In the example embodiment, user interface 1360 displays a collection list associated with a particular work order.

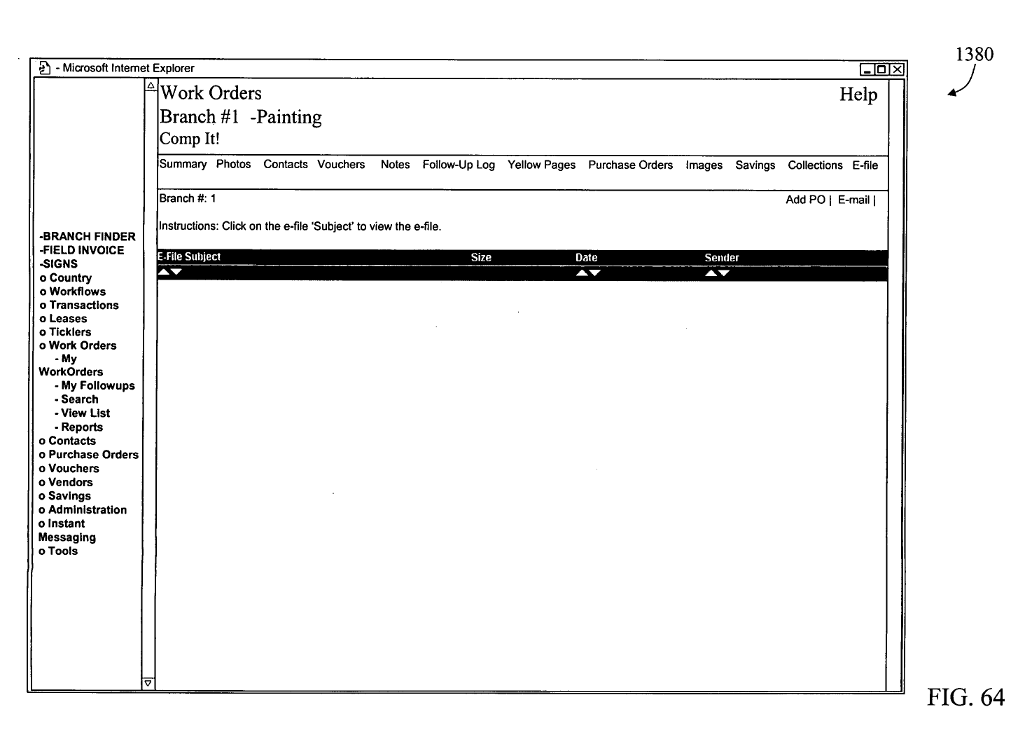

FIG. 64 is an example embodiment of a user interface 1380 displaying a work order E-file page included within REWMS 10 (shown in FIG. 1). In the example embodiment, user interface 1380 displays and allows the user to select E-file subjects associated with the work order. E-files are selectable by the subject matter, by date or by sender.

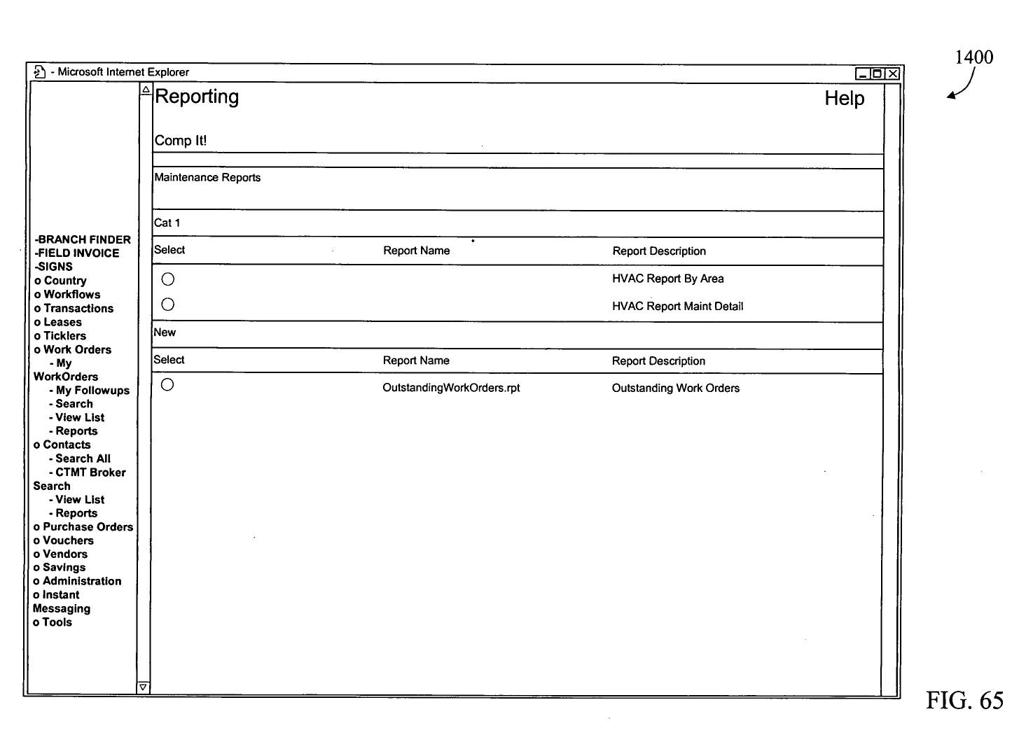

FIG. 65 is an example embodiment of a user interface 1400 displaying a maintenance reporting page included within REWMS 10 (shown in FIG. 1). In the example embodiment, user interface 1400 displays and allows the user to select maintenance reports. A report name and report description are provided.

Contacts

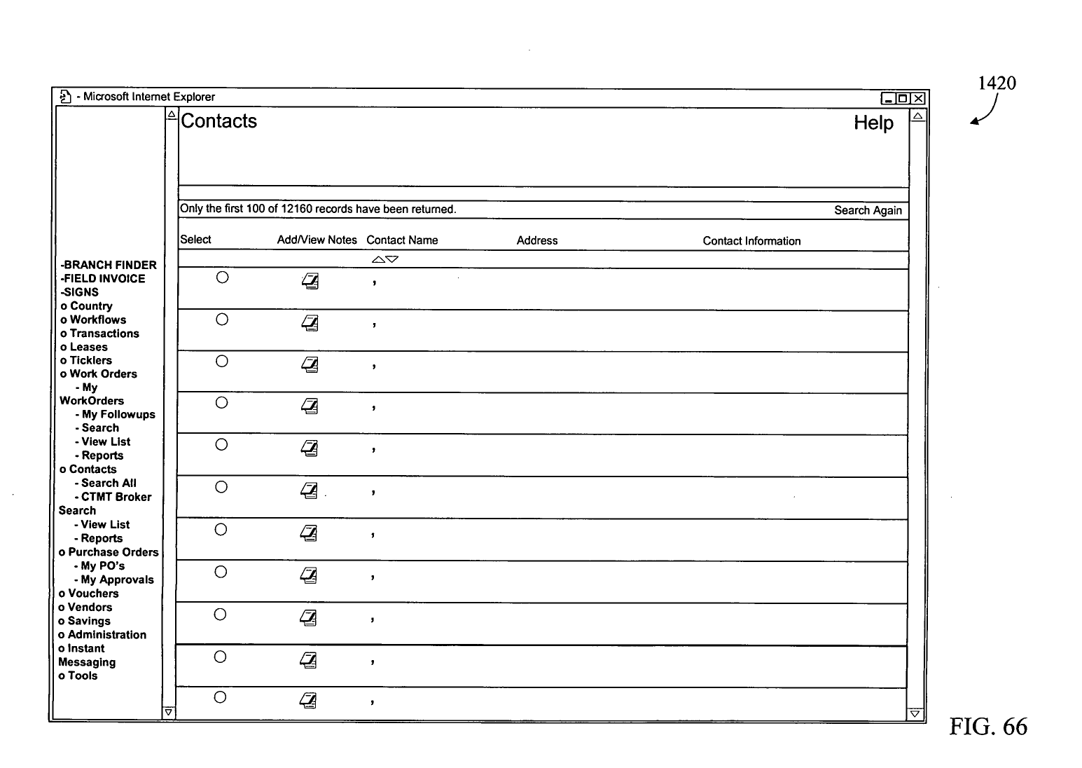

FIG. 66 is an example embodiment of a user interface 1420 displaying contacts included within REWMS 10 (shown in FIG. 1). The contacts (user interface 1420) are displayed when the contacts option (contacts link 322 shown in FIG. 5) is selected by a user. The displayed contacts may be sorted by contact name. An individual contact may have notes associated therewith which are selectable for viewing. Also an address and telephone and fax information for each contact may be provided.

Purchase Orders

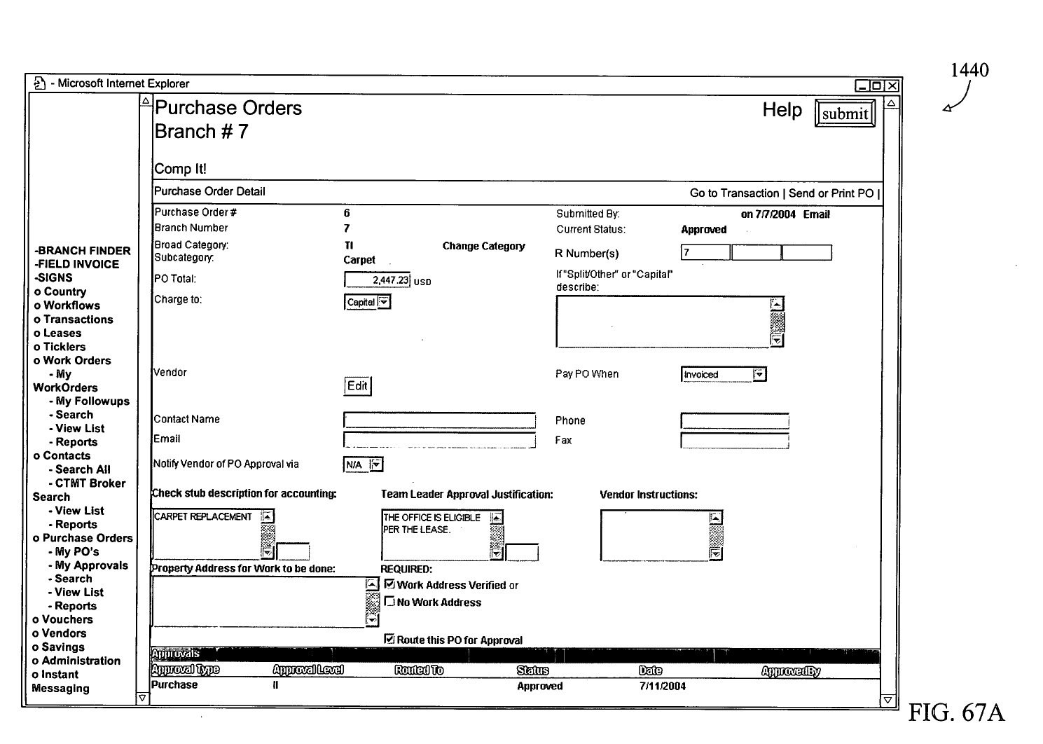

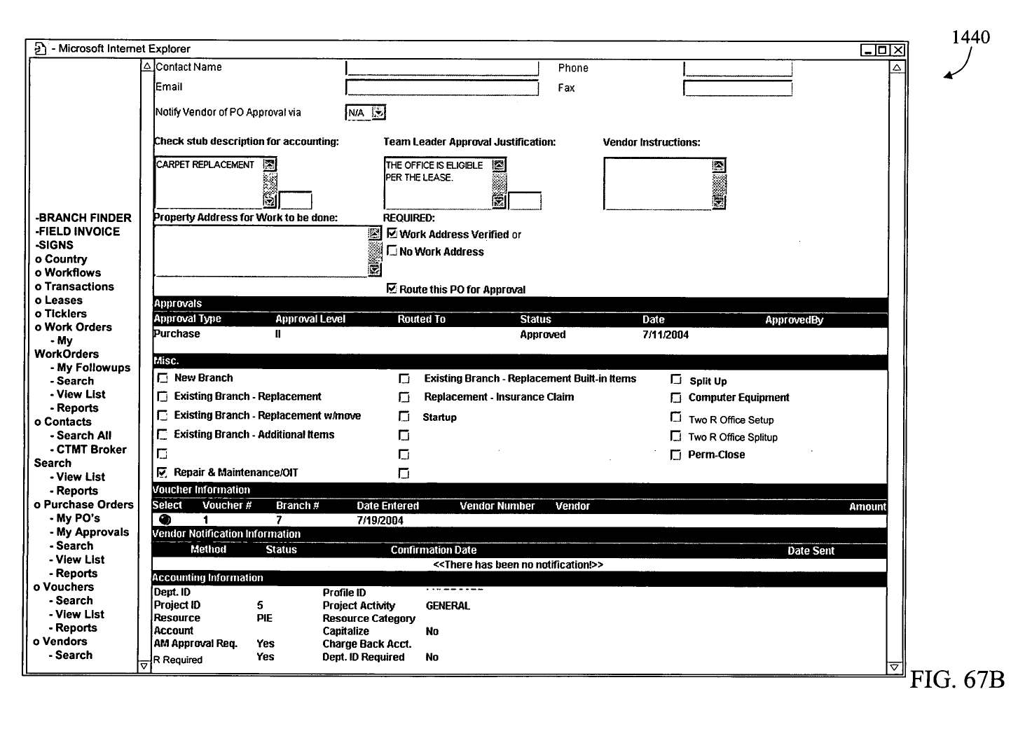

FIGS. 67A and 67B are an example embodiment of a user interface 1440 displaying a purchase order page included within REWMS 10 (shown in FIG. 1). User interface 1440 is displayed when the purchase order option (purchase order link 324 shown in FIG. 5) is selected by a user. In the example embodiment, user interface 1440 displays information associated with purchase order details, approvals, miscellaneous information regarding the property associated with the purchase order, voucher information, vendor notification information, and accounting information associated with the purchase order. A user may enter data into several of the fields included in user interface 1440, including, but not limited to, lessee representative identification number, a PO total, a contact name and contact information, a property address, and team leader approval.

Purchase Order Wizard

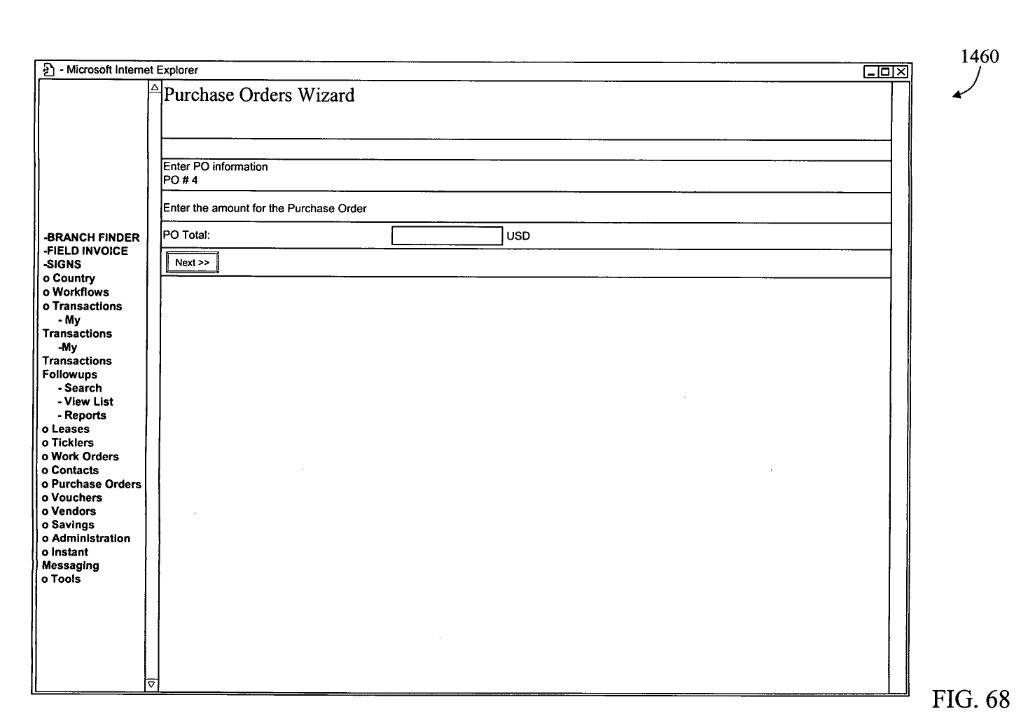

FIG. 68 through FIG. 74 are example embodiments of user interfaces for a purchase order wizard included within REWMS 10 (shown in FIG. 1). These user interfaces are utilized when entering information for a purchase order. Upon completion of the information entry, REWMS 10 is configured to display the information within user interface 1440 (shown in FIGS. 67A and 67B).

FIG. 68 is an example embodiment of a user interface 1460 included within REWMS 10 (shown in FIG. 1). User interface 1460 is utilized for entering purchase order information relating to an amount of the purchase order.

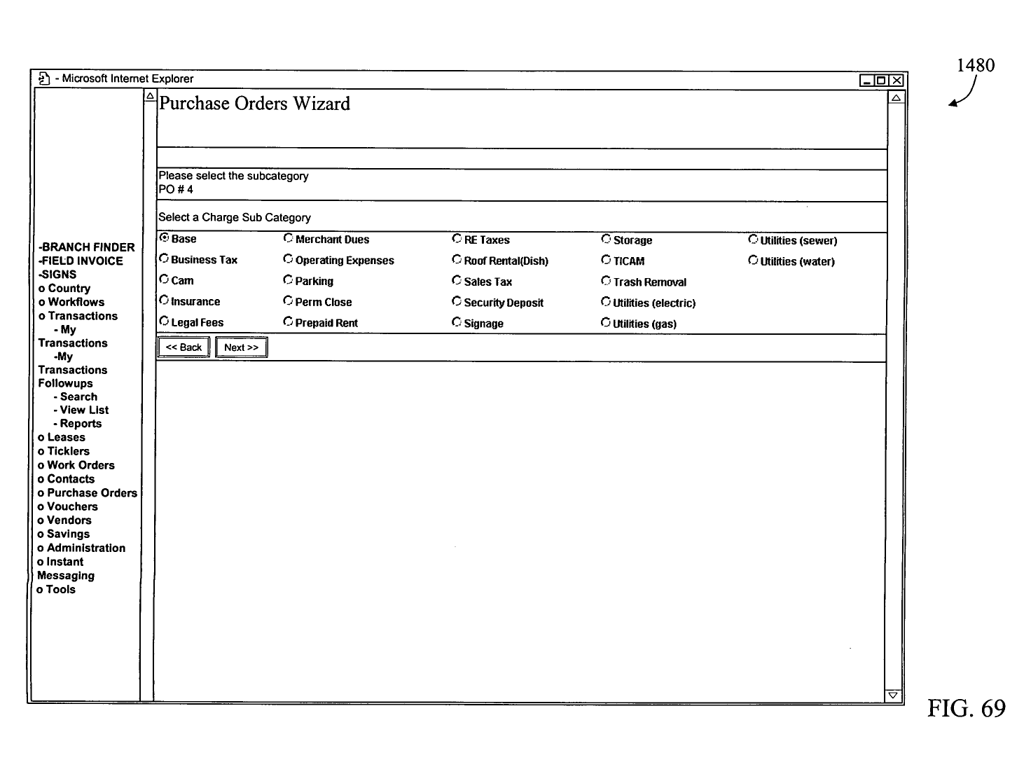

FIG. 69 is an example embodiment of a user interface 1480 included within REWMS 10 (shown in FIG. 1). User interface 1480 is utilized for entering purchase order information relating to charge sub-categories for the purchase order. A couple of the sub-categories included within user interface 1480 include insurance, legal fees, real estate taxes, sales taxes, trash removal, and various utilities.

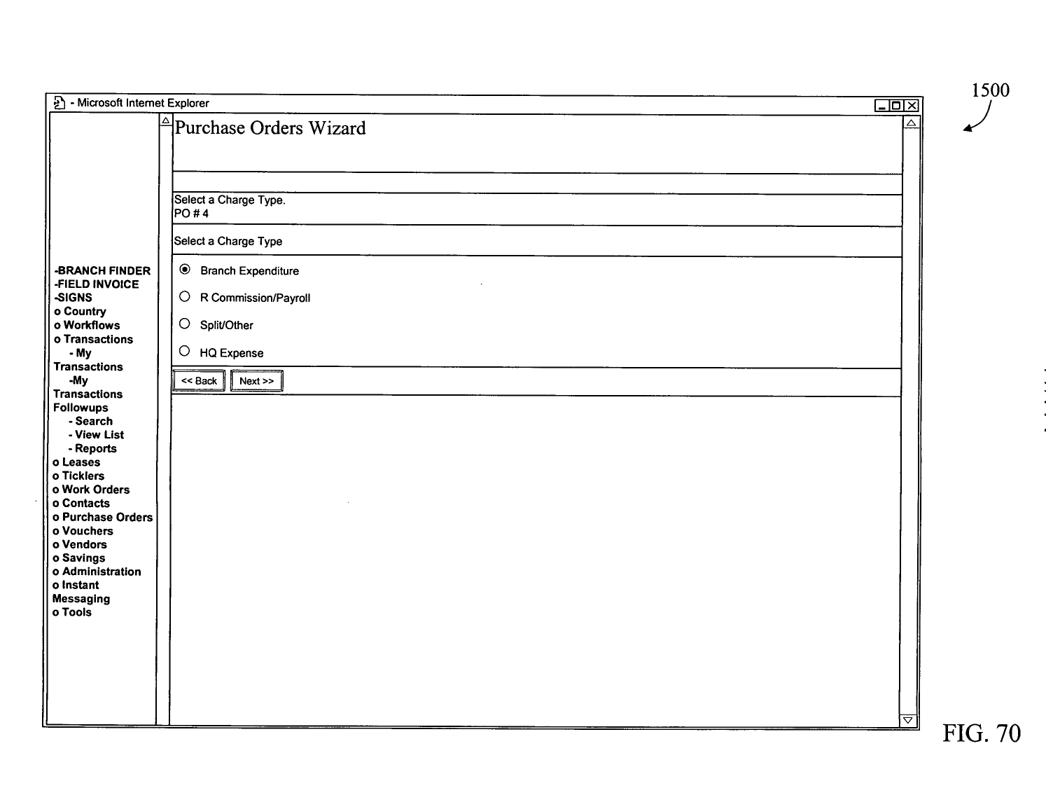

FIG. 70 is an example embodiment of a user interface 1500 included within REWMS 10 (shown in FIG. 1). User interface 1500 is utilized for entering purchase order information relating to charge types for a purchase order. Charge types included within user interface 1500 include branch expenditure, lessee representative commission, split/other, and headquarters expense.

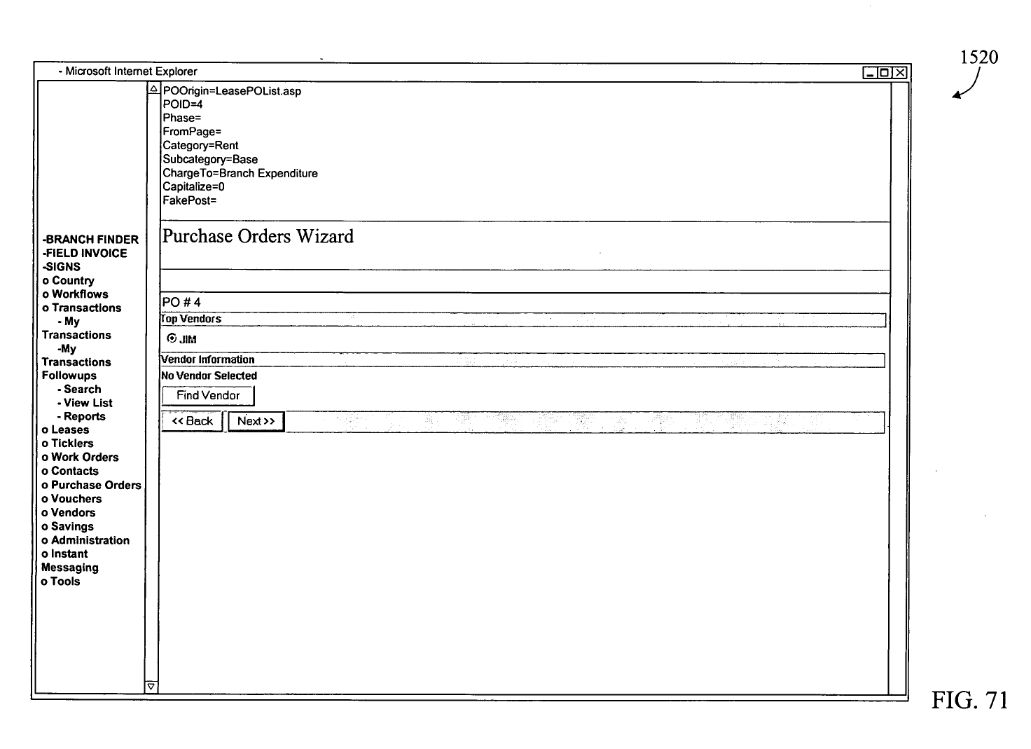

FIG. 71 is an example embodiment of a user interface 1520 included within REWMS 10 (shown in FIG. 1). User interface 1520 is utilized for selecting vendors in association with a purchase order.

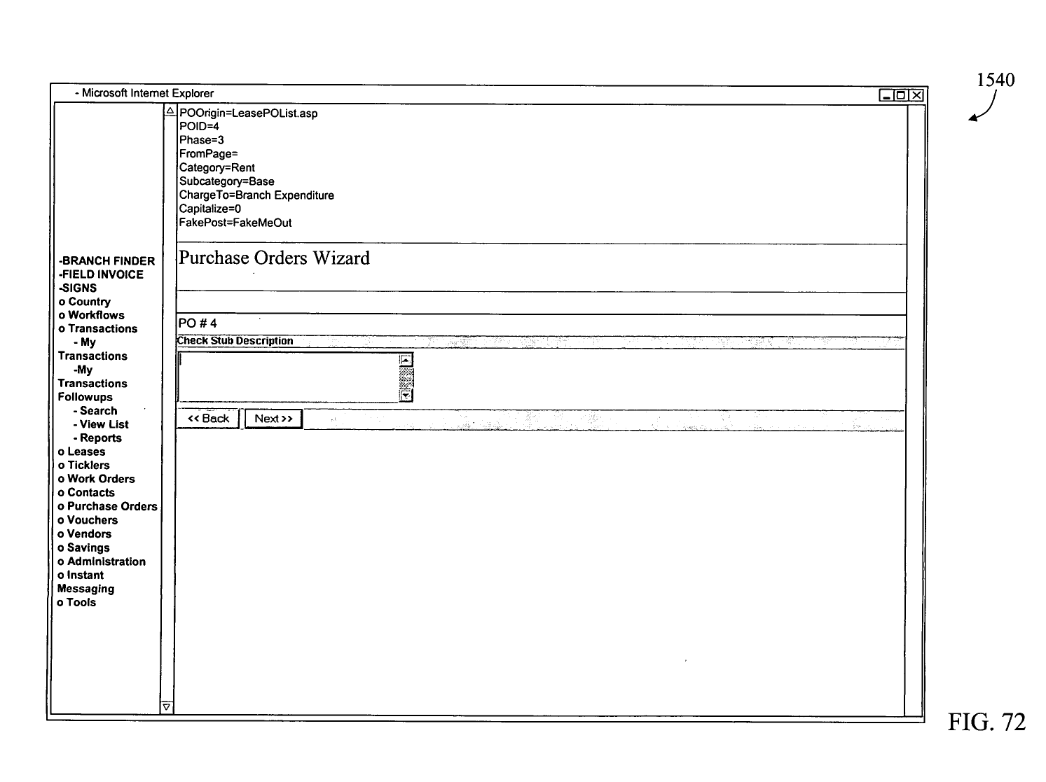

FIG. 72 is an example embodiment of a user interface 1540 included within REWMS 10 (shown in FIG. 1). User interface 1540 is utilized for entering text for a check stub description relating to a purchase order.

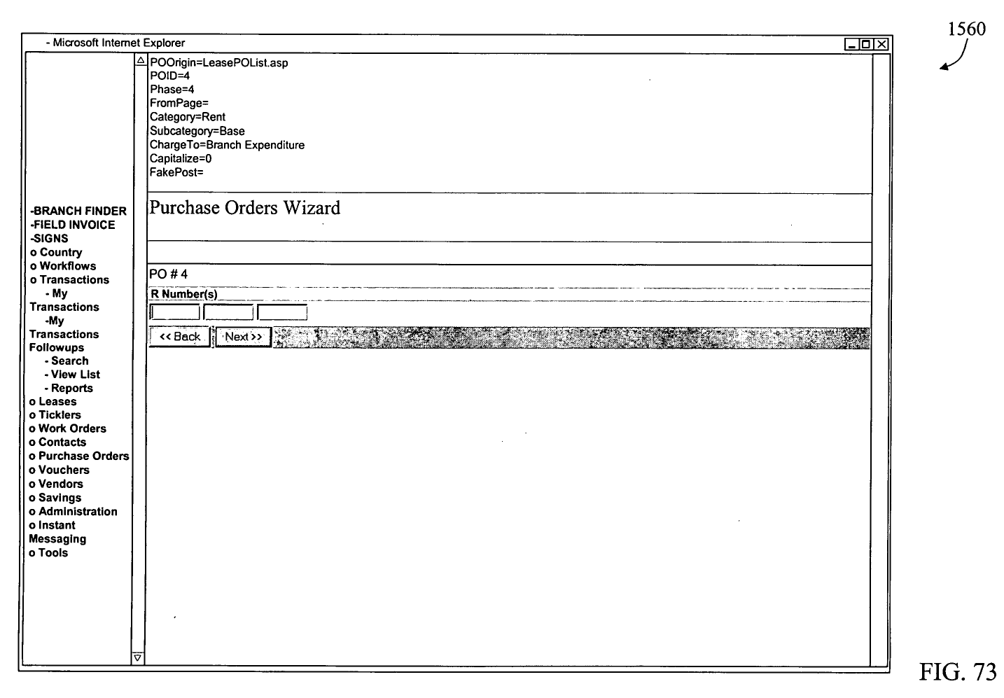

FIG. 73 is an example embodiment of a user interface 1560 included within REWMS 10 (shown in FIG. 1). User interface 1560 is utilized for entering identification numbers for the lessee representatives associated with a purchase order.

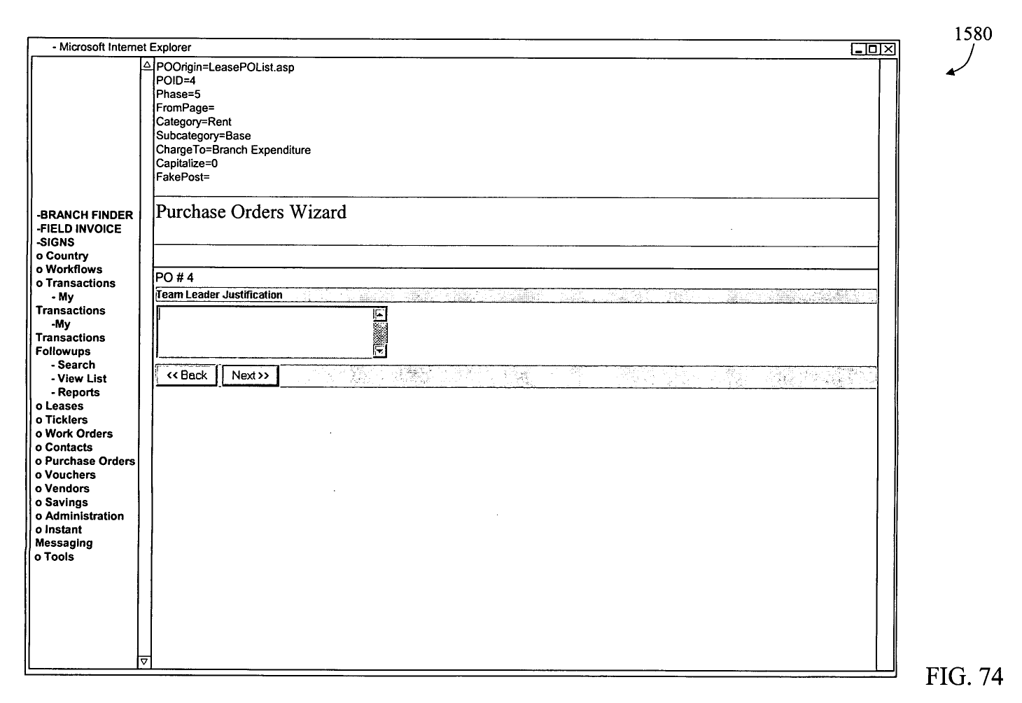

FIG. 74 is an example embodiment of a user interface 1580 included within REWMS 10 (shown in FIG. 1). User interface 1580 is utilized for entering text of a team leader justification for a purchase order.

Vouchers

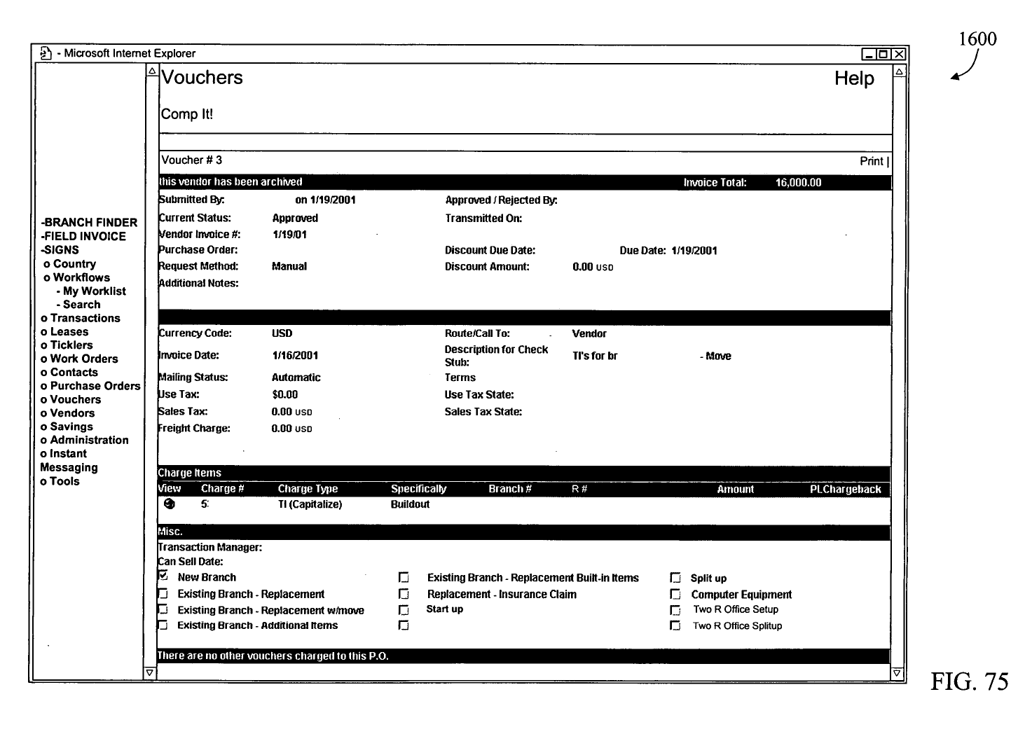

FIG. 75 is an example embodiment of a user interface 1600 displaying a voucher page included within REWMS 10 (shown in FIG. 1). User interface 1600 is displayed when the vouchers option (vouchers link 326 shown in FIG. 5) is selected by a user. In the example embodiment, user interface 1600 displays information associated with a selected voucher number. Such information may include a status, approvals, a due date, an invoice date, a mailing status, terms, a discount due date, and discount. Charge items associated with a voucher number may be viewed. Information relating to the property and voucher may be entered, for example, a new branch, replacement of an existing branch, and replacement due to an insurance claim.

Vendors

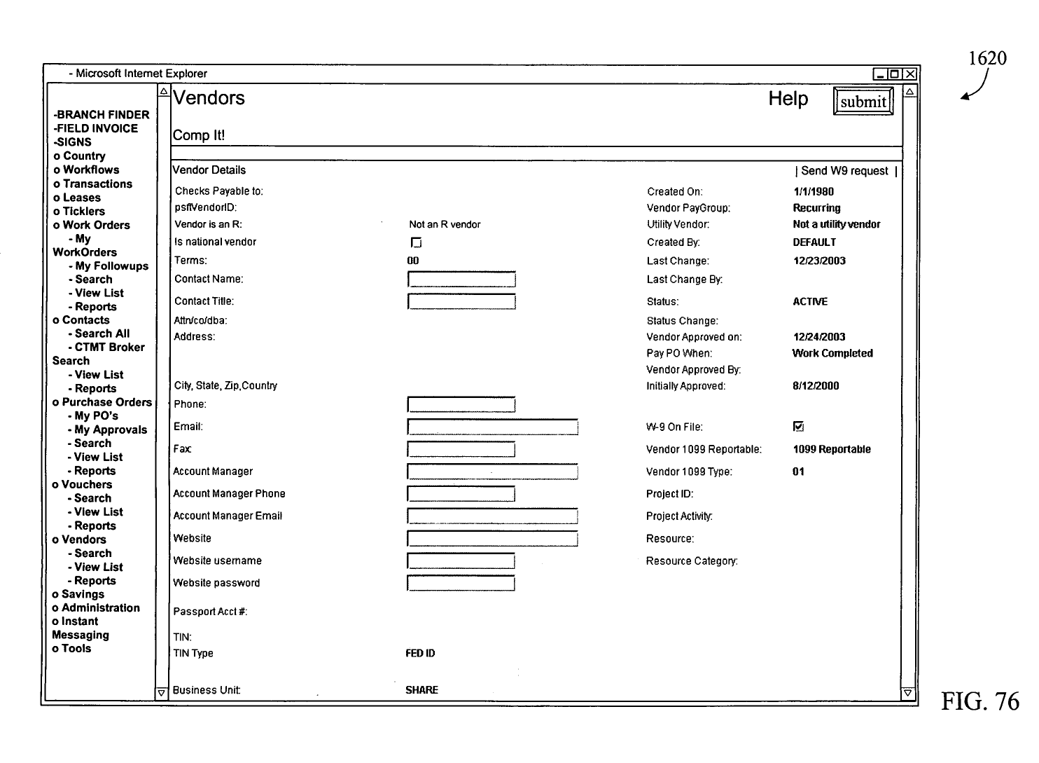

FIG. 76 is an example embodiment of a user interface 1620 displaying a vendor page included within REWMS 10 (shown in FIG. 1). User interface 1620 is displayed when the vendors option (vendors link 328 shown in FIG. 5) is selected by a user. In the example embodiment, user interface 1620 displays information and allows a user to enter additional information associated with a selected vendor. Such information may include a contact name, contact title, address information, account manager information, website information for a vendor.

Savings

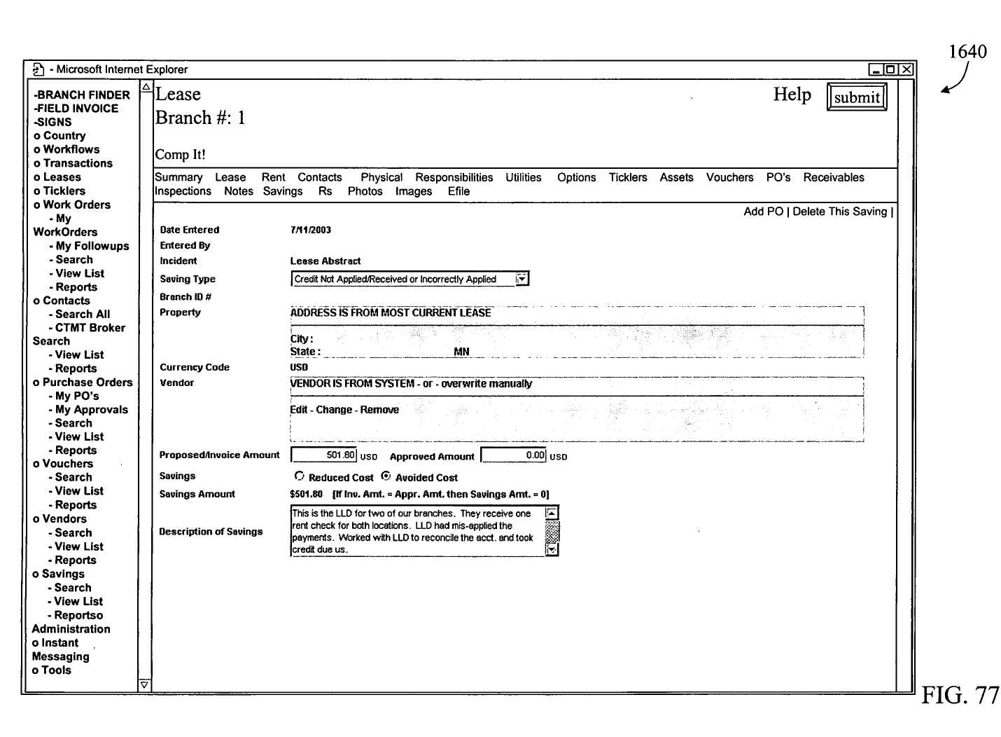

FIG. 77 is an example embodiment of a user interface 1640 displaying a savings page included within REWMS 10 (shown in FIG. 1). User interface 1640 is displayed when the savings option (savings link 330 shown in FIG. 5) is selected by a user. In the example embodiment, user interface 1640 displays information and allows a user to enter additional information associated with a selected saving event. Such information may include a date and information for the user that entered the data. Other entered information includes savings type, an identifying number for the property, and address of the property, an invoice amount, a savings amount relating to the invoiced amount, and a textual description of the savings amount.

Instant Messaging

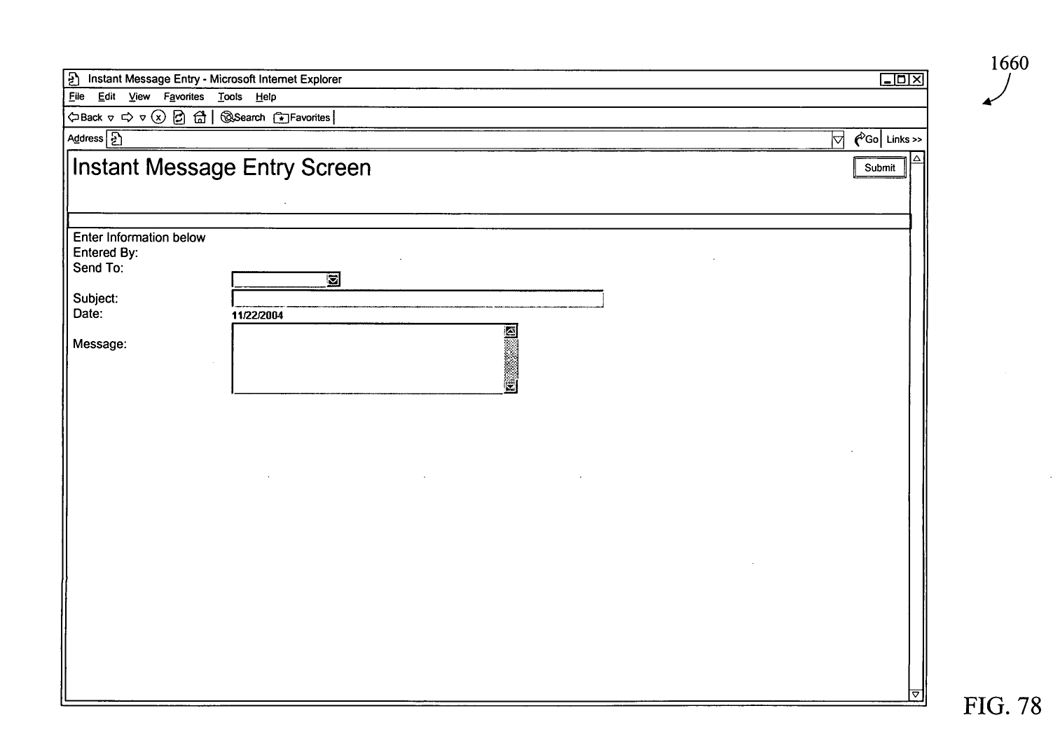

FIG. 78 is an example embodiment of a user interface 1660 displaying an instant message entry page included within REWMS 10 (shown in FIG. 1). User interface 1660 is displayed when the instant messaging option (instant messaging link 334 shown in FIG. 5) is selected by a user. In the example embodiment, user interface 1660 allows a user to enter a message. Information identifying the sender, the receiver(s), the subject, and the date is either entered by the sender or automatically included by REWMS 10.

Document Generator

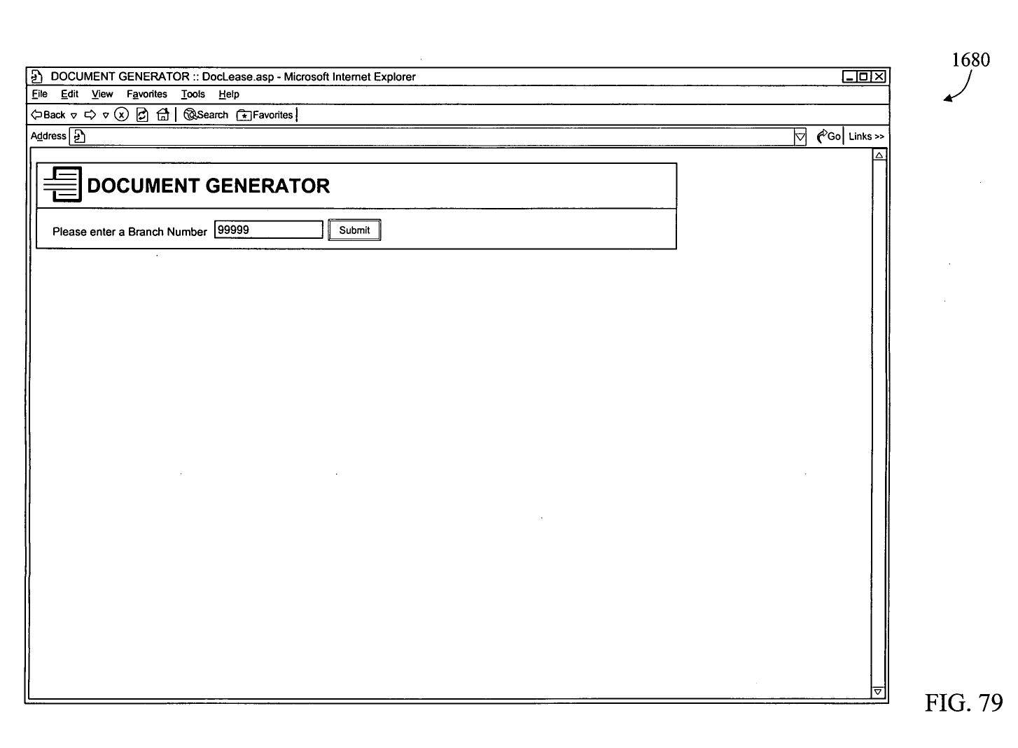

FIG. 79 through FIG. 89 are example embodiments of user interfaces for a document generator included within REWMS 10 (shown in FIG. 1). The user interfaces are accessible when the tools option (tools link 336 shown in FIG. 5) is selected by a user. The user interfaces are utilized when entering information for the generation of a document, for example, a lease agreement. Upon completion of the information entry, REWMS 10 is configured to generate one or more documents which include the information entered by the user.

FIG. 79 is an example embodiment of a user interface 1680 displaying a branch number entry page included within REWMS 10 (shown in FIG. 1). User interface 1680 is utilized to enter a branch number to be associated with documents to be generated.

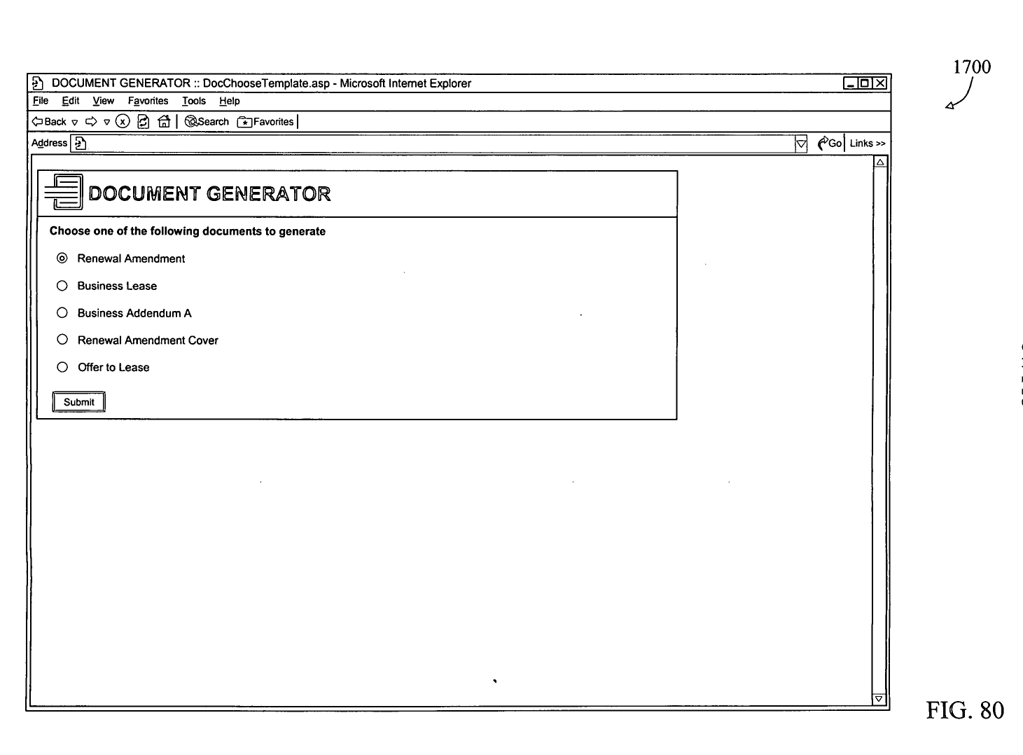

FIG. 80 is an example embodiment of a user interface 1700 displaying a select documents page included within REWMS 10 (shown in FIG. 1). User interface 1700 is utilized to select a number of documents to be generated which are associated with entered data as described herein. In the embodiment illustrated, documents that can be generated include, a renewal amendment, a lease, a lease addendum, a renewal amendment cover, and an offer to lease.

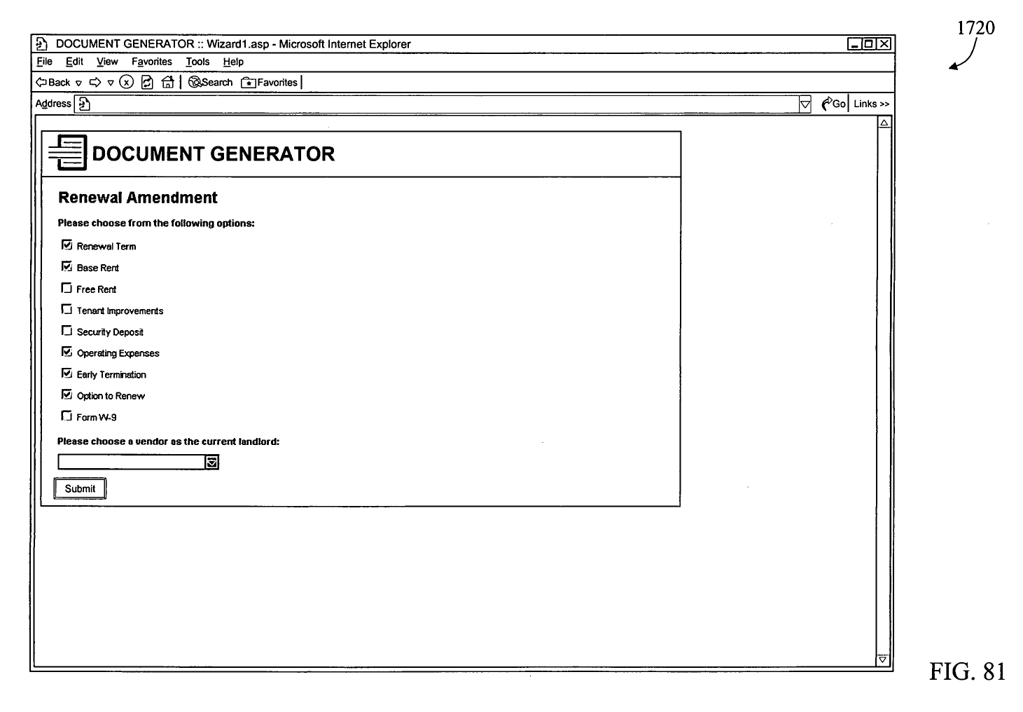

FIG. 81 is an example embodiment of a user interface 1720 displaying a renewal amendment page included within REWMS 10 (shown in FIG. 1). User interface 1720 is utilized to enter terms of a renewal amendment to be utilized in documents to be generated. Renewal amendment terms include, renewal term, base rent, free rent, tenant improvements, security deposit, operating expenses, early termination, option to renew, and form W-9. A selection box for selecting a vendor (landlord) associated with the renewal is also provided.

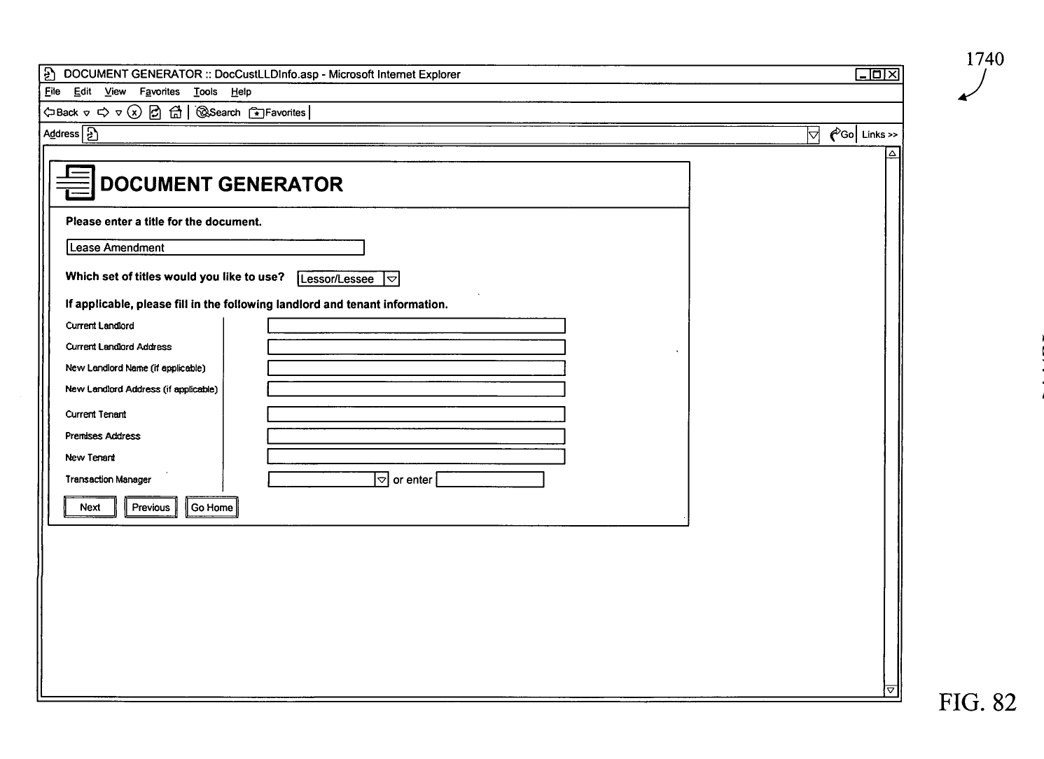

FIG. 82 is an example embodiment of a user interface 1740 displaying a document title page included within REWMS 10 (shown in FIG. 1). User interface 1740 is utilized to enter the title of a document to be generated. In the illustrated example, a lease amendment is to be generated. Lease amendment terms include, current and new landlord name and address, current and new tenant, an address of the subject property, and a transaction manager.

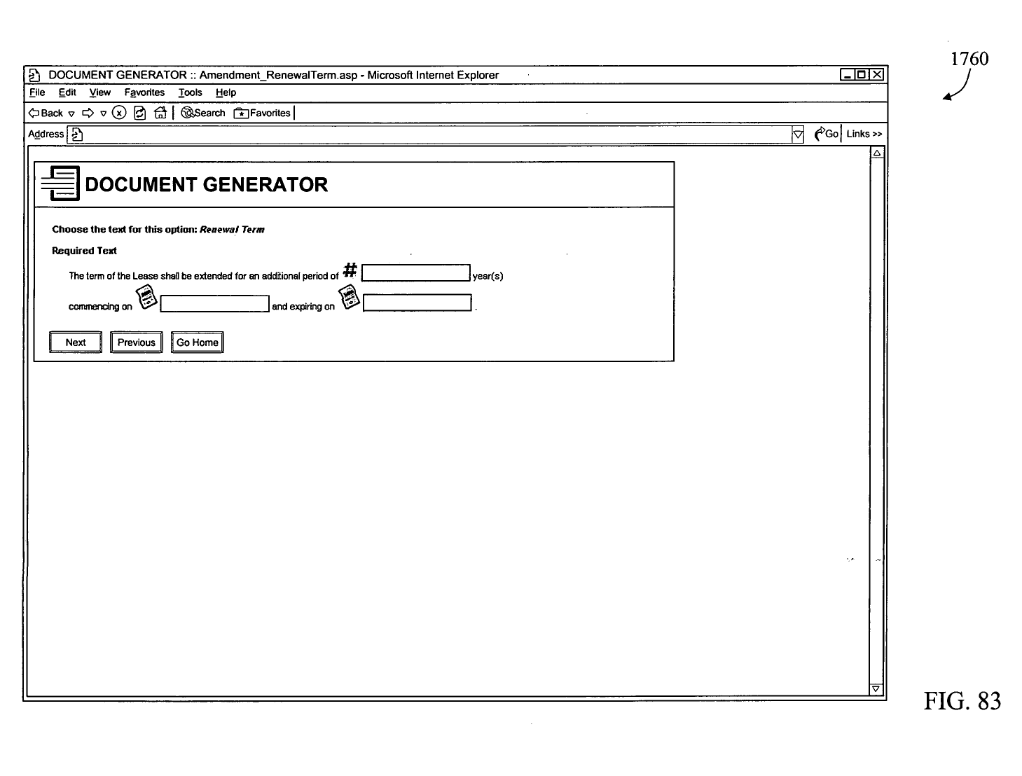

FIG. 83 is an example embodiment of a user interface 1760 displaying a renewal term entry page included within REWMS 10 (shown in FIG. 1). User interface 1760 is utilized to enter terms of a renewal to be utilized in documents to be generated. Renewal terms include the renewal term, a commencement date, and an expiration date.

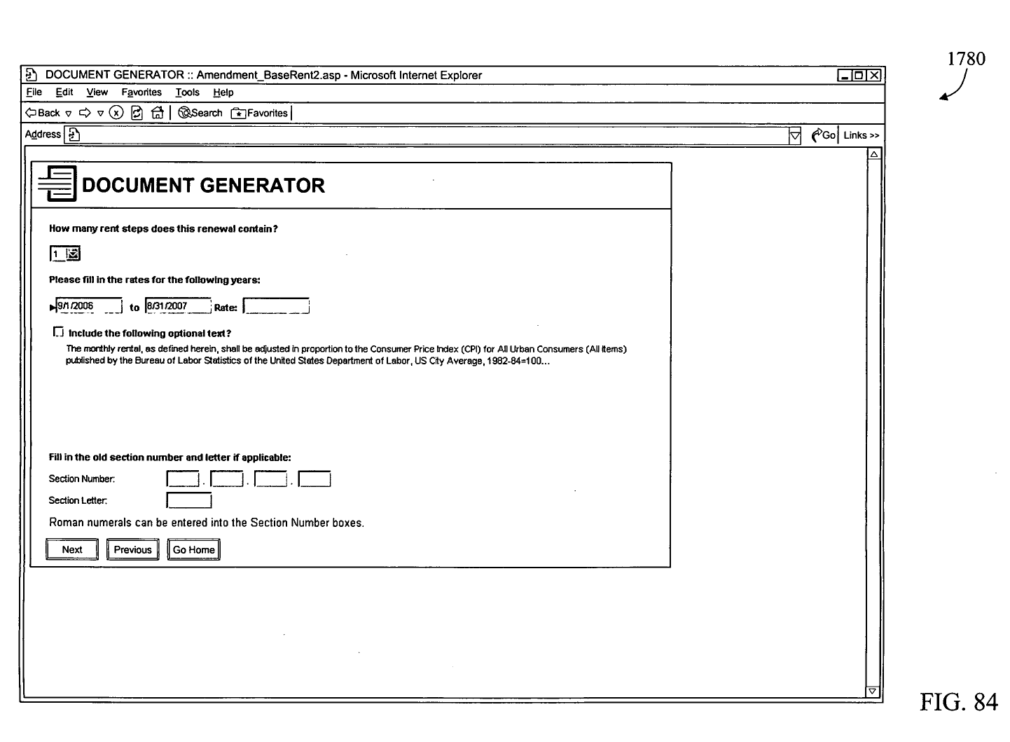

FIG. 84 is an example embodiment of a user interface 1780 displaying a rent steps page included within REWMS 10 (shown in FIG. 1). User interface 1780 is utilized to enter the number of rent steps and the terms and rate for each of the rent steps associated with a lease transaction.

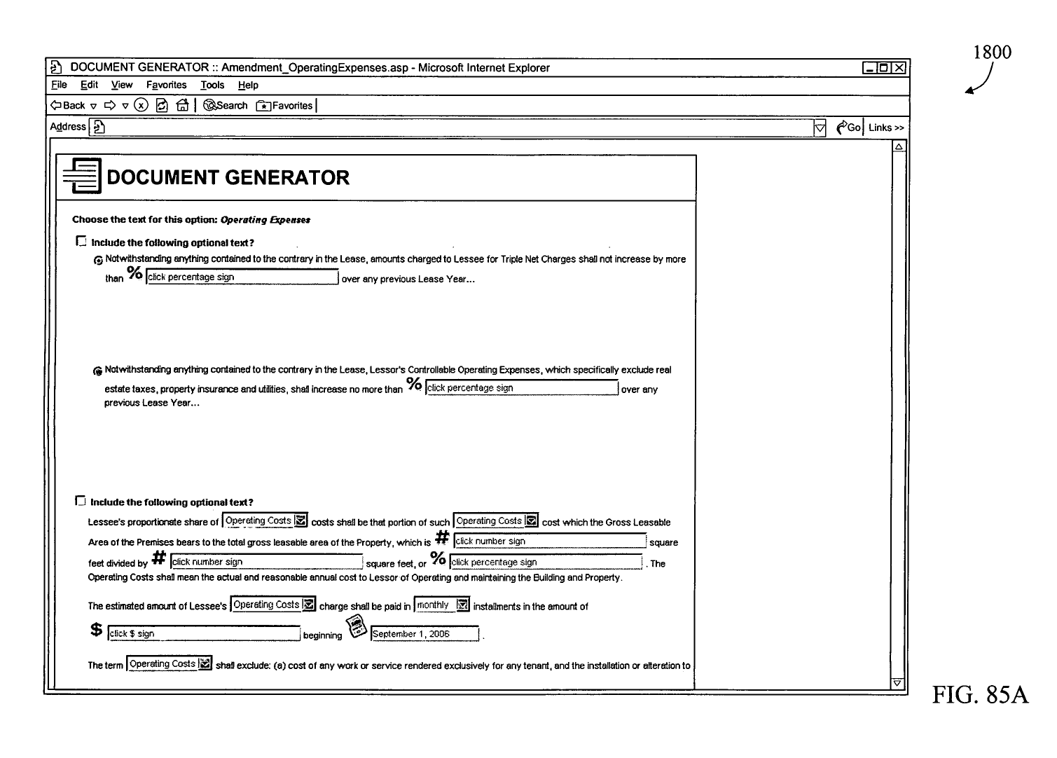

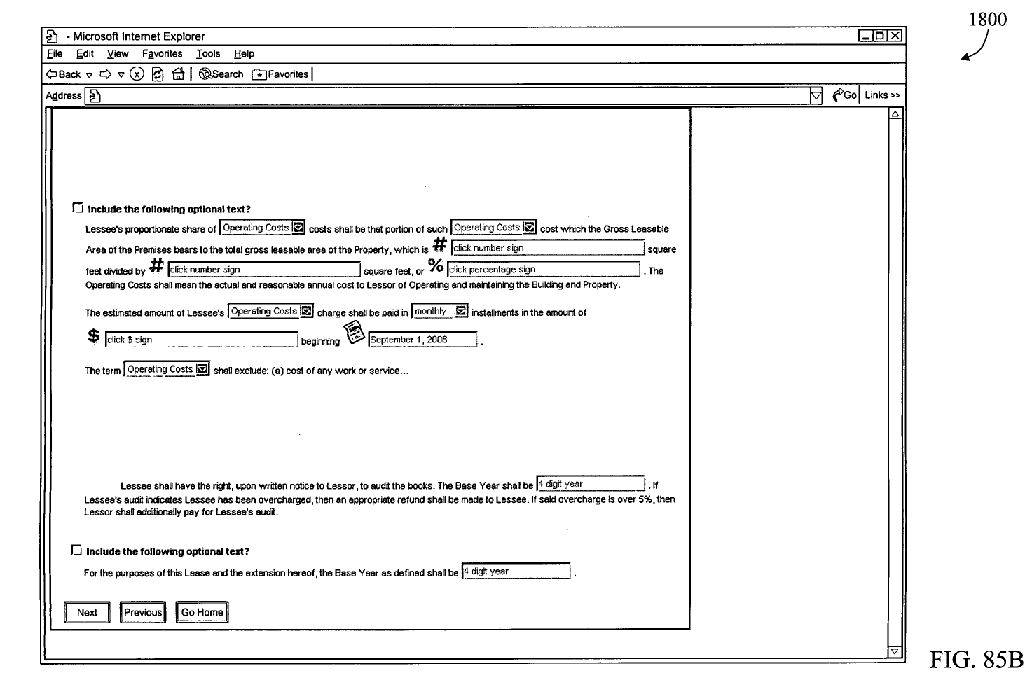

FIGS. 85A and 85B are an example embodiment of a user interface 1800 displaying an operating expenses options page included within REWMS 10 (shown in FIG. 1). User interface 1800 is utilized to enter optional text relating to operating expenses, for example, those assumed by the lessee and those assumed by the lessor.

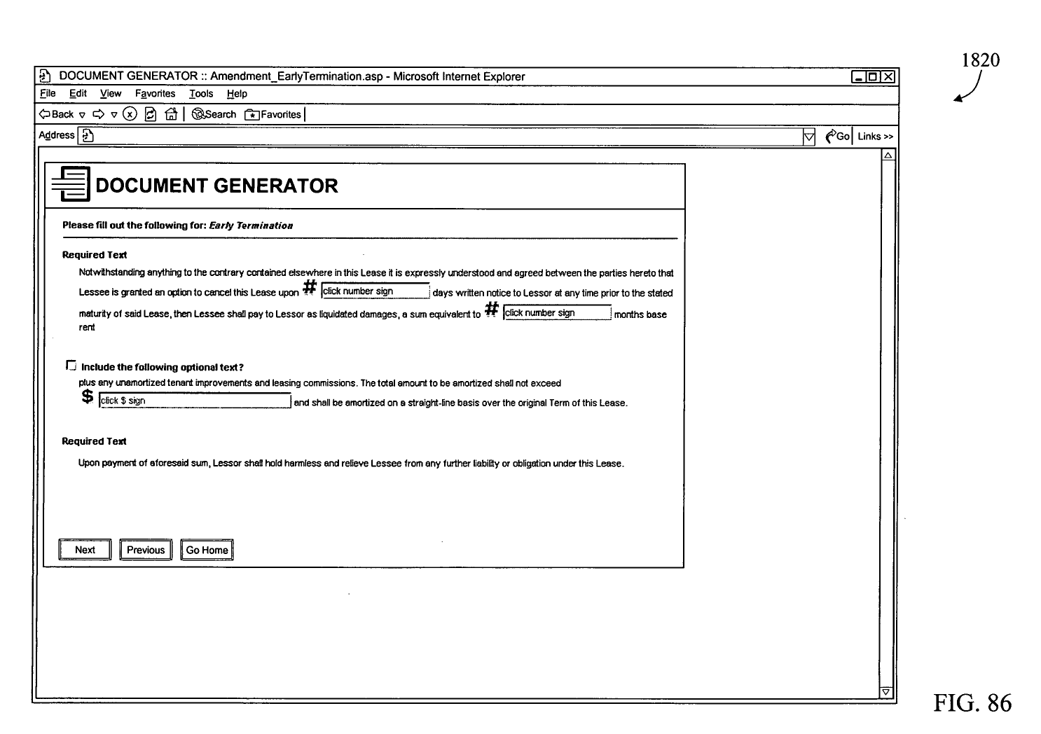

FIG. 86 is an example embodiment of a user interface 1820 displaying an early terminations options page included within REWMS 10 (shown in FIG. 1). User interface 1820 is utilized to enter terms associated with early termination of an agreement, for example, a lease agreement. Data entered included a number of days written notice to lessor, a number of months rent as damages for early termination, and a value for unamortized tenant improvement and leasing commissions.

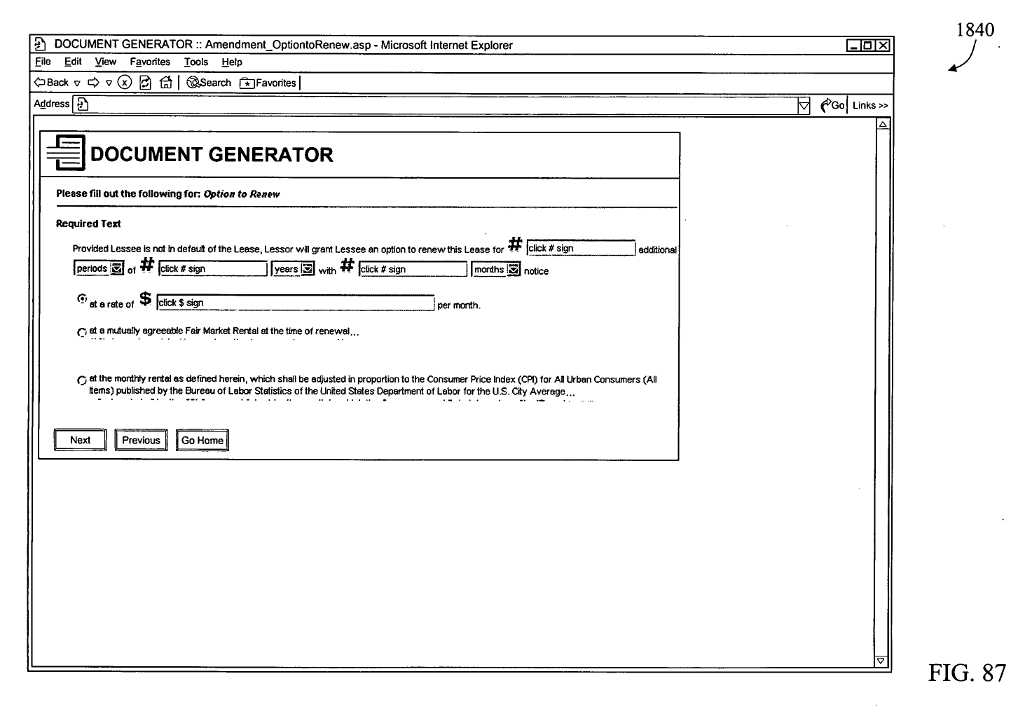

FIG. 87 is an example embodiment of a user interface 1840 displaying a renewal options page included within REWMS 10 (shown in FIG. 1). User interface 1840 is utilized to enter terms associated with renewal option within an agreement, for example, a lease agreement. Data entered included a number of periods of an entered number of years that the lessee may renew an agreement, with an entered number of months notice. Options relating to the renewal rent rate are also available.

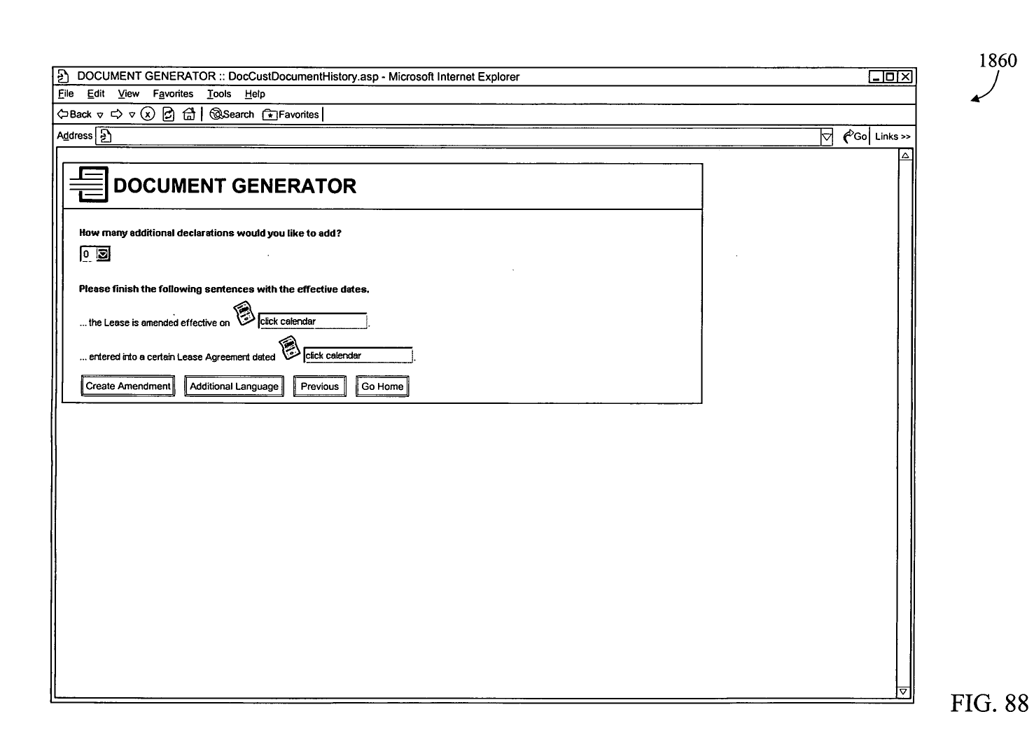

FIG. 88 is an example embodiment of a user interface 1860 displaying a declarations page included within REWMS 10 (shown in FIG. 1). User interface 1860 is utilized to enter the declaration associated with, for example, a lease transaction. A user is able to select the number of additional declarations to be added to the agreement and calendar dates associated with the declarations.

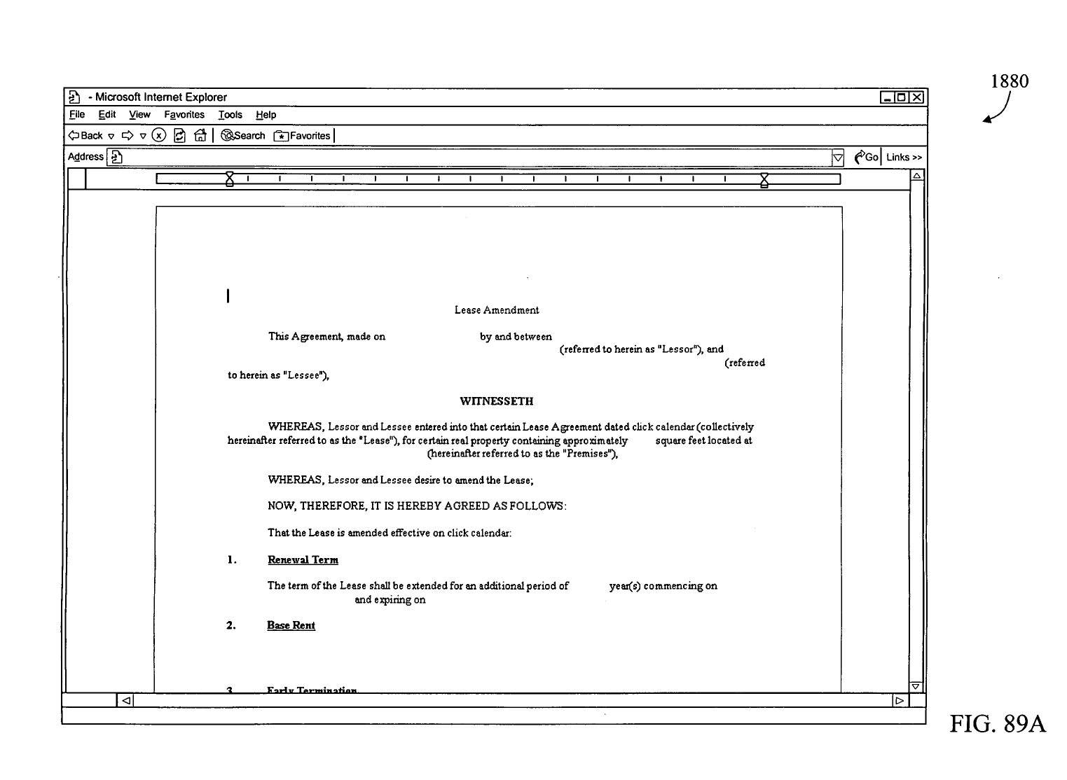

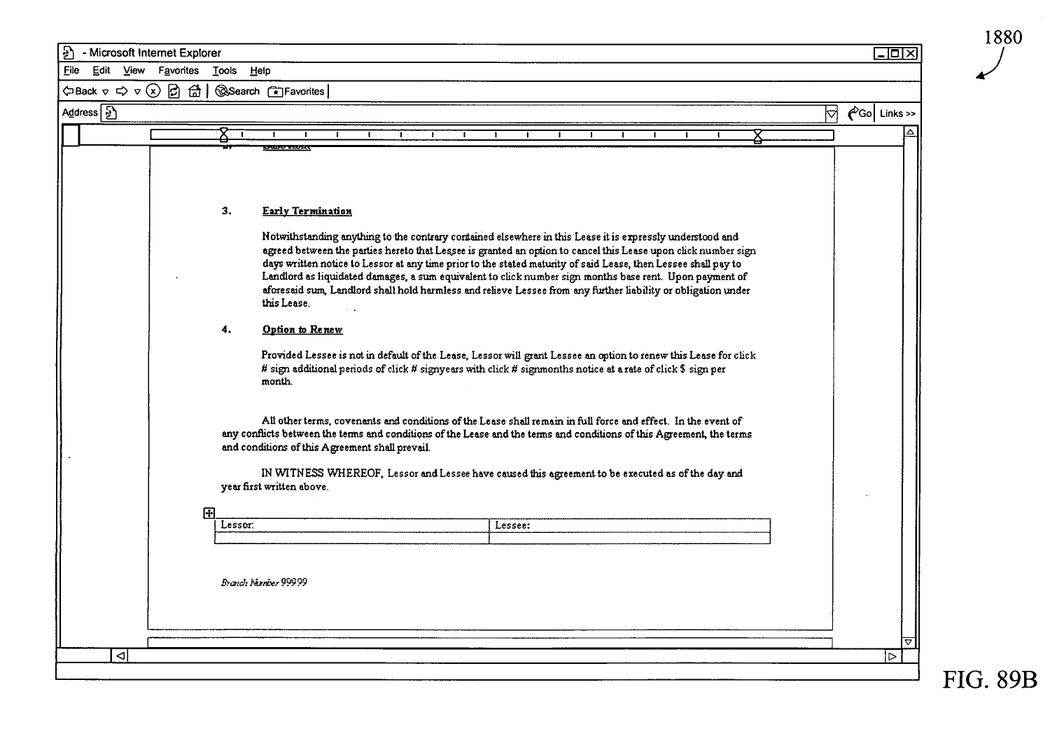

FIGS. 89A and 89B are an example embodiment of a user interface 1880 displaying a document created with the above described document generator. In the illustrated embodiment, user interface 1880 illustrates a lease amendment, including, a renewal term, a base rent rate, early termination and option to renew options. Names of the lessor and lessee are also included.

SEMS Search

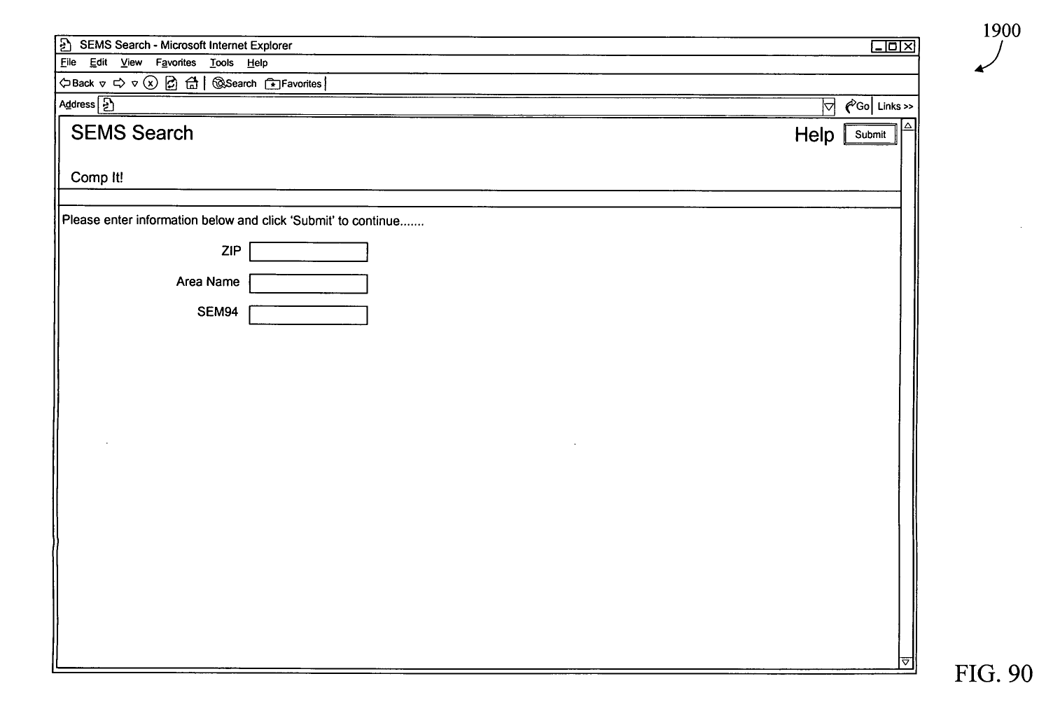

FIG. 90 is an example embodiment of a user interface 1900 displaying a socio-economic measurement system (SEMS) search tool included within REWMS 10 (shown in FIG. 1). User interface 1900 is accessible when the tools option (tools link 336 shown in FIG. 5) is selected by a user. In the example embodiment, user interface 1900 allows a user to enter at least one of a zip code, an area name, and a SEM94, which is a numerical scale (0 to 100) representing a socio-economic measurement. The SEMS search tool allows a user to determine the SEMS (Socio-Economic Measure) of a certain zip code. The SEMS is a relative scale (0 to 100) indicating the relative wealth of that zip code and thus also inferring the relative rent levels to be expected within that zip code. The SEMS figure can be a useful figure in negotiating a lease agreement.

Design and Construction

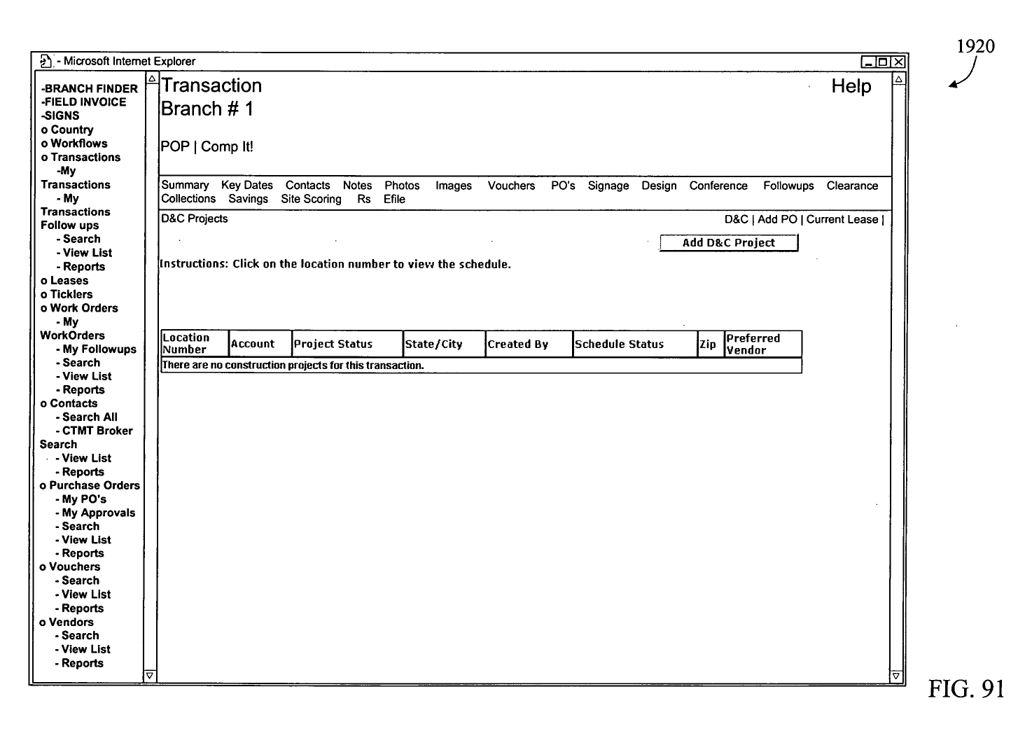

FIG. 91 is an example embodiment of a user interface 1920 displaying a design and construction projects page included within REWMS 10 (shown in FIG. 1). In the example embodiment, user interface 1920 provides the user with an ability select, display, and add design and construction projects to REWMS 10. Displayed project attributes include a location number, an account, a project status, a state and city, a person that created the project, a schedule status for the project, a zip code, and the preferred vendor for the project. By selecting a location number, the schedule for a project is accessible for viewing by a user.

POP

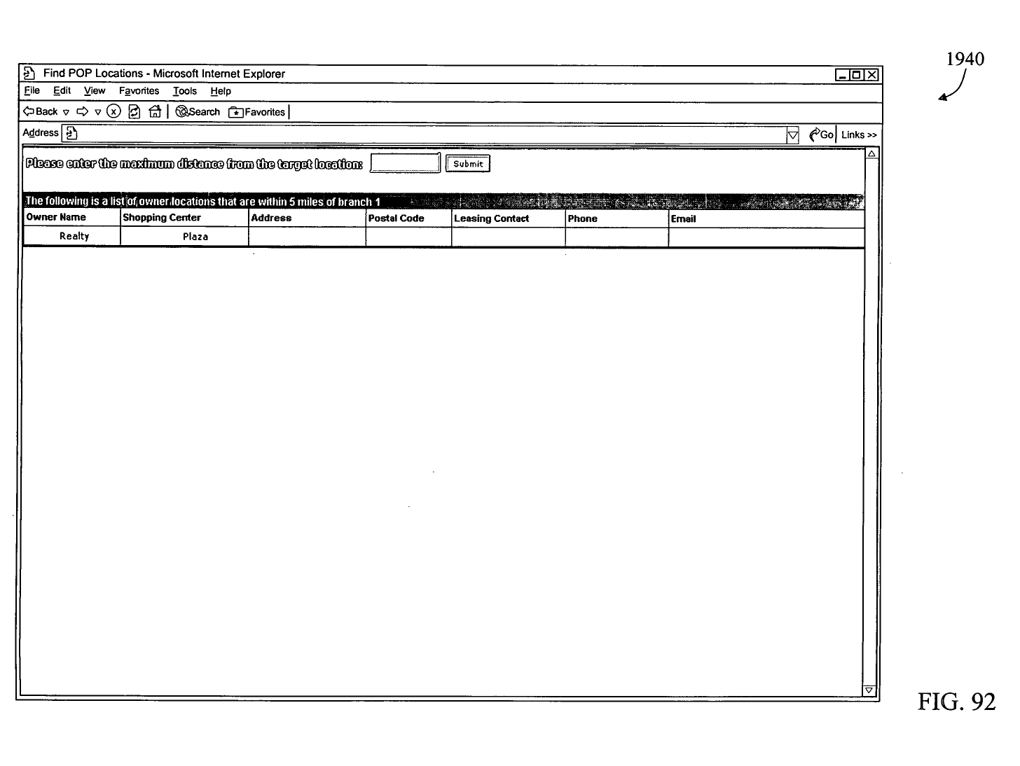

FIG. 92 is an example embodiment of a user interface 1940 displaying a preferred owner program search tool included within REWMS 10 (shown in FIG. 1). User interface 1940 is accessible when a user selects a POP link displayed on a top navigation bar (as shown, for example, on user interface 520 in FIG. 23). In the example embodiment, user interface 1940 allows a user to enter a maximum distance from a target location and REWMS 10 returns a list of target properties for contact, purchase, or lease from preferred owners. For each property in the target list, an owner name, a shopping center name, an address, a zip (or postal) code, a leasing contact, a phone number and E-mail address are provided.

Comp It

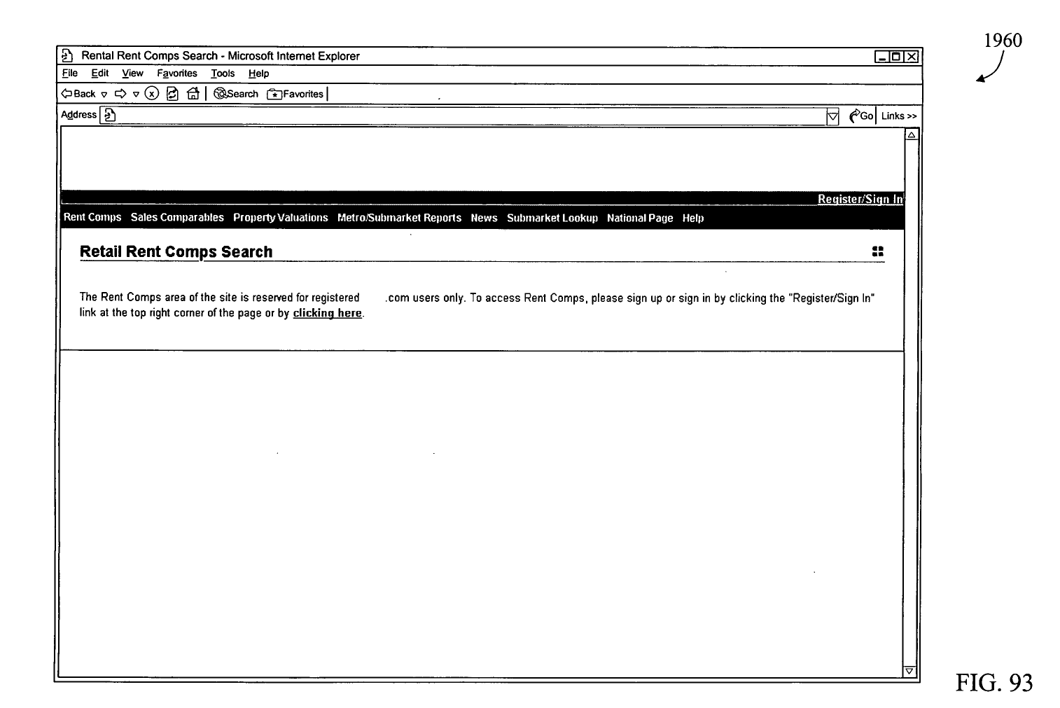

FIG. 93 is an example embodiment of a user interface 1960 displaying a retail rent comparables search tool included within REWMS 10 (shown in FIG. 1). User interface 1960 is accessible to a user from a number of the user interfaces described above. From user interface 1960, a logged in registered user may select and view rent comparables, sales comparables, property valuations, metro and submarket reports, news, a submarket lookup tool, a national page, and a help utility.

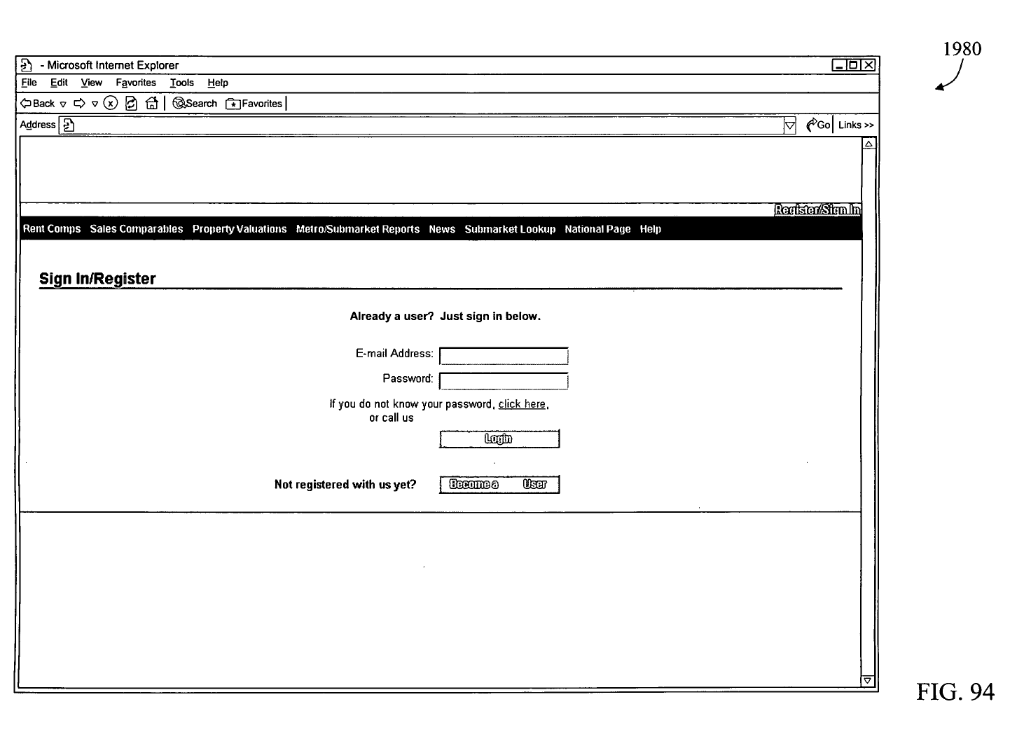

FIG. 94 is a user interface 1980 which allows a potential user to register and registered users to login for access to user interface 1960.

Branch Finder

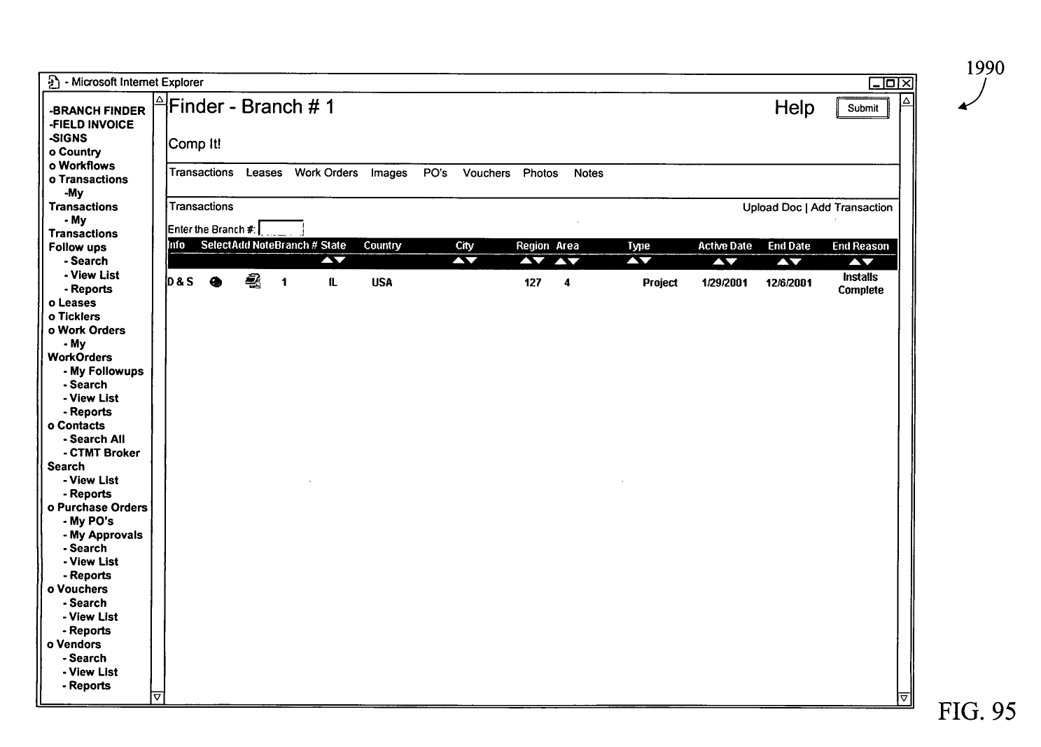

FIG. 95 is an example embodiment of a user interface 1990 displaying a branch finder included within REWMS 10 (shown in FIG. 1). User interface 1990 is displayed when the branch finder option (branch finder link 304 shown in FIG. 5) is selected by a user. User interface 1990 provides a data entry field so that a user can enter a branch number. REWMS 10 also provides search results in user interface 1990. Specifically, for a branch number search, search results include, at least in the embodiment illustrated, include an information identifier, an option to add a note, a state, a country, a city, a region, an area, a branch type, an activation date, an ending date, and an ending reason for each entry regarding a specific branch. In the embodiment illustrated, transactions relating to an entered branch number can be sorted by one of state, city, region, area, type, active date, ending date, and ending reason.

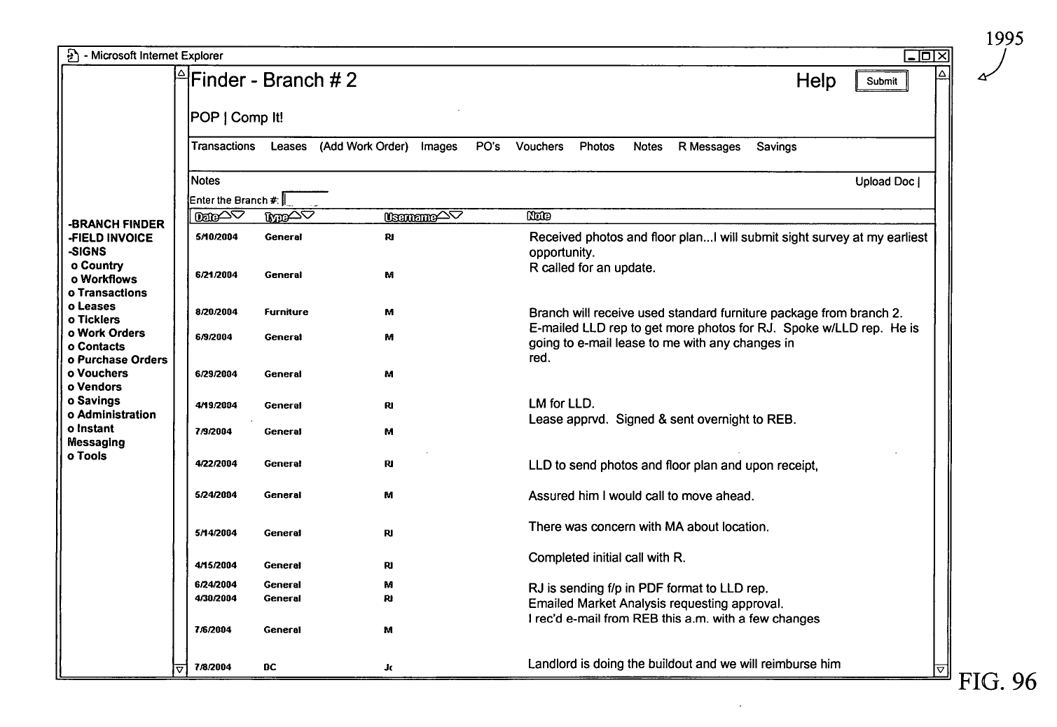

FIG. 96 is an example embodiment of a user interface 1995 displaying a portion of branch finder function included within REWMS 10 (shown in FIG. 1). User interface 1995 includes a display of notes relating to one or more transactions and provides a data entry field so that a user can enter a branch number to search the notes for the entered branch number. The notes displayed in user interface 1995 can be sorted according to a date, a type, or a username. REWMS 10 also provides the search results in a user interface, for example, user interface 1990 (shown in FIG. 95).

Client Access Portal

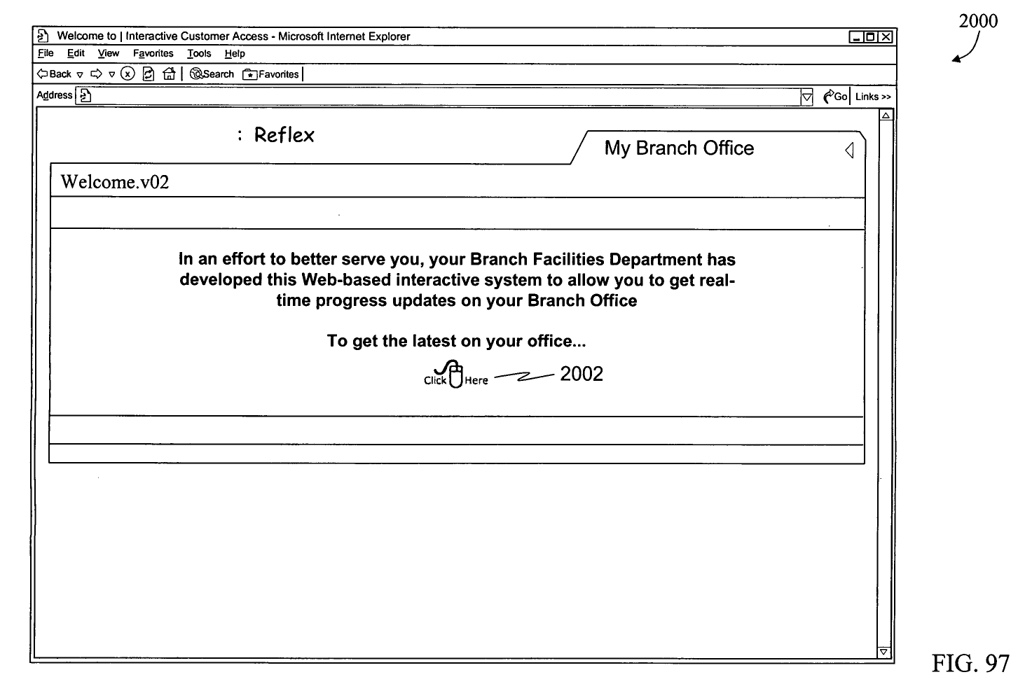

FIG. 97 through FIG. 104 are example embodiments of user interfaces for a client access portal included within REWMS 10 (shown in FIG. 1). REWMS 10 is accessible by remote client users. Remote users access REWMS 10 through an introductory user interface 2000, illustrated in FIG. 97, via a website address. The user interfaces, as described in user interface 2000, allow a user to get progress updates regarding a property, for example, that it is attempting to be leased, or that is being refurbished for utilization by a lessee representative.

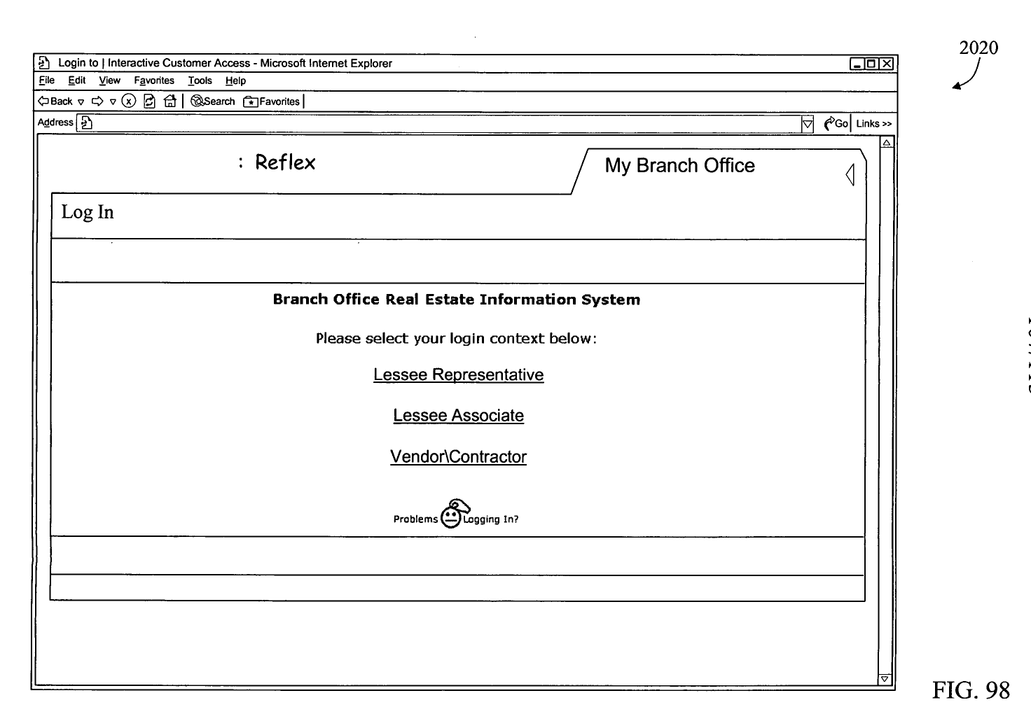

Selection of a link 2002 on user interface 2000 causes user interface 2020, shown in FIG. 98 to be displayed. User interface 2020 allows a user to access REWMS 10 based, for example, on selection of a user selected context link. Example user context links include, but are not limited to, a lessee representative, a lessee associate, and a vendor/contractor.

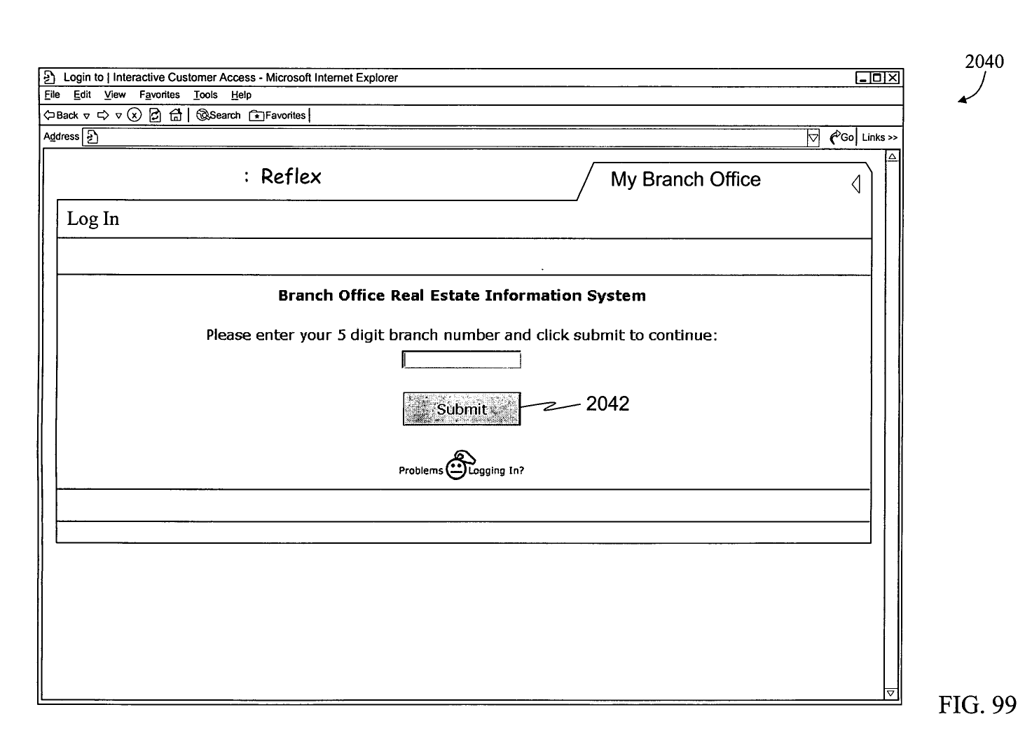

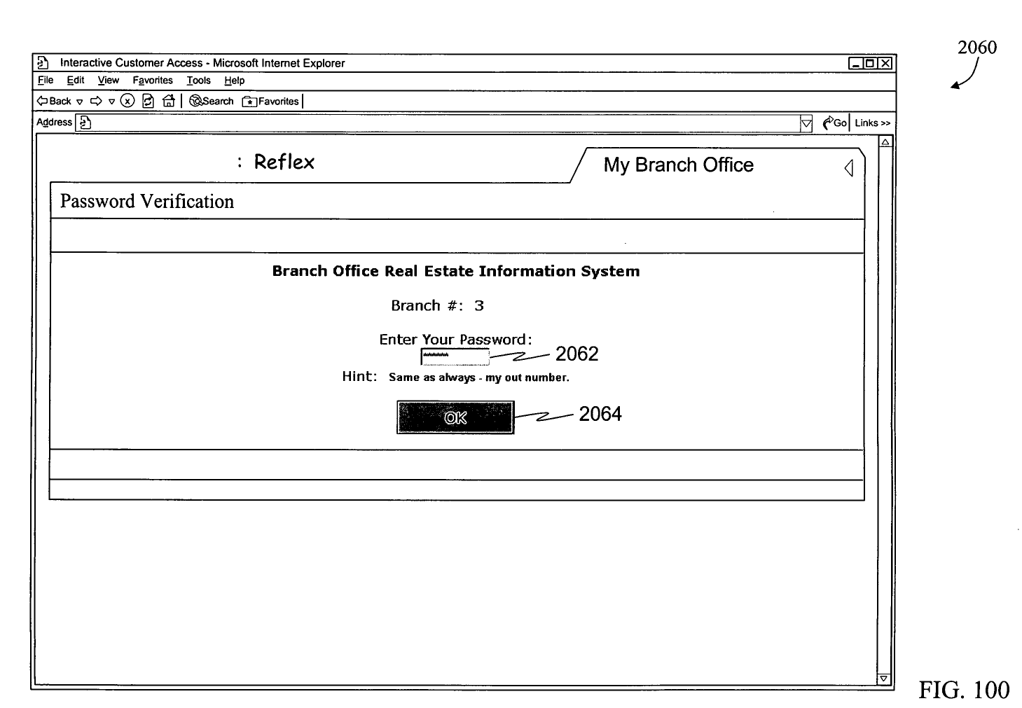

FIG. 99 is an example embodiment of a user interface 2040 for user entry of an identifying number allowing access to a branch office real estate information system. A user enters an identification umber for a branch office and selects a submit hot button 2042. Upon entry of a valid branch office identification number, a user is presented with a password entry user interface 2060, an embodiment of which is illustrated in FIG. 100. A user enters their password in the data entry field 2062 and selects an “OK” hot button 2064. The previously entered branch office number is also displayed within user interface 2060.

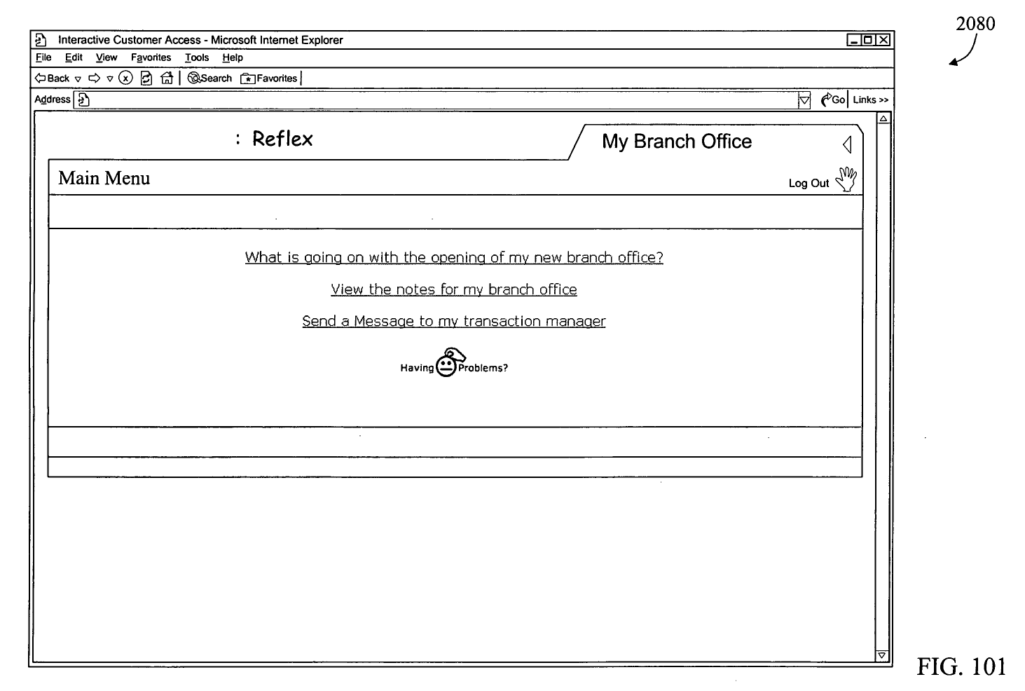

After a successful login, a user is presented with user interface 2080, an embodiment of which is illustrated in FIG. 101. User interface 2080 provides a successfully logged in user with links which can be selected to provide the user with updates regarding a property. In the embodiment illustrated, a user can determine “what is going on with the opening of my new branch office” (i.e., a summary), “view the notes for my branch office”, and “send a message to my transaction manager”.

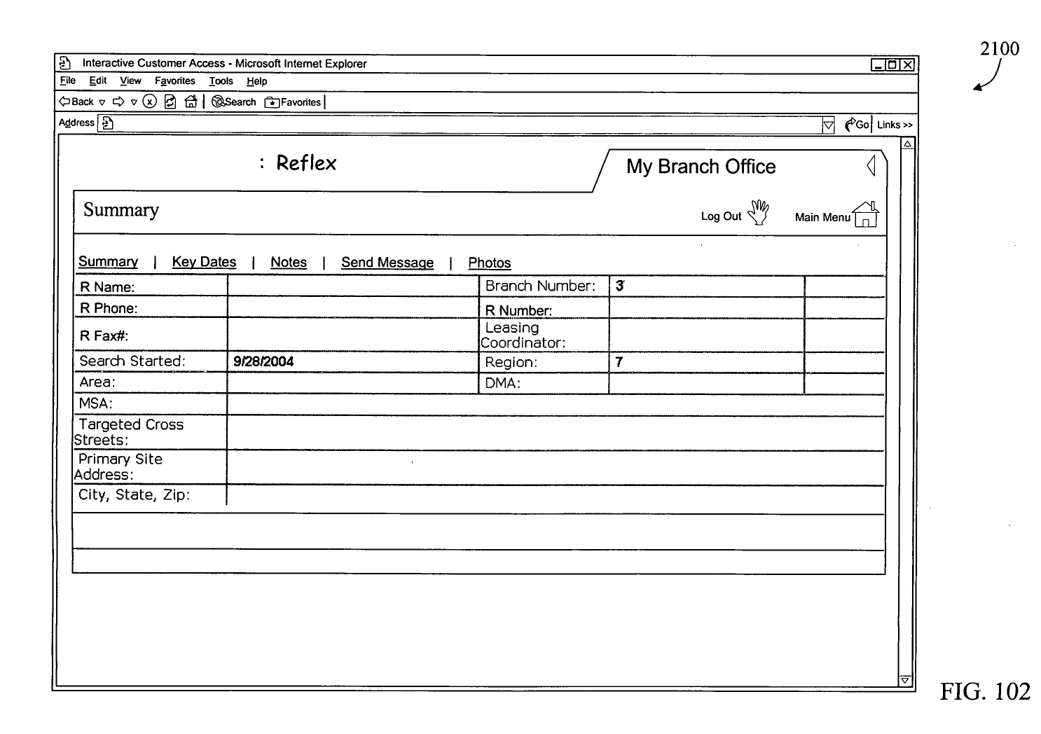

FIG. 102 is an example embodiment of a user interface 2100 that provides a user with a summary regarding the opening of a new branch office. User interface 2100, in the embodiment illustrated includes information regarding the lessee representative, the leasing coordinator, and region area information, for example, an address and targeted cross streets

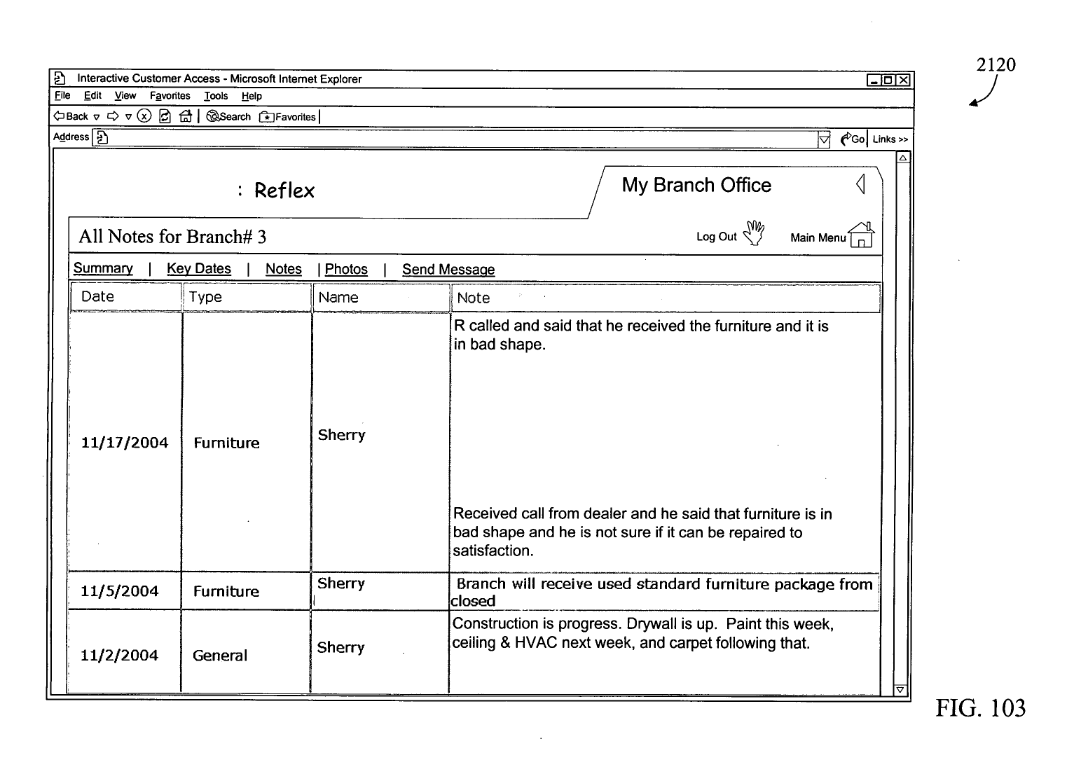

FIG. 103 is an example embodiment of a user interface 2120 that provides a user with notes regarding a branch office. User interface 2120, in the embodiment illustrated and for each note includes a date, a note type (i.e., furniture or general), a name of the person that entered the note, and the text of the note itself.

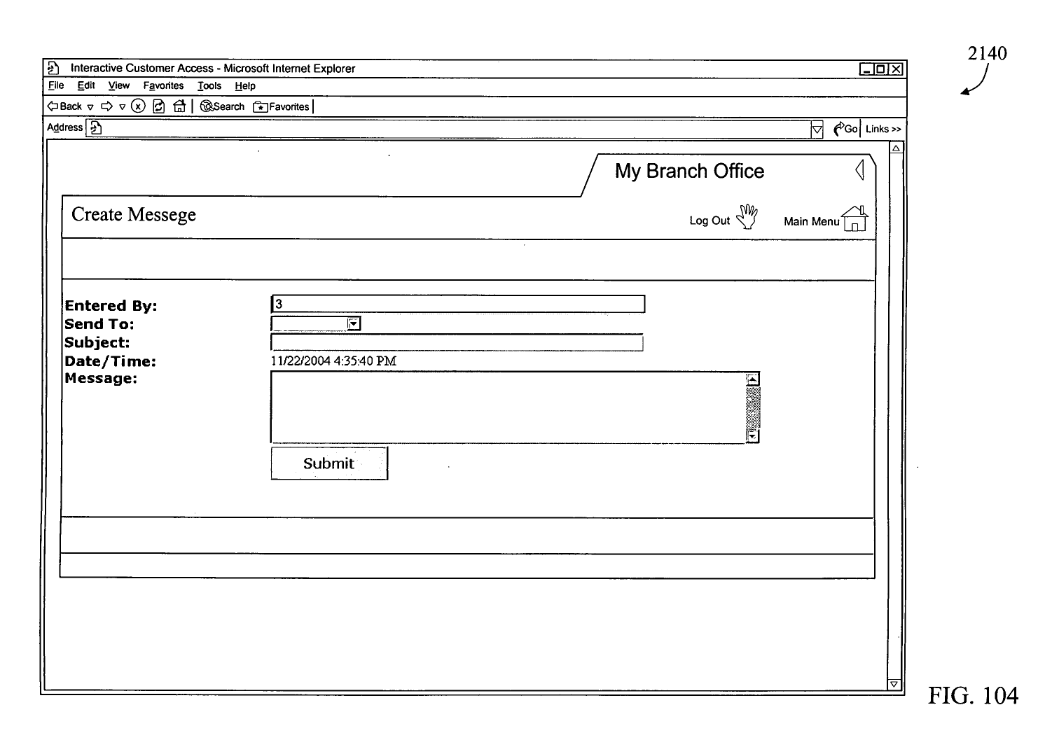

FIG. 104 is an example embodiment of a user interface 2140 that provides a user with an ability to send a message. User interface 2140 includes data entry fields for entering an identifier, a recipient, a subject, a date and time, and the text of the message.

In one aspect of the present invention, a method for controlling workflow relating to an acquisition or leasing of a facility by a business entity and managing information relating to the facility is provided. The method uses a computer system coupled to a database. The method comprising the steps of: determining whether to engage a real estate broker to investigate a potential facility, prompting a user to select a location of a potential facility, scoring the potential facility using an algorithm for determining whether the potential facility satisfies certain building requirements of the business, prompting the user to prepare a letter of intent to lease the potential facility, generating a lease agreement relating to the potential facility, obtaining the necessary approvals from the business for the potential facility, executing the lease agreement, recording and tracking any options relating to the leased facility, providing a technology survey, scheduling and monitoring construction or repair costs for the leased facility, arranging for signage for the leased facility, arranging for installing certain technology systems including a satellite system at the leased facility, and processing at least one of work orders, purchase orders, vouchers, invoices and payments to vendors for work performed at the leased facility.

REWMS therefore better enables a business having at least one facility located within the United States or within the world to collect, manage, store and disseminate real estate (RE) information relating to the existing facility or a new facility among persons within or outside of the business to ensure that the facility is properly managed. REWMS also prompts a user through a real estate transaction by controlling the workflow of leasing or purchasing a facility in a pre-selected location. More specifically, REWMS controls and tracks the workflow of leasing or purchasing a facility for a business by prompting a user to engage a real estate broker to investigate a potential facility, select a location of a potential facility, score the potential facility using an algorithm for determining whether the potential facility satisfies certain building requirements of the business, prepare a letter of intent to lease the potential facility, generate a lease agreement relating to the potential facility, obtain the necessary approvals from the business for the potential facility, finalize the lease agreement, record any options relating to the facility, provide a technology survey, schedule and monitor construction or repair costs for the facility, arrange for signage for the facility, and arrange for installing certain technology including a satellite system at the facility.

REWMS also stores, tracks, and manages RE information for the business, which includes information relating to the leasing or acquisition of a facility as described above. In addition, REWMS processes work orders submitted on behalf of a facility to the business for work that needs to be done at the facility. For example, if a roof of a facility requires repair, a user located at the facility is prompted to submit a work order for the roof repair to the business through REWMS. In one embodiment, the work order is submitted through REWMS. In another embodiment, the work order is submitted and the information is then entered into REWMS. The work order is processed through REWMS by the business. The business will then issue a purchase order (PO) to the facility through REWMS such that the facility may hire a vendor (i.e., a roofer) to repair the roof. The invoice for the roof repair may also be submitted through REWMS. Alternatively, the invoice may be submitted and the information from the invoice entered into REWMS. REWMS processes the invoice by matching the invoice to the purchase order. The vendor may then be paid for the work performed. REWMS also stores and tracks all work orders, POs, invoices, and work performed at the facility.

REWMS enables the business to store, track, and view each transaction or facility managed by the business, contact information for each facility associated with the business, vouchers submitted by the facilities, and vendors used and approved by the business for providing work or services to the facilities.

While the invention has been described in terms of various specific embodiments, those skilled in the art will recognize that the invention can be practiced with modification within the spirit and scope of the claims.

What is claimed is:

1. A method for controlling workflow relating to an acquisition or leasing of a facility using a real estate management system, the real estate management system including a computer coupled to a database, said method comprising:
selecting a location for a potential facility being considered for a transaction including at least one of an acquisition transaction and a leasing transaction;
prompting a user to enter into the computer information relating to the selected location, the entered information is stored in the database;
automatically displaying on the computer a workflow summary including an active stages section, a future stages section, and a past stages section relating to the selected location of the potential facility, wherein the active stages section includes tasks to be performed within a predetermined period of time and in a recommended sequence to progress the transaction toward completion, the future stages section includes tasks that will likely need to be performed in the future in a recommended sequence to complete the transaction, and the past stages section includes tasks that have already been performed to progress the transaction toward completion;
prompting the user to enter into the computer information relating to each action displayed and performed to complete the transaction, the entered information is stored in the database;
generating documents to complete the transaction based on the information stored in the database for the selected location, once the transaction is completed the potential facility is known as the facility having been at least one of leased or acquired;
prompting the user to enter into the computer information relating to infrastructure updates for the facility; and
managing the infrastructure updates for maintaining the facility.

2. A method according to claim 1 wherein selecting a location for a potential facility further comprises scoring a potential facility using an algorithm for determining whether the potential facility satisfies certain building requirements for a particular business.

3. A method according to claim 1 wherein selecting a location for a potential facility further comprises determining whether to engage a real estate broker to investigate the potential facility.

4. A method according to claim 1 wherein automatically displaying on the computer a workflow summary further comprises:
prompting the user to enter into the computer an approval request for approval of the transaction involving the selected location by at least one predetermined approver;
submitting the approval request to the at least one approver; and
receiving from the at least one approver an approval or a rejection of the approval request indicating whether management approves or rejects the transaction.

5. A method according to claim 4 wherein automatically displaying on the computer a workflow summary further comprises:
prompting the user to prepare a letter of intent to lease or purchase the potential facility after receiving the necessary approvals from the at least one approver.

6. A method according to claim 1 wherein generating documents to complete the transaction further comprises:
generating at least one of a lease agreement, a lease renewal agreement, and a purchase agreement relating to the facility;
executing the at least one agreement; and
recording and tracking any options relating to the facility.

7. A method according to claim 1 wherein generating documents to complete the transaction further comprises:
providing an options tool for tracking options included within at least one of a lease agreement, a lease renewal agreement, and a purchase agreement relating to the facility, the options including at least one of a tenant cancellation option, renewal options, relocation options, right of first refusal options, landlord cancellation options, and archived options;
utilizing the options tool to manage options information including data relating to option notification dates, option penalties, tenant improvements, free rent, prepaid rent, and security deposits; and
providing options information to the user for a plurality of transactions.

8. A method according to claim 1 wherein managing the infrastructure updates for maintaining the facility further comprises:
prompting the user to conduct a technology survey of the facility; and
storing the technology survey of the facility in the database.

9. A method according to claim 1 wherein managing the infrastructure updates for maintaining the facility further comprises:
scheduling and monitoring construction or repair costs for the facility;
arranging for signage for the facility; and
arranging for installing certain technology systems within the facility.

10. A method according to claim 1 wherein managing the infrastructure updates for maintaining the facility further comprises processing at least one of work orders, purchase orders, vouchers, invoices, and payments to vendors for work performed at the facility.

11. A network-based system for controlling workflow relating to an acquisition transaction or a leasing transaction of a facility for a business entity and for managing the facility for the business entity after the transaction has been completed, said system comprising:
a client system comprising a browser;
a database for storing information; and
a server system configured to be coupled to said client system and said database, said server further configured to:
prompt a user to select a location of a potential facility being considered for a transaction including at least one of an acquisition transaction and a leasing transaction;
prompt the user to input into the client system information relating to the selected location, the inputted information is stored in the database;
calculate a score for the potential facility based on a determination of whether the potential facility satisfies certain building requirements for the business entity;
automatically display on the client system a workflow summary including an active stages section, a future stages section, and a past stages section relating to the selected location of the potential facility, wherein the active stages section includes tasks to be performed within a predetermined period of time and in a recommended sequence to progress the transaction toward completion, the future stages section includes tasks that will likely need to be performed in the future in a recommended sequence to complete the transaction, and the past stages section includes tasks that have already been performed to progress the transaction toward completion;
prompt the user to input into the client system information relating to each action displayed and performed to complete the transaction, the inputted information is stored in the database;
generate documents to complete the transaction based on the information stored in the database for the selected location, once the transaction is completed the potential facility is known as the facility having been at least one of leased or acquired;
prompt the user to input into the client system information relating to infrastructure updates for the facility; and
process the infrastructure updates for maintaining the facility.

12. A network-based system according to claim 11 wherein said server is further configured to:
prompt the user to conduct a technology survey of the facility;
prompt the user to schedule and monitor at least one of construction costs, repair costs and technology installation costs for the facility;
prompt the user to arrange for signage for the facility; and
process at least one of work orders, purchase orders, vouchers, invoices, and payments to vendors for work performed at the facility.

13. A network-based system according to claim 11 wherein said server is further configured to prompt the user to select from at least one of a list of transactions assigned to the user and a worklist assigned to the user showing a workflow including active stages, future stages, and past stages of the leasing or acquisition process.

14. A network-based system according to claim 11 wherein said server is further configured to display a navigation bar on the client system including one or more of a branch finder link, a field invoice link, a signs link, a country link, a workflows link, a transactions link, a leases link, a ticklers link, a work orders link, a contacts link, a purchase orders link, a vouchers link, a vendors link, a savings link, an administration link, an instant messaging link, and a tools link.

15. A network-based system according to claim 11 wherein said server is further configured to display transactions pages including one or more of a transactions summary page, a transactions key dates page, a transactions contacts page, a transactions notes page, a transactions photographs page, a transactions images page, a transactions vouchers page, a transactions purchase orders page, a transactions signage information page, a transactions design information page, a transactions move information page, a transactions conference room tracking page, a transactions page, a transactions follow-up log page, a transactions clearance and negotiation page, a transactions collection list page, a transactions savings list page, a transactions site selection page, a transactions site scoring page, a transactions survey page, a transactions information page, and a transactions E-file page.

16. A network-based system according to claim 11 wherein said server is further configured to:
prompt the user to input into the client system an approval request for approval of the transaction involving the selected location by at least one predetermined approver;
submit the approval request to the at least one approver; and
receive at the client system from the at least one approver an approval or a rejection of the approval request indicating whether management of the business entity approves or rejects the transaction.

17. A network-based system according to claim 16 wherein said server is further configured to:
prompt the user to prepare a letter of intent to lease or purchase the potential facility after receiving the necessary approvals from the at least one approver.

18. A network-based system according to claim 11 wherein said server is further configured to:
generate at least one of a lease agreement, a lease renewal agreement, and a purchase agreement relating to the facility;
prompt each party to the transaction to execute the at least one agreement; and
record and track any options included within the executed agreement relating to the facility.

19. A network-based system according to claim 11 wherein said server is further configured to access an options tool for tracking options included within at least one of a lease agreement, a lease renewal agreement, and a purchase agreement relating to the facility, the options including at least one of a tenant cancellation option, renewal options, relocation options, right of first refusal options, landlord cancellation options, and archived options.

20. A network-based system according to claim 19 wherein said server is further configured to:
access the options tool to manage options information including data relating to option notification dates, option penalties, tenant improvements, free rent, prepaid rent, and security deposits; and
provide options information to the user for a plurality of transactions.

21. A network-based system according to claim 19 wherein the cancellation options include cancellation options penalties including at least one of base rent, operating expenses, sales tax, trash removal, packaging, signage, utilities, insurance, storage, merchandise due, real estate tax, and a fixed amount in dollars.

22. A network-based system according to claim 19 wherein the cancellation options include whether the transaction includes at least one of unamortized tenant improvements on amortized commissions, free rent, prepaid rent, and a security deposit.

23. A network-based system according to claim 11 wherein said server is further configured to:
access a work order tool; and
display on the client system after accessing the work order tool at least one of a work order summary page, a work order photographs page, a work order contacts page, a work order vouchers page, a work order notes page, a work order follow-up log page, a work order telephone listing page, a work order purchase orders page, a work order images page, a work order savings list page, a work order collection list page, a work order E-file page, and a maintenance reporting page.

24. A network-based system according to claim 11 wherein said server is further configured to:
access a purchase order tool; and
display on the client system after accessing the purchase order tool at least one of purchase order information relating to an amount of a purchase order, charge sub-categories for the purchase order, charge types for the purchase order, selection of vendors for a purchase order, text relating to a check stub description for a purchase order, identification number for a lessee representative associated with a purchase order, and team leader justification for a purchase order.

25. A network-based system according to claim 11 wherein said server is further configured with a vouchers user interface, selection of which causes said server to display information associated with a selected voucher number.

26. A network-based system according to claim 25 wherein information associated with a voucher includes at least one of a status, approvals, a due date, an invoice date, a mailing status, terms, a discount due date, a discount, charge items associated with a voucher number.

27. A network-based system according to claim 11 wherein said server is further configured to:
access a savings interface; and
prompt the user after the saving interface is selected to input information associated with a savings event including at least one of a date, a savings type, an identifying number for the property, an address of the property, an invoice amount, a savings amount relating to the invoiced amount, and a textual description of the savings amount.

28. A network-based system according to claim 11 wherein said server is further configured with a document generator for generating interfaces displayed on the client system for prompting the user to input at least one of a branch number to be associated with documents to be generated, a selection of documents to be generated, terms of a renewal amendment, a document title entry page, a renewal term entry page, a rent steps page, an operating expenses options page, an early terminations options page, a renewal options page, and a declarations page.

29. A network-based system according to claim 11 wherein said server is configured with a client access portal configured to allow access to said system by at least one of a lessee representative, and a lessee associate.

30. A computer program embodied on a computer readable medium for controlling workflow relating to an acquisition or leasing of a facility by a business entity, said program comprising at least one code segment that prompts a user to select a location for a potential facility being considered for a transaction including at least one of an acquisition transaction and a leasing transaction and then:
prompts a user to input information relating to the selected location, the entered information is stored in a database;
calculates a score for the potential facility using an algorithm for determining whether the potential facility satisfies certain building requirements for the business entity;
automatically generates a workflow summary including an active stages section, a future stages section, and a past stages section relating to the selected location of the potential facility, wherein the active stages section includes tasks to be performed within a predetermined period of time and in a recommended sequence to progress the transaction toward completion, the future stages section includes tasks that will likely need to be performed in the future in a recommended sequence to complete the transaction, and the past stages section includes tasks that have already been performed to progress the transaction toward completion;
prompts the user to input information relating to each action displayed and performed to complete the transaction, the entered information is stored in the database;
prompts the user to submit an approval request for approval of the transaction involving the selected location by at least one predetermined approver, the approver then provides the user with an approval or a rejection indicating whether management of the business entity approves or rejects the transaction;
generates documents to complete the transaction based on the information stored in the database for the selected location, once the transaction is completed the potential facility is known as the facility having been at least one of leased or acquired, the generated documents include at least one of a lease agreement, a lease renewal agreement, and a purchase agreement relating to the facility;
records and tracks any options relating to the facility;
prompts the user to input information relating to infrastructure updates for the facility including scheduling and monitoring construction or repair costs for the facility, arranging for signage for the facility, and arranging for installing certain technology systems within the facility; and
manages the infrastructure updates for maintaining the facility including processing at least one of work orders, purchase orders, vouchers, invoices, and payments to vendors for work performed at the facility.
